(19) United States
(12) Patent Application Publication
(10) Pub. No.: US 2009/0125350 A1
(43) Pub. Date: May 14, 2009

(54) SYSTEM AND METHOD FOR CAPTURING AND STORING SUPPLY CHAIN AND LOGISTICS SUPPORT INFORMATION IN A RELATIONAL DATABASE SYSTEM

(76) Inventors: Pieter Lessing, Los Angeles, CA (US); Dennis Jeng, Yorba Linda, CA (US); Mark Crosby, Venice, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/959,920

(22) Filed: Dec. 19, 2007

Related U.S. Application Data
(60) Provisional application No. 61/003,191, filed on Nov. 14, 2007.

(51) Int. Cl. G06Q 10/00

(52) U.S. Cl. 705/7

(57) ABSTRACT

A computer implemented method of and system for capturing, storing and organizing supply chain and logistics support information for a retail enterprise. Supply chain and logistics support information is stored and organized within a relational database in accordance with a logical data model comprising a plurality subject areas, and entities and relationships within the subject areas, defining the manner in which supply chain and logistics support information is stored and organized within the relational database. The relational database, populated with this information, provides a retail enterprise with detailed tracking and analysis support for shipping orders, freight bills, shipping order claims, and invoices; and detailed support for fleet tracking of shipments in the areas of legs, lanes and associated routes traveled, mode of transport, and specific equipment utilized in handling of shipments; allowing for improved supply chain efficiency through better informed decision making.

### CROSS REFERENCE TO RELATED APPLICATIONS

This application claims priority under 35 U.S.C. §119(e) to the following co-pending and commonly-assigned patent application, which is incorporated herein by reference:

Provisional Application Ser. No. ______, entitled “TERADATA RETAIL LOGICAL DATA MODEL 5.01,” filed on Nov. 14, 2007, by Pieter Lessing, Dennis Jeng, and Mark Crosby; attorney's docket number 13276.

This application is related to the following co-pending and commonly-assigned patent applications, which are incorporated by reference herein:

application Ser. No. 10/016,899, entitled “SYSTEM AND METHOD FOR CAPTURING AND STORING INFORMATION CONCERNING SHOPPERS INTERACTIONS AND TRANSACTIONS WITH AN E-BUSINESS RETAILER”, filed on Dec. 14, 2001, by Kim Nguyen-Hargett and Pieter Lessing; NCR Docket Number 9856;

application Ser. No. 10/017,146, entitled “SYSTEM AND METHOD FOR CAPTURING AND STORING INFORMATION CONCERNING RETAIL STORE OPERATIONS,” filed Dec. 14, 2001, by Kim Nguyen-Hargett and Pieter Lessing; NCR Docket Number 9858;

application Ser. No. 10/190,099, entitled “SYSTEM AND METHOD FOR CAPTURING AND STORING FINANCIAL MANAGEMENT INFORMATION,” filed on Jul. 3, 2002 by Sreedhar Srikant, William S. Black, Scott Kilmo, Karen Papierniak and James W. Smith; attorney's docket number 10145; and

application Ser. No. 11/444,047, entitled “SYSTEM AND METHOD FOR CAPTURING AND STORING RFID/SERIALIZED ITEM TRACKING INFORMATION IN A RELATIONAL DATABASE SYSTEM,” filed on May 31, 2006, by Pieter Lessing, Dennis Jeng, Mark Crosby and Sreedhar Srikant; attorney's docket number 12011.

### FIELD OF THE INVENTION

The present invention relates generally to Data Warehouse solutions, and more particularly, to systems and methods for capturing, storing and using detailed data on store operations for a Retail Business. Still more particularly, the present invention is related to a logical data model for storing and organizing supply chain and logistics support information within a Retail Business data warehouse system.

### BACKGROUND OF THE INVENTION

Teradata Corporation has developed a data warehouse solution including a comprehensive suite of analytical and operational applications that captures, organizes and advances the use of high-value business information within a Retail Business. An objective of Teradata Corporation's retail data warehouse solution is to enable retail management to easily access and analyze information that is critical to the operation of retail outlets.

The retail data warehouse solution has been improved to incorporate subject matter, and increase information visibility, in the areas of supply chain management and transportation logistics. Key supply chain content enhancements include detailed tracking and analysis support for shipping orders, freight bills, shipping order claims, and invoices. Key transportation logistics content enhancements include detail support for fleet tracking of shipments in the areas of Legs, Lanes and associated Routes traveled, mode of transport, and specific Equipment utilized in handling of shipments

Providing new and extended content support in these two key areas will expand a retailer's overall supply chain and logistics visibility, allowing for improved supply chain efficiency, through better informed decision making.

### BRIEF DESCRIPTION OF THE DRAWINGS

The present invention is illustrated by way of example, and not by limitation, in the Figures of the accompanying drawings, wherein elements having the same reference numeral designations represent like elements throughout and wherein:

FIG. 1 provides an overview of the hardware components of a data warehouse system;

FIG. 2 is a high level illustration of the Teradata Solutions for Retail data warehouse solution and included analytical and operational applications in accordance with the present invention;

FIGS. 3A through 3H, taken together, provide a conceptual data model view of a retail industry logical data model (retail LDM) illustrating the most important entities in the retail LDM and how they generally relate to each other, in accordance with the preferred embodiment of the present invention;

FIGS. 4A through 4D illustrate an entity-relationship diagram of the AGREEMENT subject area of the logical data model in accordance with the preferred embodiment of the present invention;

FIGS. 5A through 5D illustrate an entity-relationship diagram of the INVENTORY (EXTERNAL) subject area of the logical data model in accordance with the preferred embodiment of the present invention;

FIGS. 6A through 6F illustrate an entity-relationship diagram of the INVOICE subject area of the logical data model in accordance with the preferred embodiment of the present invention;

FIGS. 7A through 7I illustrate an entity-relationship diagram of the SHIPPING ORDER subject area of the logical data model in accordance with the preferred embodiment of the present invention;

FIGS. 8A through 8F illustrate an entity-relationship diagram of the SHIPPING PLAN subject area of the logical data model in accordance with the preferred embodiment of the present invention;

FIGS. 9A through 9B illustrate an entity-relationship diagram of the SHIPPING REGULATION subject area of the logical data model in accordance with the preferred embodiment of the present invention; and

FIGS. 10A through 10L illustrate an entity-relationship diagram of the SHIPPING TRANSPORT subject area of the logical data model in accordance with the preferred embodiment of the present invention.

### BEST MODE FOR CARRYING OUT THE INVENTION

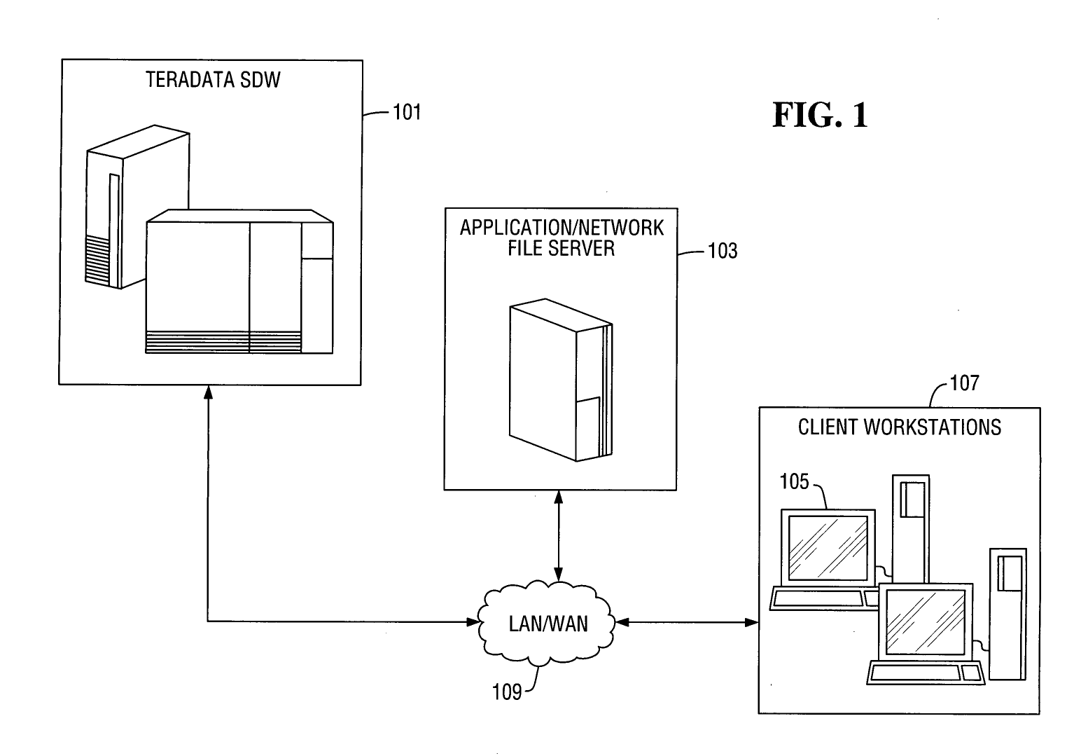

FIG. 1 provides an overview of the hardware required for a data warehouse solution. The basic components consist of a Teradata Corporation Teradata Scalable Data Warehouse 101, an administrative server 103, and client and administrative workstations 105 and 107, respectively. The components communicate with each other through a Local Area Network (LAN) or Wide Area Network (WAN), identified by reference numeral 109.

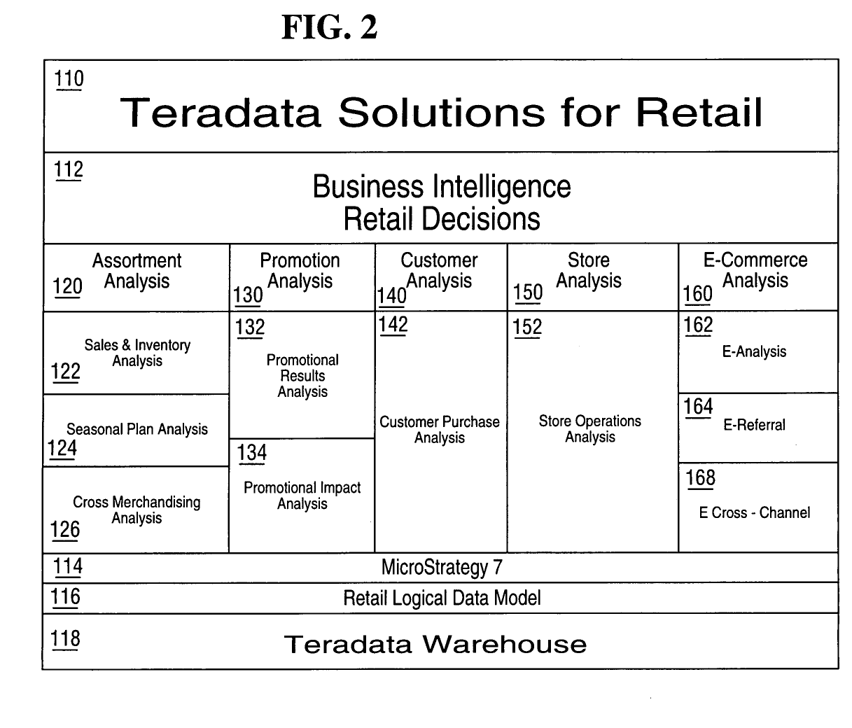

A retail business customer-centric warehouse is established on the Teradata Scalable Data Warehouse 101 as defined by the Retail Logical Data Model, described below. The application server 103 supports retail analytic and operational applications, such as Teradata Corporation's Teradata Solutions for Retail suite of retail business applications, illustrated in FIG. 2.

The Teradata Solutions for Retail suite of retail business applications comprises several analytic applications built on a common data model 116, leveraging a single source of data 118 across all departments. The application suite includes the following application members: Assortment Analysis 120, Promotion Analysis 130, Customer Analysis 140, Store Analysis 150 and E-Commerce Analysis 160.

Assortment Analysis (120). The Assortment Analysis application is the foundation for basic sales and inventory reporting; monitoring of sales trends by geography, product and product trait. Beyond basic reporting, functionality includes assortment planning and allocation analysis; additional view of seasonal planning and additional detail on vendor performance measures. Also provides advanced analysis of assortment based on customer segment preferences using analysis of market basket and customer data.

Assortment Analysis integrates planning processes that occur before and during the selling season resulting in tailored merchandise assortment, pricing and promotional support for unique markets and individual stores. The Assortment Management Analysis provides a diverse set of business analyses and reports (views) that will assist a merchant in arriving at better informed decisions regarding the management of his/her product assortments to the store level.

The Assortment Analysis application consists of three application modules:
1. Sales and Inventory Analysis 122: Elementary foundation for sales and inventory analysis reporting; monitoring of sales trends by geography, product and product trait. The Sales and Inventory Analysis provides performance and contribution reporting; analysis of sales, margin and inventory trends; and sales and inventory exception reporting.
2. Seasonal Plan Analysis 124: Analytical support for assortment planning and allocation analysis, added views on seasonal planning and vendor performance measures. The Seasonal Plan Analysis application module provides analysis and metrics concerning: store/area/department performance; item and category contribution; exception monitoring; and days-of-supply and out of stock.
3. Cross Merchandising Analysis 126: Advanced strategic analysis of assortment based on customer segment preferences using analysis of market basket and customer data. The Seasonal Plan Analysis application module provides analysis and metrics concerning: merchandising mix (Item Affinity); customer purchasing behavior (Customer Preferences); product assortment segmentation; and product introductions and deletions tailored to local market requirements.

Promotion Analysis (130). The Promotional Analysis application enables a retailer to analyze “Lift” by product, brand, or vendor, inventory effectiveness, Seasonal/Regional Demand Patterns and Price Point Analysis.

The Promotion Analysis application is designed to more effectively analyze, plan and target your promotions based on item, store and customer data. By allowing for key sales and inventory performance measurements such as “sell thru”, ending on hand stock, and sales to be combined and presented over various dimensional perspectives, one is provided with more accurate information regarding a promotion's effectiveness.

The Promotion Analysis application consists of two application modules:
1. Promotional Results Analysis application module 132 provides analysis of promotional lift by product, brand, or vendor. The Promotional Results Analysis application module provides analysis and metrics concerning: promotional performance of individual products; promotional inventory level effectiveness; stock levels during promotional periods by store; regional or seasonal demand patterns; unusual sales patterns by store; analysis of ‘forward buying’ phenomena; and the impact of promotions on price point strategies
2. Promotional Impact Analysis application module 134 provides advanced analysis of promotional effectiveness as it relates to product driver relationships and product affinities. The Promotional Impact Analysis application module 134 provides analysis and metrics concerning: market basket: time of day behavior differences (day part tracking); and customer product preferences.

Customer Analysis (140). The Customer Analysis application provides critical insight into a retailer's customer base via ranking, deciling, RFM analysis, demographic segmentation, and defining purchase behavior.

The Customer Analysis application consists of a Customer Purchase Analysis application module 142 that provides critical insight into customer base via ranking, deciling, RFM analysis, demographic segmentation, and defining purchase behavior. The Customer Purchase Analysis application module provides analysis and information concerning: targeted customer promotions; optimum promotional item assortment; promotional effectiveness; and enhanced cross merchandising strategies.

Store Analysis (150). The Store Analysis application provides analysis of store sales, labor, controllable expenses and variances.

The Store Analysis application consists of a Store Operations Analysis application module 152 that provides analysis of store sales, labor, controllable expenses and variances so as to provide a deeper understanding of costs, resources, traffic and productivity. The Store Operations Analysis application module provides analysis and information concerning: location sales; labor allocation policies; variable cost control; and resource (time) allocation.

E-Commerce Analysis (160). The E-Commerce Analysis application provides analysis of customer interactions, ad effectiveness, preference profiling, and cross-channel effectiveness.

The E-Commerce Analysis application provides a better understanding of the customer and their interaction with the e-Storefront: including customer, purchase, promotion, and media analysis. The E-Commerce Analysis application consists of three application modules:
1. E-Analysis application module 162 provides a detailed understanding of customer and e-storefront interaction, product and promotional effectiveness, as well as abandonment and fulfillment analysis. The E-Analysis application module provides analysis and metrics concerning: customer acquisition and retention; customer mix and conversation; marketing promotional effectiveness; and merchandising effectiveness.
2. E-Cross Channel application module 164 provides detailed understanding of customer behavior and interactions, product and promotional impact and contribution across customer contact channels. The E-Cross Channel application module provides analysis and metrics concerning: cross-channel customer management; and customer conversion.
3. E-Referral application module 168 provides detailed understanding of e-storefront interaction and referral effectiveness including referral return on investment (ROI). The E-Analysis application module provides analysis and metrics concerning: advertising media mix optimization; media costs; customer mix; and marketing promotional effectiveness.

### Logical Data Model Design Basics

A logical data model is a graphical representation of the way data is organized in a data warehouse environment. The logical data model specifically defines which individual data elements can be stored and how they relate to one another to provide a model of the business information. The data model ultimately defines which business questions can be answered from the data warehouse and thus determines the business value of the entire decision support system.

A properly designed LDM for a retail industry provides a foundation for more effective sales, marketing, and operations management and supports the customer relationship management (CRM) requirements related to identifying, acquiring, retaining and growing valuable customers. A logical data model for the retail industry reflects the operating principles and policies of the retail industry and provides the underlying structure for the data imported into the data warehouse

A logical data model provides an architecture for the information that will be included in a data warehouse. The database provides the physical realization of that architecture in a form that can be efficiently maintained and used. There may well be some differences between the logical data model and the final database design. The database may include some tables (summary tables, etc.) or columns that have no direct correlation in the logical data model. Elements in the logical model may be grouped differently in the physical database.

A logical data model is organized by Subject Areas, each comprised of numerous Entities, Attributes and Relationships. The data model hierarchy includes one or more Subject Areas. Each Subject Area includes one or more Entities or Tables, each having Attributes and Relationships. Each Attribute describes a fact about an Entity. Relationships between two or more Entities are further defined by Cardinality. The Relationships define which entities are connected to other entities and the cardinality of the relationships. Each of these elements will be described in greater detail below.

### Subject Area

A subject area is a subset of objects taken from the universe of data objects for a particular line of business or industry that focus on a particular Business Process. Typically, a subject area is created to help manage large data architectures that may encompass multiple business processes or business subjects. This is the highest-level data concept within a conceptual entity/relationship (E/R) model. Working with subject areas is especially useful when designing and maintaining a large or complex data model. Dividing the enterprise into several distinct subject areas allows different groups within an organization to concentrate on the processes and functions pertinent to their business area.

### Entity

An Entity represents a person, place, thing, concept, or event (e.g. PARTY, ACCOUNT, INVOICE, etc.). It represents something for which the business has the means and the will to collect and store data. An Entity must have distinguishable occurrences, e.g., one must be able to uniquely identify each occurrence of an entity with a primary key (e.g. Party Identifier, Account Identifier, Invoice Number, etc.). An Entity is typically named with a unique singular noun or noun phrase (e.g., PARTY, BILLING STATEMENT, etc.) that describes one occurrence of the Entity and cannot be used for any other Entity. It should be exclusive of every other Entity in the database. An Entity cannot appear more than once in the conceptual entity/relationship (E/R) model. Each Entity may have relationships to other Entities residing in its own Subject Area or in other Subject Areas.

### Attribute

An Attribute is a data fact about an Entity or Relationship. It is a logical (not physical) construct. It is data in its atomic form. In other words, it is the lowest level of information that still has business meaning without further decomposition. An example would be FIRST NAME, or LAST NAME. An example of an invalid attribute would be PERSON NAME if it includes both the first and last names, as this could be further decomposed into the separate, definable (first name, last name) data facts.

### Relationship

A Relationship is an association that links occurrences of one or more Entities. A Relationship must connect at least one Entity. If only one Entity is connected, the Relationship is said to be Recursive. A Relationship is described by a noun or passive verb or verb phase that describes the action taken in the Relationship. A Relationship represent a static state of being between the occurrences of the Entities it connects. Relationships are not intended to represent processes or data flows. They cannot be linked to another Relationships. They may optionally represent future, present, and/or past relatedness. The time frame must be explicitly defined in the data definition. Relationships may contain attributes. In a normalized model, a Relationship containing Attributes will result in the creation of an Entity.

### Cardinality

In order for a data model to be considered accurate, it must contain both the maximum and minimum number of Entity occurrences expected. This is controlled by rules of cardinality, which describes a relationship between two Entities based on how many occurrences of one Entity type may exist relative to the occurrence of the other Entity. Typically, it is a ratio, commonly depicted as a one-to-one (1:1); one-to-many (1:N); and many-to-many (M:N) relationship.

The maximum cardinality may be an infinite number or a fixed number but never zero. The minimum cardinality may be zero, or some other positive number, but it must be less than or equal to the maximum cardinality for the same relationship.

The logical data model for the E-Business will now be described in more detail. The logical data model uses IDEF1X modeling conventions, as shown in Table 1.

TABLE 1
Entity Conventions

| Convention | Definition |
|---|---|
| 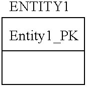 | Independent entity. An entity is depicted as a box, with its name above the box in singular, uppercase form. Square-boxed entities are independent. They rely on no other entity for their identification. Primary keys are attributes that uniquely identify the entity. Primary keys are shown at the top of the box, separated from other listed attributes by a horizontal line |
| 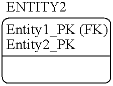 | Dependant entity. Round-cornered entities are dependent on one or more entities for their identification. (FK) following the primary key attribute indicates a foreign key—an attribute in the entity that is the primary key in another, closely related entity. |
| 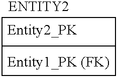 | An independent entity may also include a foreign key as a “non-primary key foreign key”. A non-primary key foreign key is shown below the horizontal line separating primary key attributes from other entity atributes. |

Relationship and cardinality conventions are shown in Table 2.

TABLE 2
Relationship/Cardinality Conventions

| Convention | Definition |
|---|---|
| 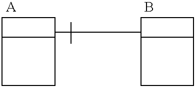 | A single line at the end of a relationship link means that a single record entity B is related to only one record in entity A.. |
| 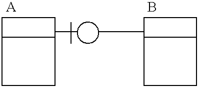 | A circle indicates that the presence of a linked record in entity A is optional. |
| 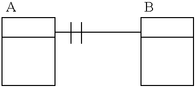 | A double line indicates that the prescence of a linked record in entity A is mandatory. |
| 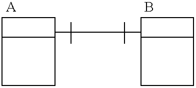 | One-to-one relationship. |
| 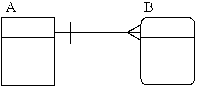 | One-to-many relationship. The crow's foot symbol means that more than one instance of an entity is associated with another entity. |
| 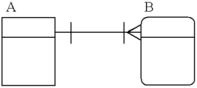 | One-to-one-or-more relationship. A crossbar with a crow's foot symbol means there is at least one instance of an entity associated with the other entity. |
| 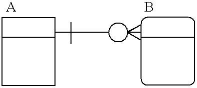 | One-to-zero-one-or-more relationship. A circle with a crow's feet symbol means there may be zero, one, or many instances of the entity associated with the other entity. |
| 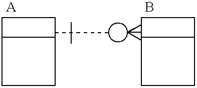 | A dotted relationship line indicates that the identity of entity B is not linked to entity A. |

### Retail Logical Data Model

The Retail Logical Data Model (rLDM) is a large data model composed of a large number of tables. To effectively view and understand the data model, the data tables have been logically organized into smaller groups called subject areas. Each subject area is comprised of a set of tables that contain information relevant to a particular entity. In addition, the subject areas address particular business questions.

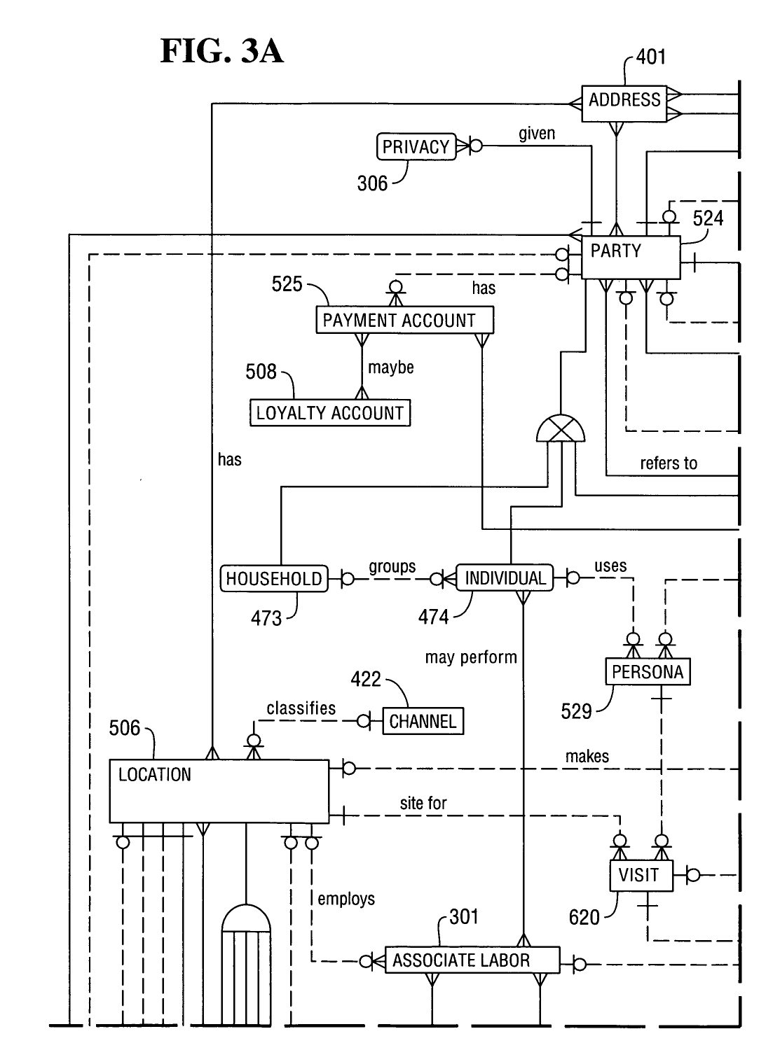

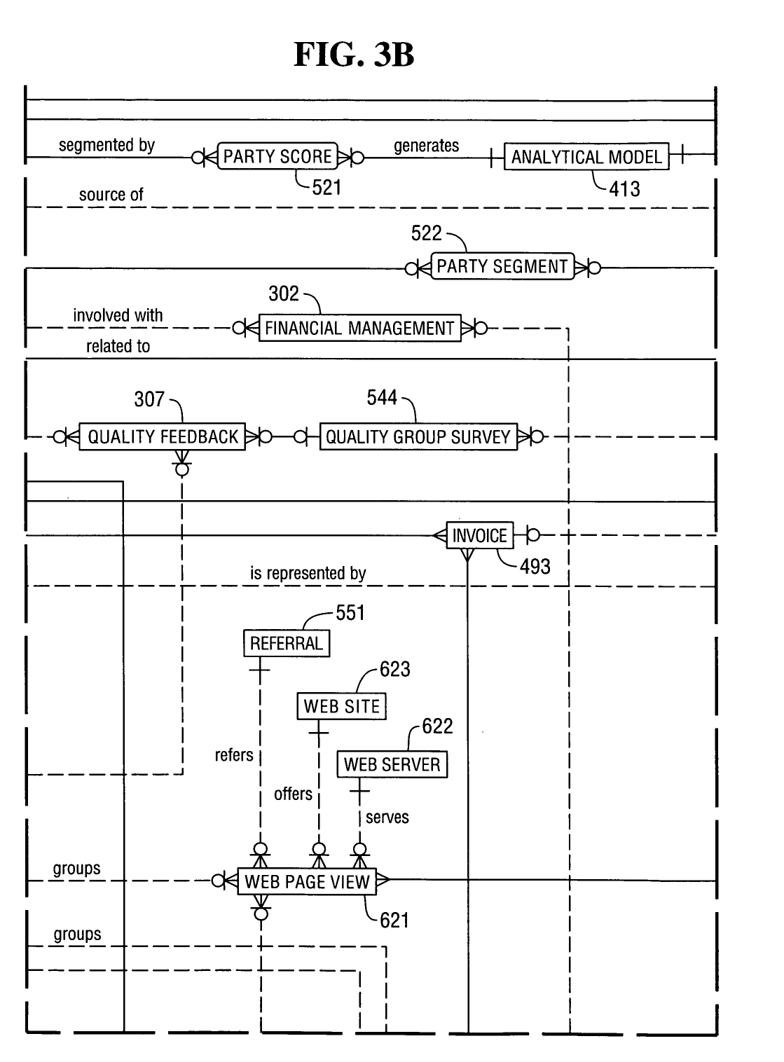

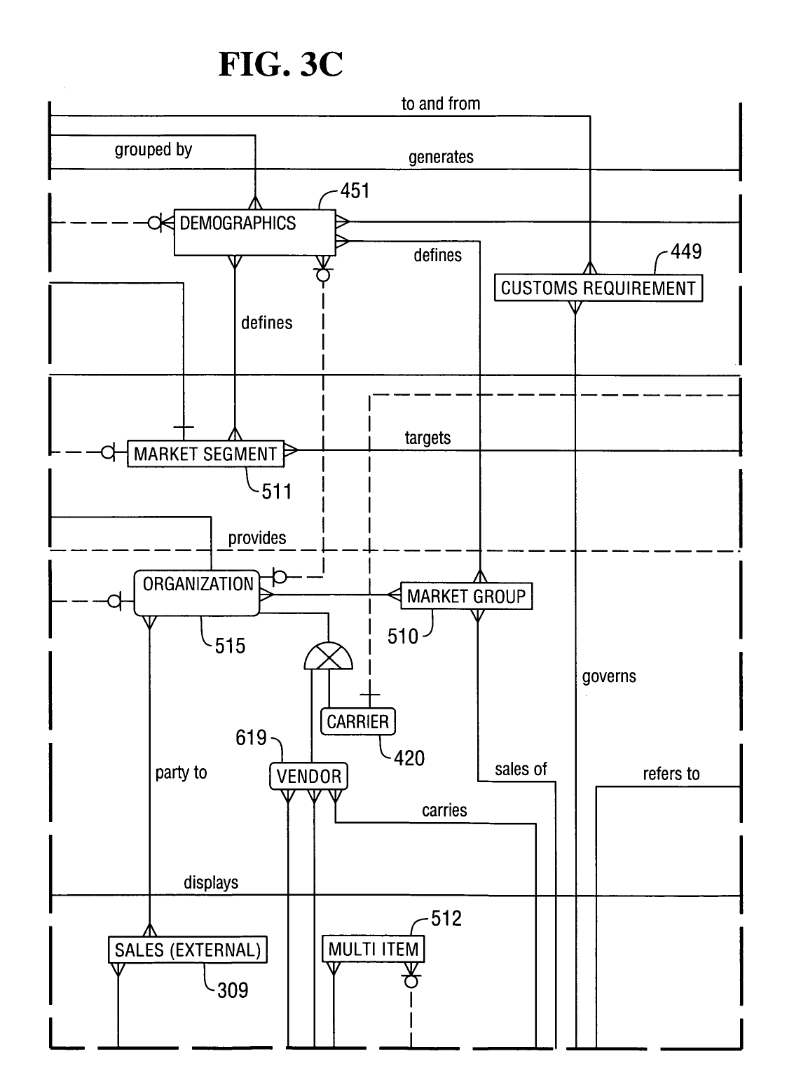

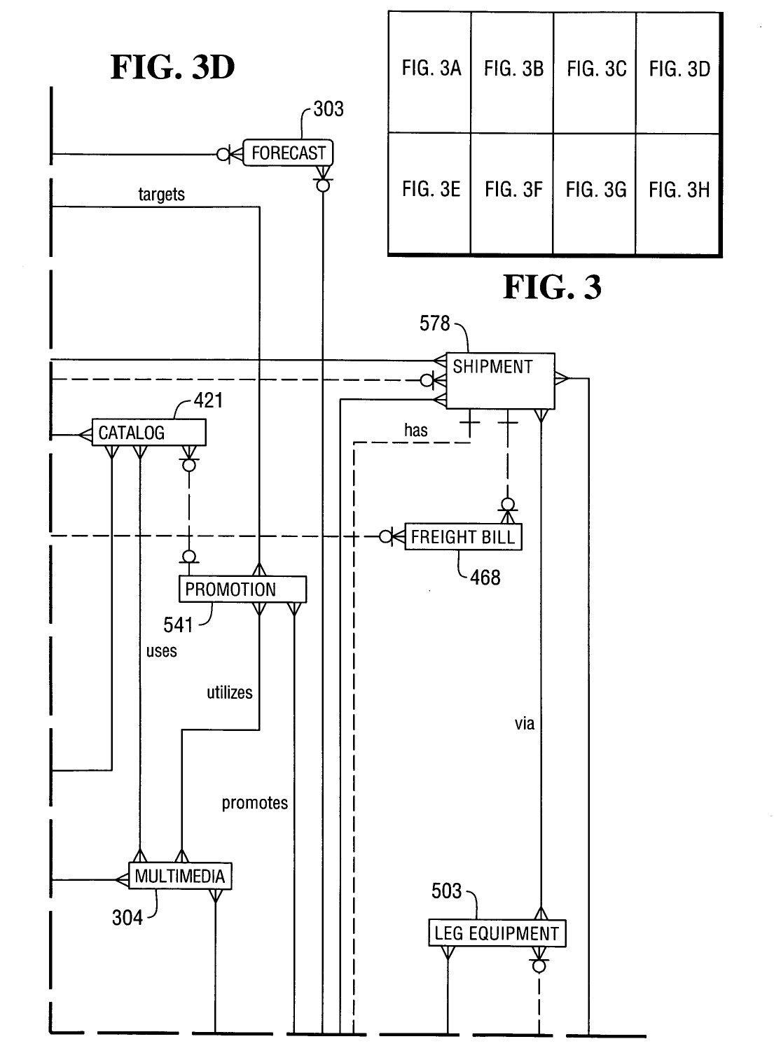

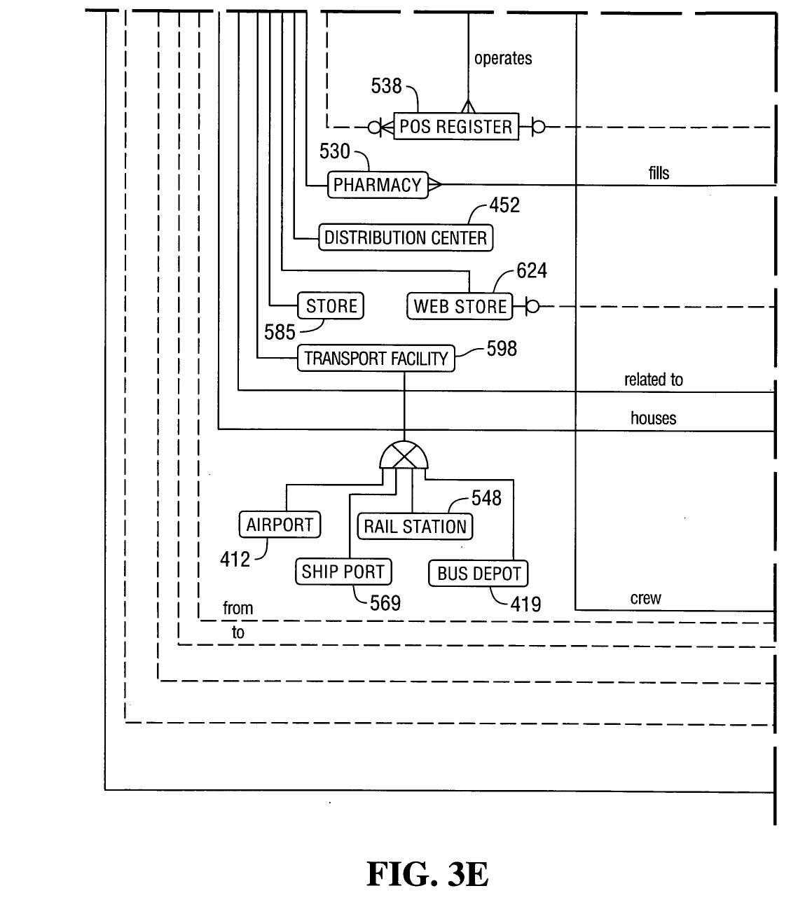

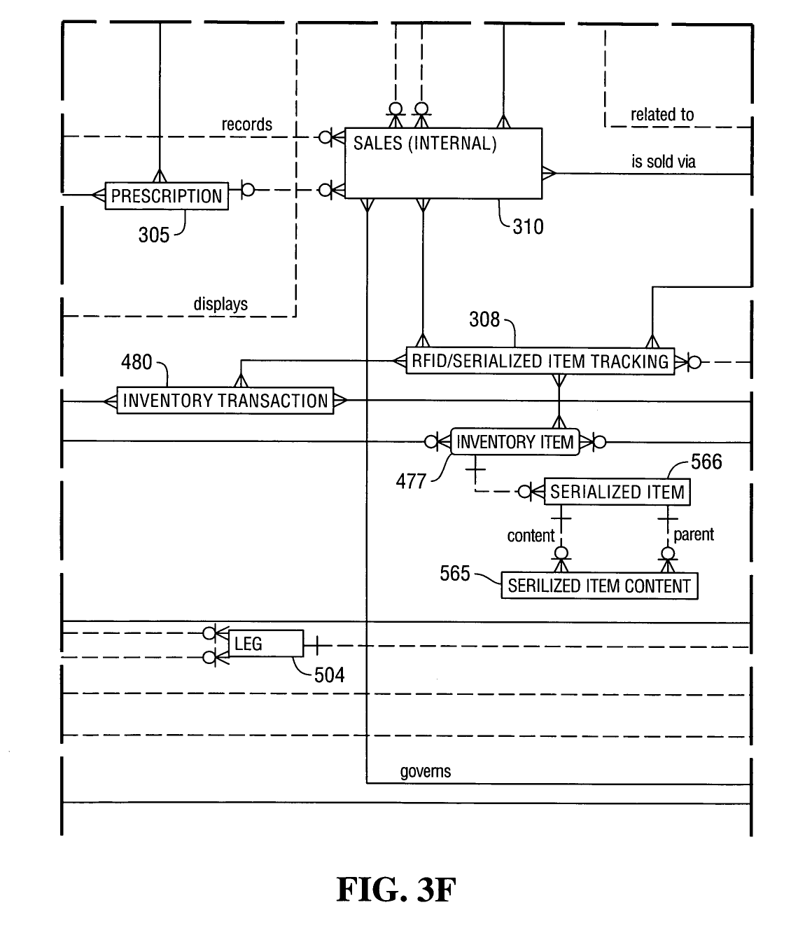

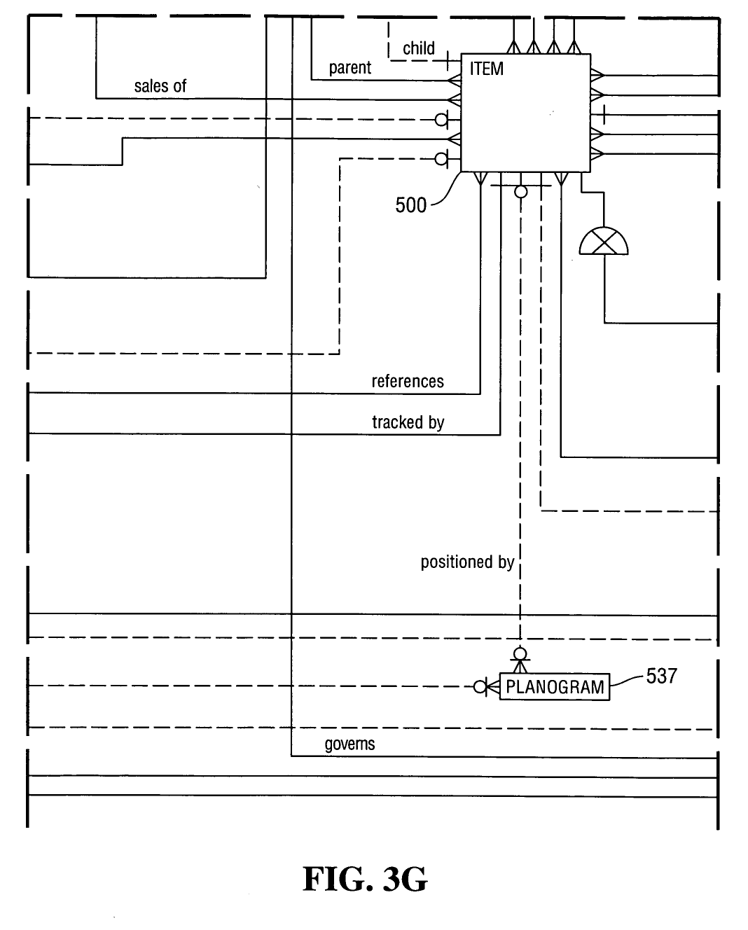

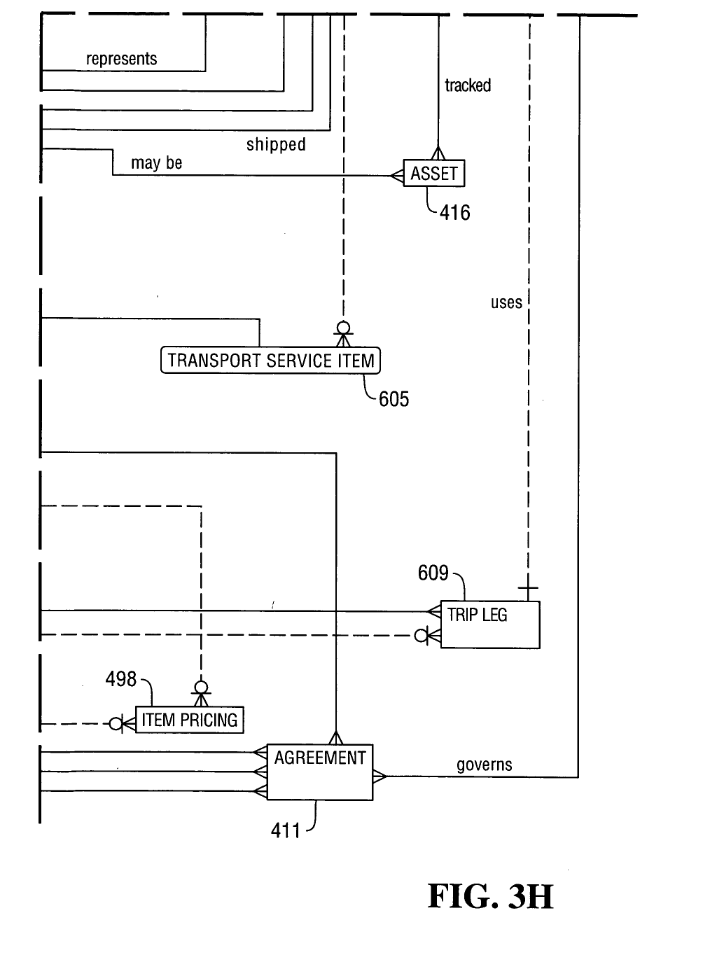

The Retail Logical Data Model is presented in the Conceptual View illustrated in FIGS. 3A through 3H. This view provides an overall high-level understanding of the major entities and how they relate to each other. The Conceptual View was derived directly from the Retail Logical Data Model by selecting the most important entities from every subject area, being sure that at least one entity from each subject area was selected, and distilling the relationships among the selected entities, while still maintaining the general nature of the way the entities relate to each other. During this process, some intervening entities were abstracted into relationships. Many-to-many relationships were used where appropriate. The result is a simple, easy to understand diagram that conveys the general content of the underlying logical data model.

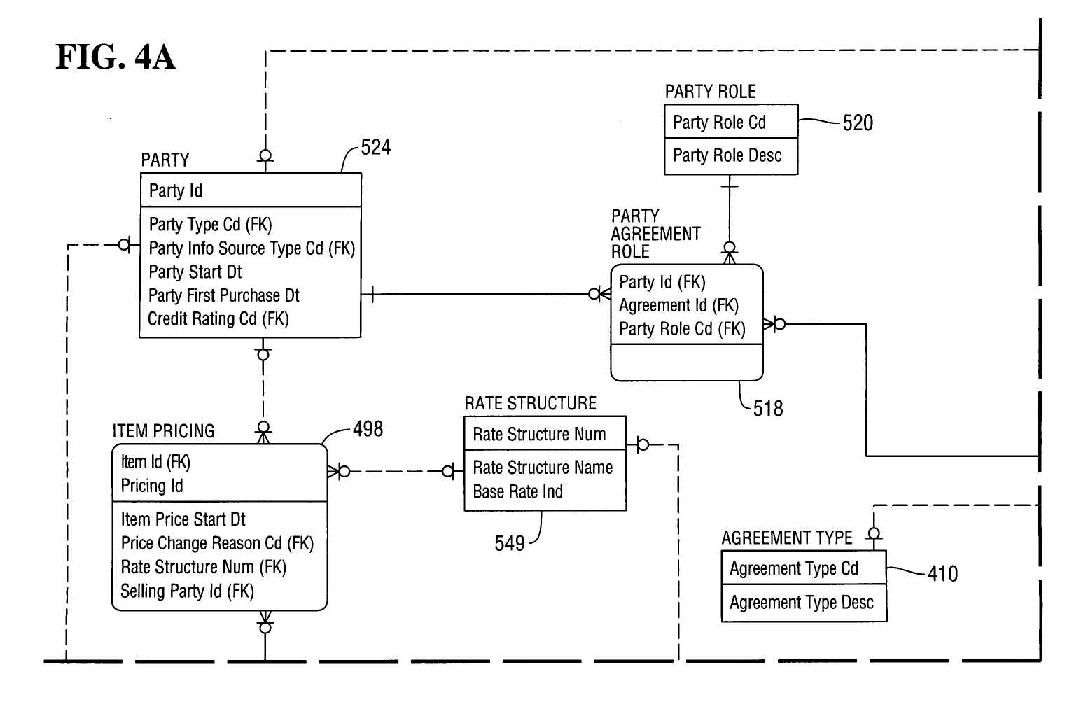

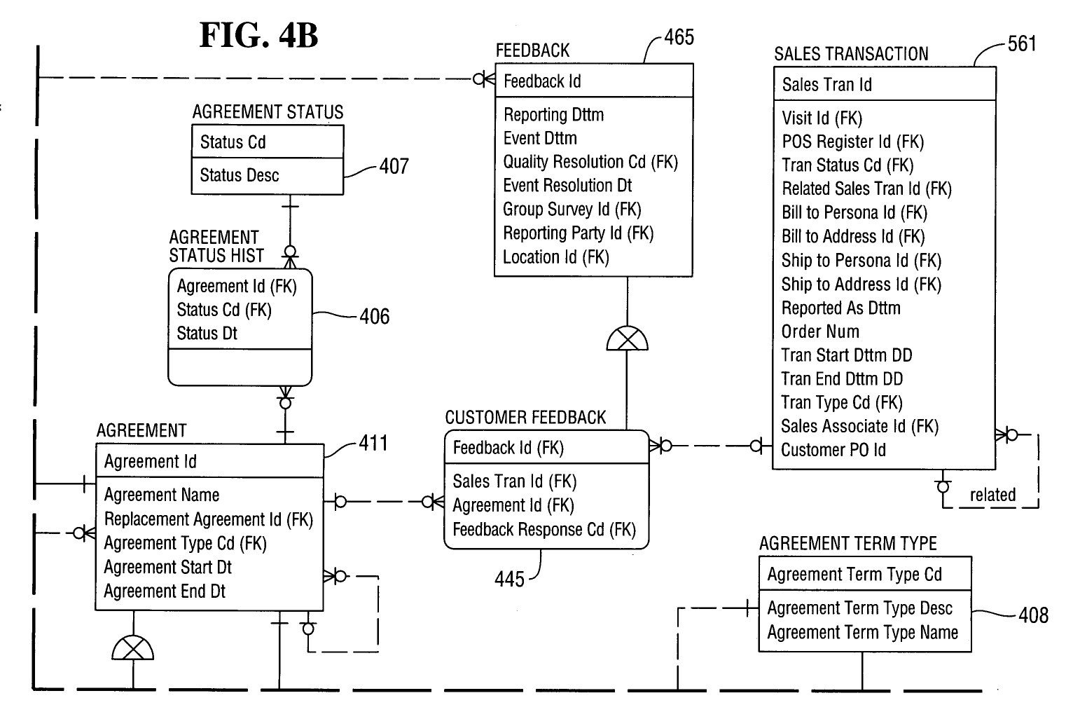

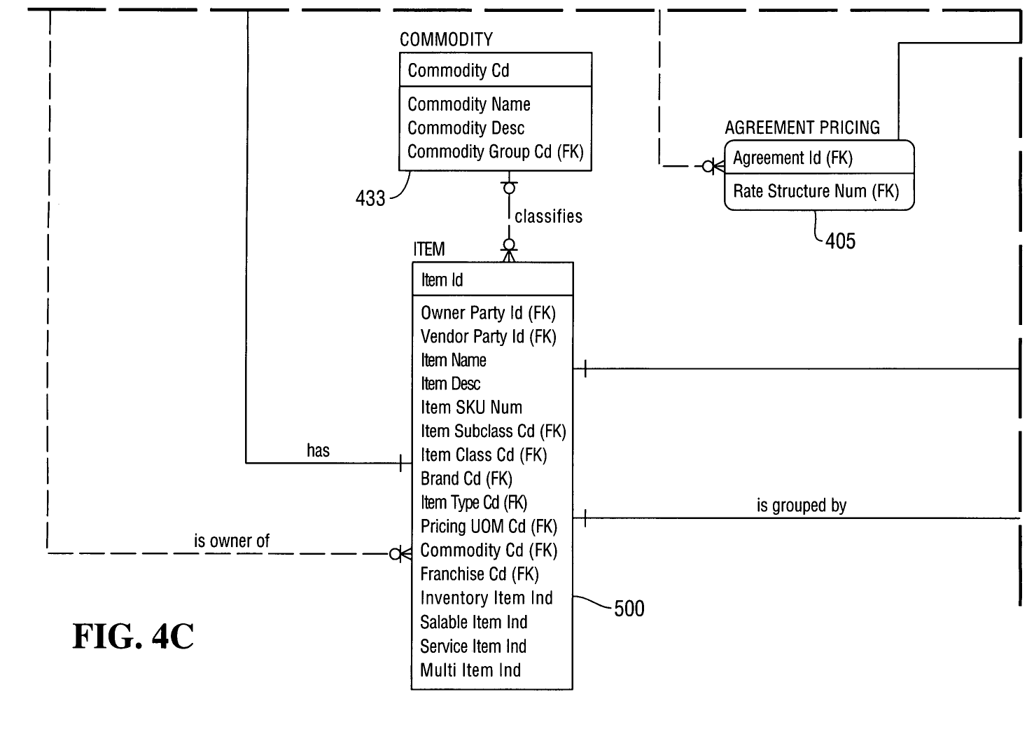

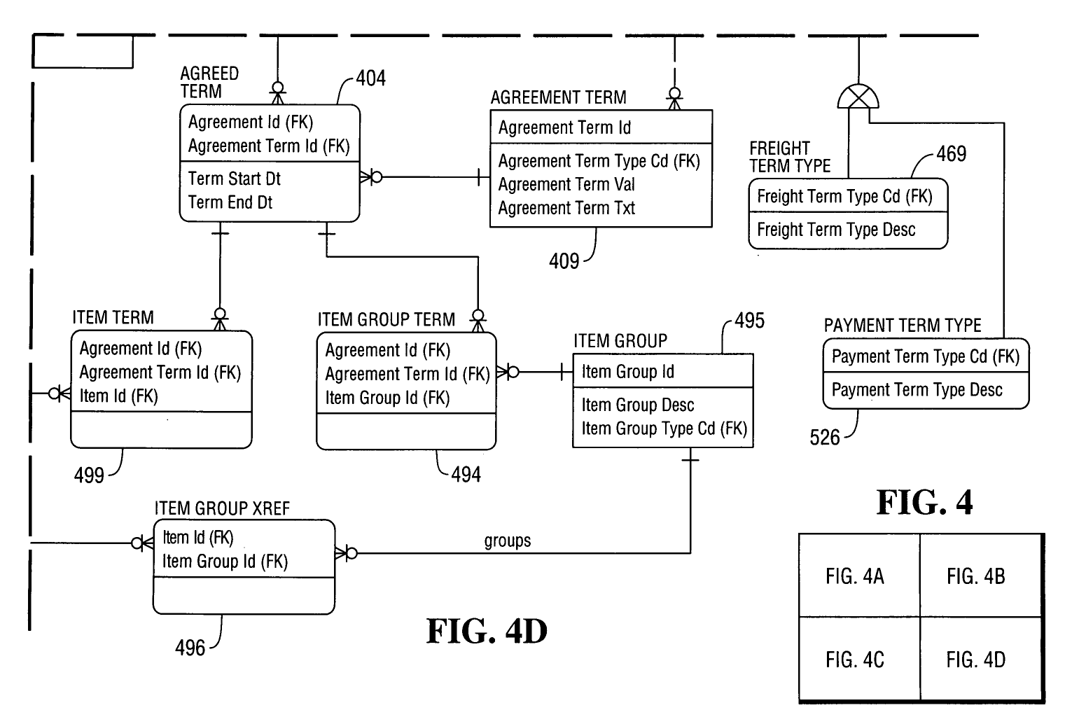

Subject Area Views, such as the AGREEMENT subject area view illustrated in FIGS. 4A through 4D, show small (but highly detailed) subsets of the model. Subject areas are collections of entities about business information objects or concepts that are closely related. The sum total of all subject areas equals the rLDM. For ease of use and understanding, the Retail Logical Data Model has been divided into the following fifty-six (56) subject areas, titled:

1. ADDRESS

2. AGREEMENT

3. ASSOCIATE LABOR

4. CATALOG

5. DEMOGRAPHICS

6. FM.AP AR PA INVOICE

7. FM.AP INVOICE

8. FM.AP PAYMENT

9. FM.AR INVOICE

10. FM.AR PAYMENT AND COLLECTION

11. FM.FA FIXED ASSET

12. FM.GL.ASSET ACCOUNT

13. FM.GL.EQUITY ACCOUNT

14. FM.GL.EXPENSE ACCOUNT

15. FM.GL.GENERAL LEDGER ACCOUNT

16. FM.GL.CHART OF ACCOUNT BALANCE

17. FM.GL.PRODUCT SEGMENT

18. FM.GL.PROJECT SEGMENT

19. FM.GL.SUB ACCOUNT

20. FM.GL.JOURNAL ENTRY

21. FM.GL.LIABILITY ACCOUNT

22. FM.GL.REVENUE ACCOUNT

23. FM.PA PROJECT

24. FM.PA PROJECT RESOURCE

25. FM.PARTY

26. FM.PO PROCUREMENT

27. FM.PO PROCUREMENT RECEIPT

28. FM.PO PROCUREMENT RETURN

29. ITEM DEFINITION

30. ITEM PRICING

31. INVENTORY (EXTERNAL)

32. INVENTORY (INTERNAL)

33. INVOICE

34. LOCATION

35. MODEL SCORE AND FORECAST

36. MULTIMEDIA

37. PARTY

38. PAYMENT ACCOUNT

39. PHARMACY

40. PLANOGRAM

41. POINT OF SALE REGISTER

42. PRIVACY

43. PROMOTION

44. QUALITY FEEDBACK

45. RFID/SERIALIZED ITEM TRACKING

46. SALES (EXTERNAL)

47. SALES (INTERNAL)

48. SHIPPING ORDER

49. SHIPPING PLAN

50. SHIPPING REGULATION

51. SHIPPING TRANSPORT

52. TIME PERIOD

53. VENDOR (SUPPLIER)

54. WEB OPERATIONS

55. WEB SITE

56. WEB VISIT

Details about each of these subject areas follow.

The ADDRESS subject area, represented by ADDRESS entity 401 in the conceptual model of FIG. 3, is used to capture all ADDRESS information that can be used for communications and physical addressing. Each unique occurrence of an ADDRESS may represent a physical MAILING ADDRESS (e.g., street, post office box), a TELEPHONE ADDRESS (e.g., voice or fax number), or an ELECTRONIC ADDRESS (e.g., e-mail, ftp, or URL). Internet Protocol addresses are modeled separately in the entity IP ADDRESS within the WEB VISIT subject area.

The AGREEMENT subject area, represented by AGREEMENT entity 411, defines the specific terms and conditions between Parties. This subject area is used to track the specific agreements made relating to pricing, as well as the specific terms and conditions associated with the sale, payment and/or delivery of products and/or services between Parties, in a quantitative manner, so that analysis can be better performed to determine performance compliancy.

The ASSOCIATE LABOR subject area, represented by ASSOCIATE LABOR entity 301 in FIG. 3, defines key business characteristics of an ASSOCIATE, sometimes referred to as an “employee” who, as an individual, is part of the internal organization of the Enterprise. The key emphasis of the ASSOCIATE LABOR subject area is to track the critical information necessary to understand, analyze and make better decisions regarding an Enterprise's labor costs and related labor expenses, as they relate to each ASSOCIATE.

This section models both the forecasted, or planned, labor for each location (stores, distribution and call centers, etc.) in cost amounts and hours (including overtime) and the schedule of work for each Associate. A history of expenses related to associate labor and benefits is provided to aid in comparison analyses.

The CATALOG subject area, represented by entity 421 in FIG. 3, is used to describe the content and usage of catalogs by an enterprise. The intent is to accommodate the typical printed catalog that is mass-mailed to a targeted/segmented group of potential customers. This Subject Area allows tracking of the success of a specific catalog or mailing, since it is related to the SALES (INTERNAL) Subject Area, indicating which sales were made from which catalog mailed to what target group.

Although targeted mainly at enterprises doing conventional catalog/mail order business, this section can be adapted for usage to also describe promotional flyers, and other printed offerings if required.

The pages of a Catalog may be either printed for mailing and physical distribution or may be “virtual” pages placed on a web site. Additional features are available on web sites such as keyword search and automated orders. This type of customer interaction is captured in the WEB VISIT subject area.

The DEMOGRAPHICS subject area is represented in FIG. 3 by DEMOGRAPHIC entity 451, MARKET GROUP entity 510 and MARKET SEGMENT entity 511. The DEMOGRAPHICS subject area contains information obtained (purchased/leased) from external sources. Its primary usage is for the creation of SEGMENTs (groups of PARTYs sharing common characteristics) for marketing purposes.

MARKET GROUPs record third party aggregated sales data, such as that purchased from Nielson or IRI, for example. Information about these groups (e.g., supermarket, category discounter, drug store, etc.) is typically purchased and often used by the Enterprise to measure its performance in the marketplace. Market Groups may also be associated with various DEMOGRAPHICs.

MARKET SEGMENTs are groups of PARTYs targeted by the Enterprise for marketing and/or analysis (and may be formed via algorithmic modeling or forecasting—See MODEL SCORE & FORECAST Subject Area). These segments are also related to DEMOGRAPHICs to enhance and support analysis and targeted sales campaigns (See PROMOTION Subject Area).

The twenty-three Financial Management (FM) subject areas; FM.AP AR PA INVOICE, FM.AP INVOICE, FM.AP PAYMENT, FM.AR INVOICE, FM.AR PAYMENT AND COLLECTION, FM.FA FIXED ASSET, FM.GL.ASSET ACCOUNT, FM.GL.EQUITY ACCOUNT, FM.GL.EXPENSE ACCOUNT, FM.GL.GENERAL LEDGER ACCOUNT, FM.GL.CHART OF ACCOUNT BALANCE, FM.GL.PRODUCT SEGMENT, FM.GL.PROJECT SEGMENT, FM.GL.SUB ACCOUNT, FM.GL.JOURNAL ENTRY, FM.GL.LIABILITY ACCOUNT, FM.GL.REVENUE ACCOUNT, FM.PA PROJECT, FM.PA PROJECT RESOURCE, FM.PARTY, FM.PO PROCUREMENT, FM.PO PROCUREMENT RECEIPT, FM.PO PROCUREMENT RETURN; are represented by a single entity, FINANCIAL MANAGEMENT entity 302 in FIG. 3.

The FM.AP AR PA INVOICE subject area contains information related to various types of billing documents or Invoices encountered by a business. Invoices are presented to a bill-to-party as a request for payment for goods sold or services rendered. This subject area links the Invoice detail back to the originating business transactions for verification and analytical purposes.

The FM.AP INVOICE subject area describes the details around amounts owed to a supplier for goods and services purchased. The Accounts Payable subledger holds details for these transactions including reimbursable expenses (employee expense reports) and recurring expenses.

The FM.AP PAYMENT subject area holds payment details for AP Invoices. Payments are the partial or complete discharge of the invoice obligation, typically by its settlement in the form of a transfer of funds. Payments may be applied against obligations represented by one or more Invoices.

The FM.AR INVOICE subject area describes the details around amounts billed to customers for goods and services sold. Summary Accounts Receivable amounts as well as sales and revenue amounts from the AR subledger are recorded to the company's General Ledger.

The FM.AR PAYMENT AND COLLECTION subject area describes the details concerning the process of converting Accounts Receivable to Cash. Payments may be received for AR Invoices, as well as interest earned, rents receivable, or periodic products and services provided. Collection activity includes any action a company takes to solicit settlement of AR obligations.

The FM.FA FIXED ASSET subject area holds information needed to track the addition and disposal of the tangible property of the business. This subject area also holds information needed to calculate and record the depreciation of an asset, including term, depreciation methods, accounting cycle, costs and residual values.

The FM.GL.ASSET ACCOUNT subject area contains information concerning enterprise assets. Assets are tangible or intangible property owned by a business, having monetary value (usually at cost or fair market value). These range from cash and investments to real estate such as land, other tangible property such as timber, or enforceable claims against others, etc. For accounting purposes these are usually classified under three groups: Current Assets, Fixed Assets and Other Assets.

The FM.GL.CHART OF ACCOUNT BALANCE subject area contains information concerning an enterprise's Chart of Account Balances. GL Chart of Accounts Balances are actual amounts experienced through some point in time, or budgeted amounts projected for a financial plan. Companies maintain only one record of actual amounts, but may define multiple financial plans and maintain balances for each financial plan instance.

The FM.GL.EQUITY ACCOUNT subject area contains information concerning equity in an enterprise. Equity is the shareholders' stake in any company/business. From a financial accounting standpoint, Equity is total assets less total liabilities, also referred to as Net Worth.

The FM.GL.EXPENSE ACCOUNT subject area contains information concerning enterprise expenses. Expense is the amount spent by a company in running the business and producing goods or services. Some of the typical expense accounts are OPERATING EXPENSE ACCOUNT, INTEREST EXPENSE ACCOUNT, etc.

The FM.GL.GENERAL LEDGER ACCOUNT subject area contains information concerning an enterprise's General Ledger. The General Ledger is a collection of all accounts used by a business. It is the accounting transaction record, maintained either manually or using computer software, of all the balance sheet and income statement balances of a company or business. Previously as the name suggests, the General Ledger was a collection of books that was used to physically record accounting transactions. Today these transactions are generally recorded and stored by using computer software.

There are five main types of GENERAL LEDGER (GL) ACCOUNTs. They are ASSET ACCOUNT, LIABILITY ACCOUNT, EXPENSE ACCOUNT, REVENUE ACCOUNT and EQUITY ACCOUNT. Each account in turn may have sub-ledgers. For example, ASSET ACCOUNT consists of a group of accounts such as Fixed Asset Account, Current Asset Account, etc. The GL ACCOUNTs are shared by various internal organizations within a business and therefore are associated with other GL Segments in segment groups to track and report financial information.

The FM.GL.JOURNAL ENTRY subject area contains information concerning an enterprise's Journal Entries. Journal Entries record the monetary value of business transactions into GL Accounts as debits or credits. Journal Entries usually include supporting information referencing the transaction events or items affected, such as a vendor invoice, customer invoice, or inventory receipt.

The FM.GL.LIABILITY ACCOUNT subject area contains information concerning liabilities of an enterprise. The liabilities of a company are amounts owed to other parties or organizations representing loans, expenses, or any other form of a legally enforceable claim on the company's assets, excluding owner's equity that calls for the transfer of assets at a determined future date.

The FM.GL.PRODUCT SEGMENT subject area is associated with GL Accounts in segment groups to track and report financial product information.

The FM.GL.PROJECT SEGMENT subject area is associated with GL Accounts in segment groups to track and report financial project information. The GL PROJECT SEGMENT is used to track details of any type of business project activity.

The FM.GL.REVENUE ACCOUNT subject area contains information concerning enterprise revenue. Revenue (sometimes referred to as income) refers to the amount of money earned by a company.

The FM.GL.SUB ACCOUNT subject area is associated with GL Accounts in segment groups to track and report financial transactions for a company.

The FM.PA PROJECT subject area provides more granularity to project financial information than a General Ledger. Project Accounting (PA) focuses on maintaining control over revenues, costs, resources, and assets directly associated with a project.

A project can be any set of related business activities for which a company wishes to track financial information. Project expenses may include associates' time and expense reports, vendor expenses, and capital expenses. Project revenue is generated when project expenses are billable to a customer. PA generates the detailed information needed to create a customer invoice, but the invoice is actually processed through the billing function of Accounts Receivable.

Within PA, budgets by project, resource, task, etc. may be maintained separately from the General Ledger budget. PA supports project reporting by task, resource, vendor, and customer for different currencies and time periods. In some cases, PA tracks projects by specific project reporting periods, which may be separate from a company's accounting period.

The FM.PA PROJECT RESOURCE subject area tracks items and individuals assigned to a scheduled task in a project plan. The cost and billable rates associated with these Items and Individuals will be used in the Project Financial Plan.

The FM.PARTY subject area defines the people and organizations of interest to the enterprise as they pertain to Financial Management and its particular business requirements.

The FM.PO PROCUREMENT subject area represents information related to the process of acquiring the goods (materials, parts, supplies, equipment) required to run the business. PO Procurement as an overall business function covers the process from requisition to order, to tracking receipts and returns.

The FM.PO PROCUREMENT RECEIPT subject area tracks the actual receipt of items ordered for comparison to the Purchase Order and related AP Invoice. It also allows for analysis as to whether the original due dates for the receipt were actually met.

The FM.PO PROCUREMENT RETURN subject area holds information about transactions where the receiving PARTY sends back to the vendor or supplier Item(s) that were previously received.

The INVENTORY subject areas, represented in the conceptual model of FIG. 3 by INVENTORY ITEM entity 477 and INVENTORY TRANSACTION entity 480 details the movement of inventory between locations (facilities) as well as tracking physical and calculated stock levels and value, and provides for controlling in-stock and replenishment levels. Inventory is a company's merchandise, raw materials, and finished and unfinished products which have not yet been sold. Inventory can be individually valued by several different means, including cost or current market value, and collectively by FIFO (First in, first out), LIFO (Last in, first out) or other techniques.

The INVENTORY (EXTERNAL) subject area details the adjustments to Inventory where at least one EXTERNAL Location is involved. Control of Inventory is transferred to or from a Third Party and Inventory is adjusted accordingly.

The INVENTORY (INTERNAL) subject area details the movement of inventory between and the adjustments to inventory where only INTERNAL locations (e.g., Stores, DCs, Warehouses) are involved. Control of inventory is not transferred to or from a Third Party.

The INVOICE subject area, represented by INVOICE entity 493, holds information concerning INVOICEs, which represent a request for payment by a third party vendor (supplier) to the enterprise, or by the enterprise to a customer for goods provided or services rendered.

The ITEM DEFINITION subject area, represented by ITEM entity 500 in FIG. 3 details all the ITEMs of interest to an enterprise. An ITEM is the lowest level for which inventory and sales records are retained within the retail store. It can be analogous to a SKU (Stock Keeping Unit).

The ITEM PRICING subject area, represented by ITEM PRICING entity 498, supports Item Pricing and Costing. The inclusion of effective dates allows for historical pricing and costing information to be captured. Future pricing information can also be captured.

The LOCATION subject area, represented by entities 506 and 422, LOCATION and CHANNEL, respectively, in FIG. 3, defines a physical or virtual site or facility which is owned or leased by a retailer to support the sale of goods, distribution, and storage. A LOCATION may be a WEB STORE, KIOSK, CALL CENTER, “brickand-mortar” STORE, PHARMACY, DISTRIBUTION CENTER, etc.

The MODEL, SCORE & FORECAST subject area supports functional areas such as:

(1) CUSTOMER RELATIONSHIP MANAGEMENT (CRM). By using Customer Scoring the Enterprise can tag their customers in a multitude of different ways to highlight their best customers for differentiated treatment. Example: Customers can be ‘scored’ for profitability, frequency of purchases, propensity to buy, etc. Vendors and suppliers may similarly be ‘scored’ on accuracy of orders, delivery time etc.

(2) DEMAND AND SUPPLY CHAIN MANAGEMENT. The various forecasting entities can be populated by the enterprise using their own statistical methods or by using the output of 3rd party applications. Since the model contains internally generated Sales and Order Forecasts, as well as Vendor generated Forecasts, these forecasts can be compared for possible deltas and exception reporting. And:

(3) KNOWLEDGE MANAGEMENT/DATA MINING. Supports information regarding the Analytical Models used to predict, cluster, or classify information that is typically used in Data Mining and Knowledge Discovery. Example: A Model that describes the propensity of a customer to buy a given item, etc.

The MODEL, SCORE & FORECAST subject area is represented in the conceptual model of FIG. 3 by ANALYTICAL MODEL entity 413, FORECAST entity 303, and PARTY SCORE entity 521.

This MULTMEDIA subject area, represented by entity 304 in FIG. 3, models the various multimedia elements that the enterprise uses to construct marketing collateral

The PARTY subject area defines the people and organizations of interest to an enterprise. This subject area is represented in the conceptual model by PARTY entity 524, HOUSEHOLD entity 473, INDIVIDUAL entity 474, ORGANIZATION entity 515, and PERSONA entity 529.

The PAYMENT ACCOUNT subject area, represented by PAYMENT ACCOUNT entity 525 and LOYALTY ACCOUNT entity 508 in FIG. 3, describes the mechanism by which goods are be paid for, other than cash). Three main areas are described: conventional, typically external, payment accounts, such as credit cards, checking accounts, in-house credit cards, etc.; loyalty accounts comprising in-house programs designed to encourage customers to make purchases by offering rewards; and internal accounts such as Gift Cards, Gift Certificates, etc.

The PHARMACY subject area represents information about the dispensing and payment for prescription drugs, from the perspective of a Retail Pharmacy. This subject is represented in FIG. 3 by PHARMACY entity 530 and PRESCRIPTION entity 305.

The PLANOGRAM subject area, represented by entity 537 in FIG. 3, models information concerning where items are located in a store, as well as relationships to other items in their proximity.

The POINT OF SALE REGISTER subject area is represented by entity 538 in FIG. 3. This subject are is used to capture all non-sales related transactions involving P.O.S. Registers (Associate sign-in/out or No-Sale events, etc.) as well as specific sales transaction related keying sequence events (quantity key, price override). Application areas that can make use of this information could be, for example, cashier productivity, loss prevention, fraud detection or validation/auditing applications that reconcile data warehouse content with actual P.O.S. logs.

Two main areas are covered: Register events (POS SALES) taking place as part of a Sale (quantity key, price override, etc.), and those Register events (POS NON SALES) taking place independent of a Sales transaction (settlement, logging, etc.).

The detail information in this Subject Area is critical in tracking and identifying exceptions, suspicious or potentially fraudulent activities and for productivity and training plans and issues.

The PRIVACY subject area represents a PARTY's privacy settings for the collection and use of personal data. Privacy, and the control of one's personal data, is rapidly gaining attention in the media and political arena. Consumers are becoming more privacy-assertive; and with the rapid adoption of online privacy for the Web, offline privacy expectations are rising. This subject is represented in FIG. 3 by PRIVACY entity 306.

Privacy data fields are those which pertain to personal data, such as age, gender, income, marital status, or purchase habits;, reveal identity, such as name, address, phone number, social security number, bank account number; or “special categories” of data, such as racial or ethnic origin, religious beliefs, etc.

The PROMOTION subject area models the key information necessary to support the tracking and analysis of an enterprise's marketing efforts. It allows the determination of promotional effectiveness by tracking market segments or individuals targeted with promotional offers and the eventual response to the promotion in the form of Sales lift or Coupon redemption. This area also captures the promotion budget, actual promotion expenses and expected or planned sales revenue associated with a given promotion. The PROMOTION subject are is represented by entity 541 in FIG. 3.

The QUALITY FEEDBACK subject area, represented by QUALITY FEEDBACK entity 307 and QUALITY GROUP SURVEY entity 544, provides a view of all aspects of quality feedback tracking present in the Retail Logical Data Model. The primary reason for this subject area and content is to capture feedback received by an enterprise, typically regarding the quality of its products and services, in an effort to analyze and improve the quality of the retailer's products and services.

The RFID/SERIALIZED ITEM TRACKING subject area provides a view of all aspects of Serialized Item tracking present in the model, supporting the use of RFID (Radio Frequency Identification) Technology in the retail industry.

The Subject Area, represented by entities 308, 565 and 266 in FIG. 3, tracks the three different types of movement of Serialized Items: movement to and from suppliers, movement between internal locations, and movement to and from customers.

The SALES (EXTERNAL) subject area, represented by entity 309 in FIG. 3, details sales transactions reported by a third party, possibly from a Trading Partner or Purchased/leased information from a syndication organization such as VNU, IRI, Nielsen, etc. The enterprise is neither the selling nor purchasing party in any of these transactions.

Syndicated information is available at many different aggregation levels, but is typically grouped by MARKET GROUP, shown as entity 510 in FIG. 3, externally defined grouping of organizations that are part of the same sub-industry, such as supermarkets, convenience stores, drugstores, mass merchandisers, warehouse clubs, etc.

External sales information is used by an enterprise to measure market share and performance.

The SALES (INTERNAL) subject area, represented by entity 310 in FIG. 3, captures information concerning the sale and fulfillment of products and services offered by an enterprise. This subject area details what was sold to whom, who paid for it, how paid for, and when, how and by whom it was provided to the customer.

Sales transactions are grouped together at a VISIT level, shown as entity 335 in FIG. 3, defining all the sales related transactions made by a customer during a predefined time period at a given location.

The SHIPPING ORDER subject area, represented by FREIGHT BILL entity 468 in FIG. 3, details the content of a SHIPMENT, the PIECEs, or Handling Units, that make up a Shipment, the actual Items contained therein, the different PARTIES involved, the TRANSPORTATION SERVICES requested, and any potential CLAIMs made against selected Shipment Pieces.

The SHIPPING PLAN Subject Area supports two distinctly different Transportation and Shipping Planning options. The first Planning area allows for the advance route, rate, carrier, service, and cost planning of every single (or select) Shipment. The second Planning area covers a global ‘goal setting’ capability.

The SHIPPING REGULATION subject area, represented by CUSTOMS REQUIREMENT entity 449, specifies the rules and regulations of transporting goods over borders. As part of the critical information that this subject area supports, it specifically defines the official information required to be presented to the Controlling Authority.

The SHIPPING TRANSPORT subject area, represented by ASSET entity 416, and LEG EQUIPMENT entity 503 details the actual transporting of a Shipment, including all tracking information, transport mode(s) used, legs and routes traveled and the Equipment utilized.

The TIME PERIOD subject area, not shown, can be used to map country-specific holidays and events, climate and sales seasons. Additionally, it can be used to map into an enterprise's accounting and fiscal time periods.

The VENDOR (SUPPLIER) subject area, represented by entity VENDOR entity 619 in FIG. 3, captures information concerning the type of ORGANIZATION that supplies ITEMs to a retail company. This area models purchase orders made to the VENDOR and receipt of items in return.

The WEB OPERATIONS subject area models web server activity and web visit interactions. The central entity within the WEB OPERATIONS subject area is the WEB SERVER entity, identified by reference numeral 622 in FIG. 3. This subject area also models other areas associated with web site services. Such information as server capacity, software and activity provide for monitoring and maintenance are tracked.

All key aspects of an enterprise's web site(s); e.g., the content, intent, multimedia components, advertising, page navigation, etc.; are represented in the WEB SITE subject area. The WEB SITE subject area is represented in the conceptual model of FIG. 3 by WEB SITE entity 623 and WEB STORE entity 624.

The WEB VISIT subject area is represented by REFERRAL entity 551 and WEB PAGE VIEW entity 621 in FIG. 3. This subject area stores information about web visitors, visitor web activity and browsing history, and referrals.

More detailed information concerning the above described subject areas is available in Provisional Application Ser. No. ______, entitled “TERADATA RETAIL LOGICAL DATA MODEL 5.01,” filed on Nov. 14, 2007, attorney's docket number 13276.

### Supply Chain and Logistics Support Subject Areas

Information concerning the supply chain and logistics support is contained principally within the SHIPPING ORDER, SHIPPING PLAN, SHIPPING REGULATION, and SHIPPING TRANSPORT subject areas within the Retail Logical Data Model. However, additional relevant information is also contained with the AGREEMENT, INVENTORY (EXTERNAL), INVOICE subject areas. These subject areas are illustrated in FIGS. 4 through 10, described below.

FIGS. 4A through 4D illustrate an entity-relationship diagram of the AGREEMENT subject area of the Retail Logical Data Model. The AGREEMENT subject area defines the specific terms and conditions between Parties and is used to track the specific agreements made relating to pricing, as well as the specific terms and conditions associated with the sale, payment and/or delivery of products and/or services between Parties, in a quantitative manner, so that analysis can be better performed to determine performance compliancy.

An AGREEMENT can represent the terms between the enterprise and a specific Third Party as they relate to a given price or pricing RATE STRUCTURE (“price list”) for products and services, e.g., pricing conditions based on volume breaks, location dependencies, etc.; the terms and conditions associated with the special handling and delivery of a specific ITEM or group of ITEMs, e.g., liability carried by a third party carrier for a given shipment line of goods in case of loss or damages, order to be cancelled if not delivered by agreed date, etc.; or the terms and conditions associated with the payment of goods provided or services rendered, e.g., payment term of 30 days, 2 10 Net 30 on Delivery—Discount of 2% off invoiced payment if paid within 10 days after delivery, otherwise full invoice payment due in 30 days after delivery, etc.

An AGREEMENT can be linked to CUSTOMER FEEDBACK received directly from a customer, where the customer or individual contacted the enterprise. Example: Customer informs enterprise that they can get better terms from a competitor, Customer fills out an online survey and receives a discount or free gift based the terms and conditions of a promotion attached to his/her sales transaction, etc.

The entities of the AGREEMENT subject area, illustrated in FIGS. 4A through 4D, are defined as follows:

AGREED TERM (404) A specific term that forms part of a specific AGREEMENT. Examples include: Discount of 5%, Max Liability of x amount, Payment Term is 30 days, etc.

AGREEMENT PRICING (405) Defines the specific AGREEMENT with a specific PARTY relative to prices, terms and conditions, e.g., the terms between a third PARTY and an enterprise as it relates to the pricing of products and services.

AGREEMENT STATUS HIST (406) Defines the specific Pricing RATE STRUCTURE that is referenced in an AGREEMENT with a PARTY (typically a customer).

AGREEMENT STATUS (407) Defines the status of an Agreement. Examples include: Active, Cancelled, and Expired.

AGREEMENT TERM TYPE (408) Defines the status change for a specific Agreement. Examples include “2/4/1999 Active” and “6/6/2005 Cancelled”.

AGREEMENT TERM (409) A specific term that forms part of an AGREEMENT. This allows for re-use of identical Agreement Terms in multiple Agreements. Examples include: Late Delivery Penalty of 0.5%, Max Liability of x amount, Payment Terms is 30 days, etc.

AGREEMENT TYPE (410) The type of term that can be specified in an AGREEMENT. Examples include: Late Delivery fine, Max Liability, Specialized Billing, Special Handling services, Exclusivity Clause, Payment Terms, Freight Terms (who pays for shipping), etc.

AGREEMENT (411) Indicates the specific type of Agreement, e.g., Pricing Agreement or Delivery Agreement.

COMMODITY (433) A scheme for classifying products and services using a recognized third-party classification method, enabling a common reference for business-to-business usage, electronic catalogs, search engines and economic reporting/comparison purposes, etc. The Commodity classification of an Item can be used to help determine transportation rates, hazardous material information, customs implications, etc. Two such classification methods are the United Nations Standard Products and Services Classification (UNSPSC) and the National Motor Freight Classification (NMFC).

The United Nations Standard Products and Services Classification (UNSPSC) is an open global coding system that classifies products and services. Example coding for the UNSPSC:

10.10.20.01 Elephants

25.20.21.00 Flight instrumentation

27.11.17.15 Torque wrenches

27.13.15.12 Pneumatic screwdriver

31.16.15.00 Screws

53.13.16.19 Cosmetics

71.12.30.02. Integrated operation, engineering, modification, maintenance services

73.13.16.08 Cold storage services

78.10.15.00 Air cargo transport

78.10.15.01 Domestic air cargo transport

78.10.22.04 Letter or small parcel worldwide delivery services

90.11.18.00 Hotel rooms

90.15.19.01 Casinos

The National Motor Freight Classification (NMFC) code used to identify specific freight by a pre-defined code and class defined by the National Motor Freight Traffic Association. The NMFC code is used to determine CLASS RATING, liability information, hazardous material designation, etc.

CUSTOMER FEEDBACK (445) Feedback received directly from a customer, where the customer or individual contacted the enterprise. Feedback can be regarding an existing order, agreement, shipment, etc., e.g., customer informs enterprise that they can get better terms from a competitor, customer called the enterprise after a visit or product order, or customer completed a survey form available in an enterprise location.

If needed, individual subtype entities can be created for each type of business transaction feedback or contact that is collected (Agreements, Sales, Orders, Shipments, etc.).

FEEDBACK (465) An entity that can be used to organize or group unstructured feedback at a high level. Possible Examples: Product related, Service related, Staff related, Store related, etc.

FREIGHT TERM TYPE (469) Indicates the payment agreement for the freight. Examples of fixed values are: Prepaid (The Shipper/Consignor pays), Third Party (A Party other than the Shipper or Receiver pays), and Collect (The Receiver/Consignee pays).

Even though a Debtor (Paying) Party is included as an attribute for every SHIPMENT, it may be non-trivial to determine if the Debtor is actually the same party as the Shipper or Receiver, due to multiple Organizational Hierarchy Identifiers for a PARTY. An example could be where the enterprise assigned different Party Ids for the Customer and the Customer's Headquarters (or Holding Company). In this case, even though the Shipper IS the Debtor Party, the actual Shipper Party Id and Debtor Party Id may differ—but the Payment Term would clearly indicate this fact.

ITEM GROUP TERM (494) Terms or conditions that are associated with a contract and a group of items. Examples: Special handling or delivery requirements for a group of Items.

ITEM GROUP (495) A cluster of ITEMs, grouped together for analytical or merchandising reasons. Can be used for permanent, global, or ad-hoc reasons, e.g., an analyst can define an ITEM GROUP to be all ITEMs that had a return rate of over 10%. This can then be used to easily track and report on these ITEMs in future. An ITEM can be in multiple ITEM GROUPs at the same time.

ITEM GROUP XREF (496) Defines which ITEMs are contained in which GROUPs.

ITEM PRICING (498) A Specific Price for a specific Item for a date range, based on a set of pricing conditions, e.g., price for Item A if 100+ are purchased from Location B during 2005.

ITEM TERM (499) Terms or conditions that are associated with a contract and a specific item, e.g., special handling or delivery requirements for a given Item.

ITEM (500) An ITEM is the lowest level for which inventory and sales records are retained within the enterprise. A unique identifier for a grouping of one or more products or services and the corresponding price plan, rate structure or unit charge that may marketed by the organization for the purpose of generating revenue. An item is what a customer purchases or subscribes to. Examples include: Parker Elite fountain pen in silver, Campbell's Hearty Tomato Soup 4 oz can, Photo Printing Service, Overnight Transportation Service, Accessorial Service, etc.

PARTY AGREEMENT ROLE (518) Defines the Parties involved in the Agreement and their roles. Examples: the Party who will be providing the goods or services detailed in the Agreement, the Party who will be paying for the goods or services detailed in the Agreement, and Other Parties such as Agreement Negotiator, etc.

PARTY ROLE (520) Code and description used to identify the role of the PARTY in a Transaction. Examples: Agent, Supplier, Inspector, Approver, Reservationist, Traveler, Travel Requestor, etc.

PARTY (524) A party is any individual, organization or household that is of interest to the enterprise.

PAYMENT TERM TYPE (526) Contains the list of all the Payment Terms to be associated with scheduled payment, customer/vendors and INVOICEs. Examples are Net 10 days, Net 45 days, Prepayment. Payment terms are used in calculating the payment schedule. Payment Terms allow the calculation of the due date and the discount date for PAYMENT of a transaction. For example, the payment term “2% 10, Net 30” lets a customer take a two percent discount if PAYMENT is received within 10 days; after 10 days, the entire balance is due within 30 days of the invoice date with no applicable discount.

RATE STRUCTURE (549) A Rate “Table” that defines a specific price for every product or service offered IN COMBINATION with a set of pricing conditions. This presents a unified “price list” that can be made available to a Customer (or group of Customers) via an Agreement. Pricing conditions could be volume breaks, location dependencies, etc. One Rate Structure can be designated as a “base” rate structure (default Pricing).

SALES TRANSACTION (561) A single CUSTOMER interaction or transaction involving the potential or actual Sale or Return of one or more ITEMs. It is very open ended, and can be used to describe any aggregation of ITEMS made by a (potential) customer. For example, this entity can represent Web Shopping Cart, Web Wish-list, Wedding Registry List, Store P.O.S. Sale, Store Layaway Purchase, Catalog Order, etc. It does not always represent an ACTUAL sale.

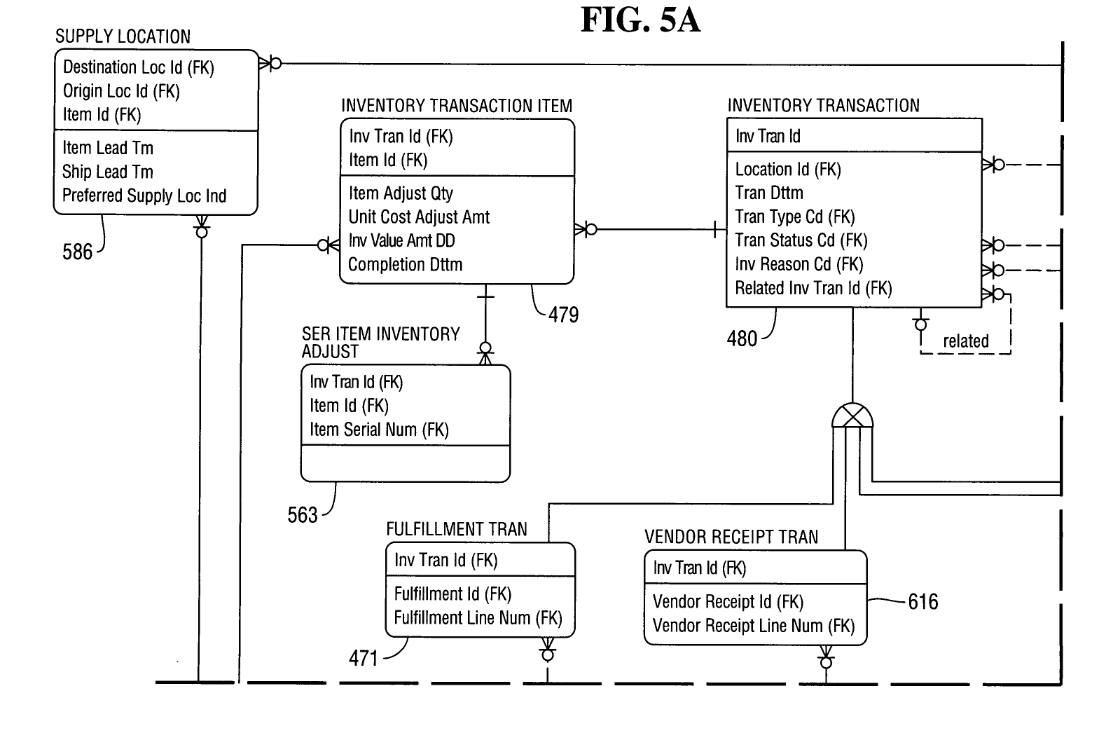

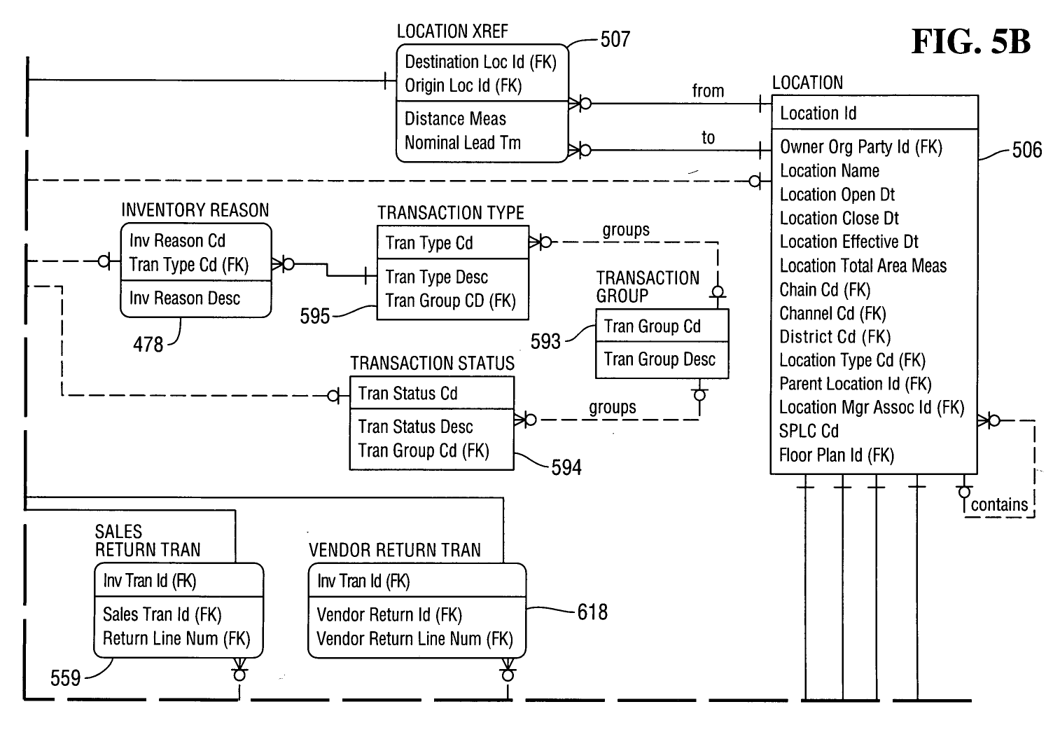

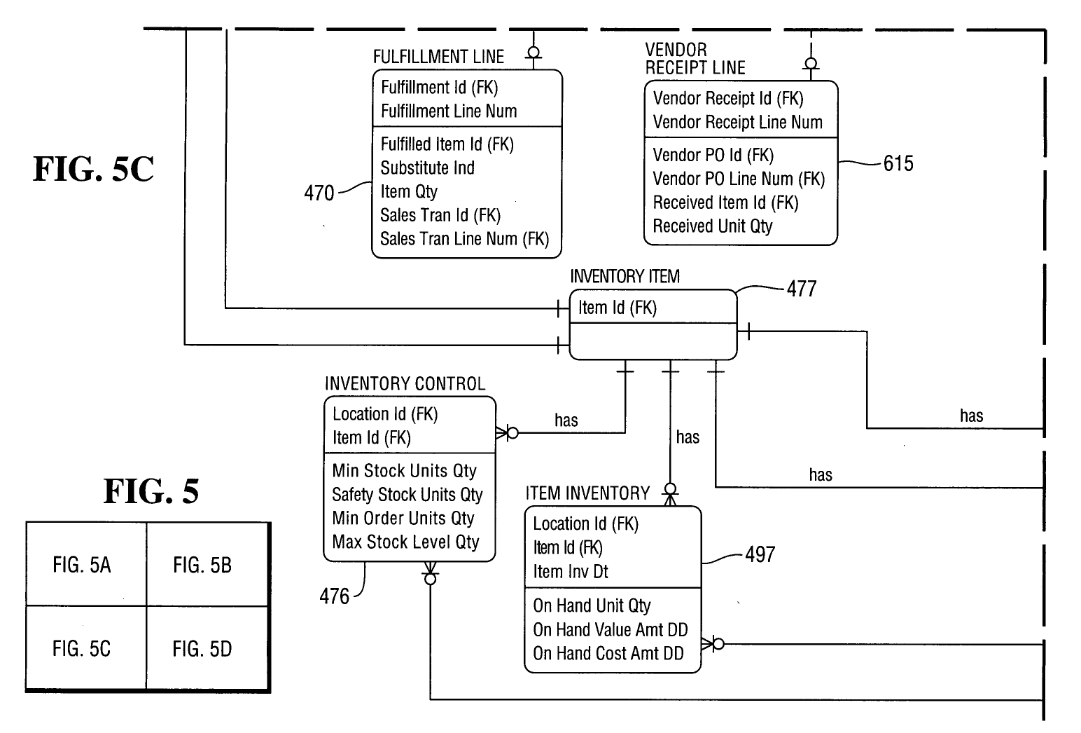

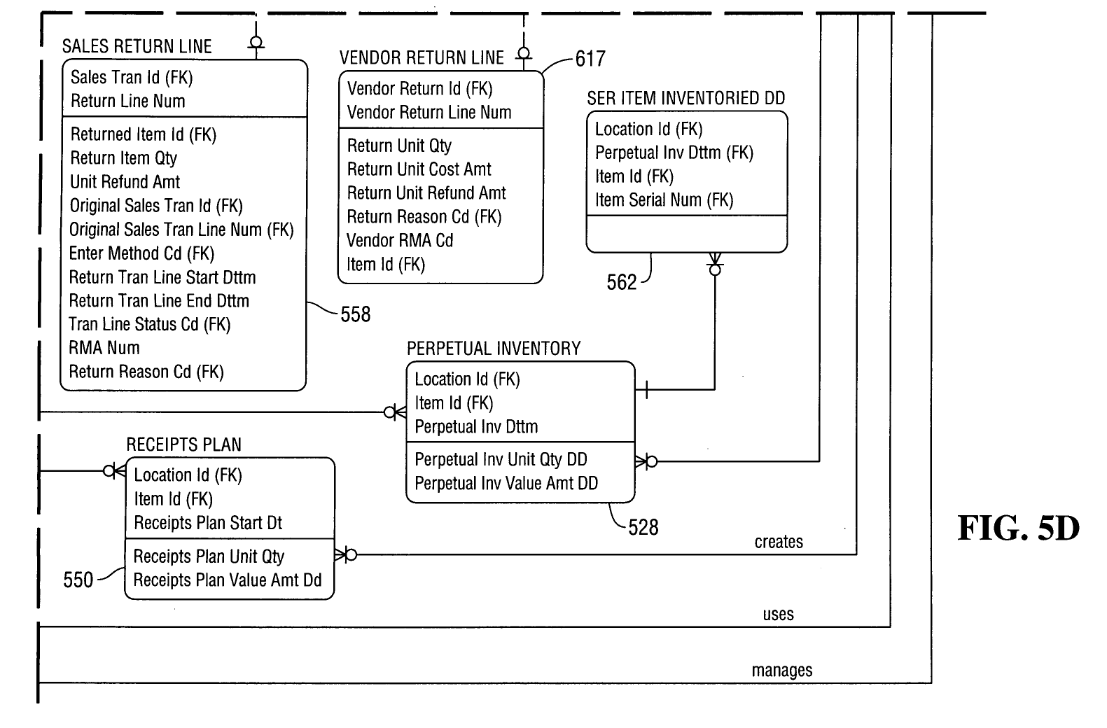

FIGS. 5A through 5D illustrate an entity-relationship diagram of the INVENTORY (EXTERNAL) subject area of the Retail Logical Data Model.

INVENTORY is a company's merchandise, raw materials, and finished and unfinished products which have not yet been sold. They can be individually valued by several different means, including cost or current market value, and collectively by FIFO (First in, first out), LIFO (Last in, first out) or other techniques.

INVENTORY (EXTERNAL) details the adjustments to Inventory where at least one EXTERNAL Location is involved. Control of Inventory is transferred to or from a Third Party and Inventory is adjusted accordingly. Capture and tracking of physical and calculated stock levels and values is also supported as well as providing for controlling in-stock and replenishment levels.

It is critical to not only be able to analyze and track the on-hand stock levels of ITEMs for replenishment and servicing level purposes, but to better understand and detect those specific root cause transactions that are potentially causing the unusual or unplanned inventory fluctuations.

An INVENTORY TRANSACTION that is external in nature represents a transaction or event that affects the inventory level of an INVENTORY ITEM whereby that ITEM is received from, or provided to, an external party (e.g., customer, vendor). Various INVENTORY TRANSACTIONs record the addition or removal of ITEMs. These include ALLOCATION (FULFILLMENT) TRANSACTIONs (fulfillment of customer sales orders), SALES RETURN TRANSACTIONs (return of purchased items by customer), VENDOR RECEIPT TRAN (receipt of item shipment from vendor), and VENDOR RETURN TRANs (return of items back to vendor).

The entities of the INVENTORY (EXTERNAL) subject area, illustrated in FIGS. 5A through 5D, are defined as follows:

FULFILLMENT LINE (470) The actual ITEMs contained in a FULFILLMENT, e.g., Wooden Desk style H14, etc.

FULFILLMENT TRAN (471) Inventory adjustment (negative) made due to the allocation/fulfillment/sale of goods.

INVENTORY CONTROL (476) A cross reference of products or items to locations for the purpose of managing inventory. It specifies the required, re-ordering, and safety levels of stock.

INVENTORY ITEM (477) A subset of (physical) items than can be inventoried. This would exclude service items and virtual items. There would typically be corresponding information for these Items in the Inventory Subject Areas to track levels and locations of the Items. Examples include: Can of soda, 6 pack of Soda cans, Shampoo, Massage oils, Golf clubs, etc.

INVENTORY REASON (478) Indicates the reason for an Inventory Transaction. Examples: Internal Inventory Request (Store Order to Distribution Center), Wastage (Spoiled, Damaged, Beyond expiration date, etc.), Transfer (Normal DC Transfer, Store supply to support promo, Returns from Store to DC, etc.), Audit (Normally scheduled stock count, exception count, etc.), or Configuration (Breakdown of bulk in preparation for shipping to Store, etc.).

It is assumed all items contained in an Inventory Transaction share the same reason code. If the requirement is to differentiate reason codes at the item line level instead, relate the INVENTORY REASON to the INVENTORY TRANSACTION ITEM level.

INVENTORY TRANSACTION ITEM (479) Information about the item involved in the Inventory Transaction. Covers inventory transactions (adjustment of item counts) in locations belonging to the enterprise only. Example: Transferring goods between distribution centers, supplying stores with goods from warehouse locations or distribution centers, adjusting Inventory levels due to shrinkage, wastage or damage, etc.

The item quantity will be positive when adding to the inventory count (transfer in, etc.) and negative when subtracting from the inventory count (transfer out, wastage, etc.)

INVENTORY TRANSACTION (480) An event that affects the inventory level of an item. Inventory Transactions can be Internal (the items remain under the control of the enterprise for the duration of the transaction) or External (the item is received from, or provided to, an external party).

ITEM INVENTORY (497) Represents the expected On Hand Stock position as of a specific date at a given location as seen by the system. It is typically based on a known starting count or base position and adjusted based on known transactions (i.e., sales, returns, receipts, adjustments) that took place during the intervening period leading up to the current reporting date. The values of this entity are as accurate as practical until a periodic physical count is performed to re-synchronize them to with their actual values, if need be. ITEM INVENTORY is utilized by store management, category managers, buyers and merchandisers to analyze inventory on a daily, weekly or specific period basis, thus allowing for better tactical as well as strategic decisions to be made regarding current and future item replenishments, planned or unplanned markdowns, and potential item deletion or reductions, thus resulting in improved inventory positions to reduce potential out of stock and overstock situations.

This entity differs from the Perpetual Inventory entity, which instead reflects all inventory adjustments as they as happen—providing a more real-time/up to date and time inventory representation. Item Inventory represents the On Hand Stock position of a given item at the end or beginning of ‘regular’ or ‘fixed’ period, versus at any point in time during that period.

LOCATION (506) A physical or virtual site or facility which is owned or leased by a PARTY in support of their business activities such as to support the Sales, Distribution, Storage, etc. A Location can be contained in another Location (Pharmacy inside a Retail Store, etc.) “Virtual” Locations can refer to non-physical locations (Web Store, etc.) or logical Locations inside physical Locations.

LOCATION XREF (507) Details information regarding a location pair. Typically used when moving goods between two locations. A location can belong to either the enterprise or a third party.

PERPETUAL INVENTORY (528) Represents an up to date calculated inventory level status for a specific item within a specific location, for a specific date and time. PERPETUAL INVENTORY reflects all known inventory adjustments as they happen, providing a more real-time, up to date and time inventory position representation. The values represented by this entity are typically calculated by using the most recent inventory levels in the Item Inventory entity, and then applying all the transactions per item per location since that date. Transactions that should be taken into account are: all the internal inventory transactions, and all transactions moving items from & to 3rd parties (sales, vendor receipts, etc.).

This entity would be redundant and may be omitted if the enterprise prefers to dynamically (‘on the fly’) calculate the inventory levels as described above instead.

RECEIPTS PLAN (550) A detailed plan of how items will be received into inventory at each LOCATION.

SALES RETURN LINE (558) Details items returned to a location by a customer for a refund or an exchange. If a Receipt is provided, this transaction will be linked to the original Sales Transaction and Sales Transaction Line that represented the original purchase. A Sales Return Transaction is a type of Sales Transaction; therefore, the information regarding the individual doing the return (name, address) will be captured in the related Sales Transaction entity for the Return.

SALES RETURN TRAN (559) Inventory adjustment (positive) made due to the return of sold goods from a customer back to the enterprise.

SER ITEM INVENTORIED DD (562) Identifies the specific Serialized Items that are Inventoried at a specific Location. This tracking may be enabled via RFID Technology—see the RFID Subject Area for more information.

SER ITEM INVENTORY ADJUST (563) Identifies the specific Serialized Items that were added or deleted from Inventory at a specific internal Location due to the internal movement of goods (no third party involved). The reason for the addition/deletion is detailed in the INVENTORY Subject Area. This tracking may be enabled via RFID Technology—see the RFID Subject Area for more information.

SUPPLY LOCATION (586) For a given location and item, describes the preferred supply location, as well as the time typically needed to get the item from the origin location to the target location. This structure allows for detail at the lowest atomic item level. If needed this structure can be defined at a higher level of the item hierarchy instead.

TRANSACTION GROUP (593) Groups Sales and Inventory TRANSACTION TYPEs into high level transaction groups. Examples: internal sales transaction, external sales transaction, inventory transaction, purchase order, return, etc.

TRANSACTION STATUS (594) Denotes the current phase of a Shopping or Inventory Transaction. Within Transaction Group SALES TRANSACTION examples include: Cancelled order, completed order, abandoned shopping cart, shopping cart that had been converted into an order, etc. Within Transaction Group INVENTORY examples include: in Transit, completed, cancelled, etc. Within Transaction Group PURCHASE ORDER examples include: Acknowledged, Shipped, In Transit, completed, cancelled, etc.

The current status is modeled by a direct relationship to the Transaction entity. Historical Status (or Status progression) is modeled by an associative entity between this entity and the transaction entity (and including the effective date in the associative entity).

TRANSACTION TYPE (595) Specifies the specific type of Sales or Inventory transaction within a larger TRANSACTION GROUP. Can be internal to the enterprise or external (3rd party). Within Transaction Group Internal SALES examples include: POS Sale, Wholesaler Sale, Consumer Return, Web Shopping Cart, Web Wish-list, Registry Lists (Wedding, Bridal Shower, Anniversary, Baby Shower, etc.), Store Layaway Purchase, Catalog Order, etc. Within Transaction Group INVENTORY examples include: Wastage, Transfer, Audit (Stock Count), Consolidation, etc. Within Transaction Group EXTERNAL SALES examples include: POS Sale, Wholesaler Sale, Consumer Return, etc. Within Transaction Group PURCHASE ORDER examples include: Regular Purchase Order, Blanket Purchase Order, Special Purchase Order, etc.

VENDOR RECEIPT LINE (615) Information about a specific ITEM contained in a VENDOR RECEIPT.

VENDOR RECEIPT TRAN (616) Inventory adjustment (positive) made due to the receipt of goods from a Supplier/Vendor.

VENDOR RETURN LINE (617) Specifies the actual ITEMs returned to the VENDOR, due to damage, malfunctioning, etc., of the ITEM.

VENDOR RETURN TRAN (618) Inventory adjustment (negative) made due to the return of purchased goods back to the Supplier/Vendor.

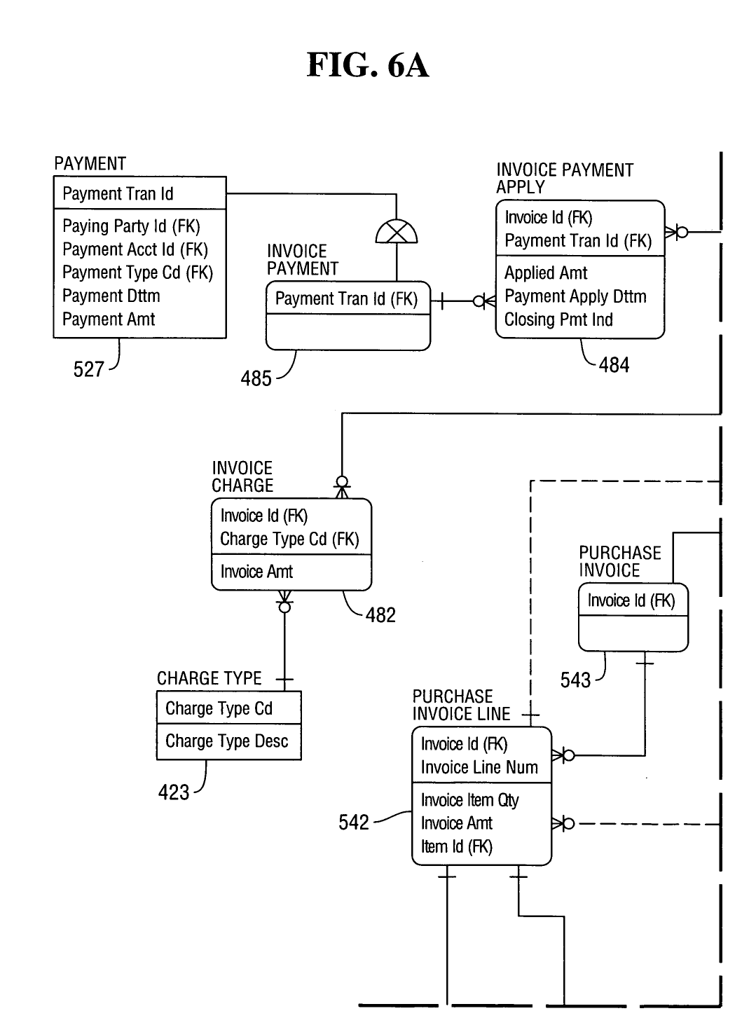

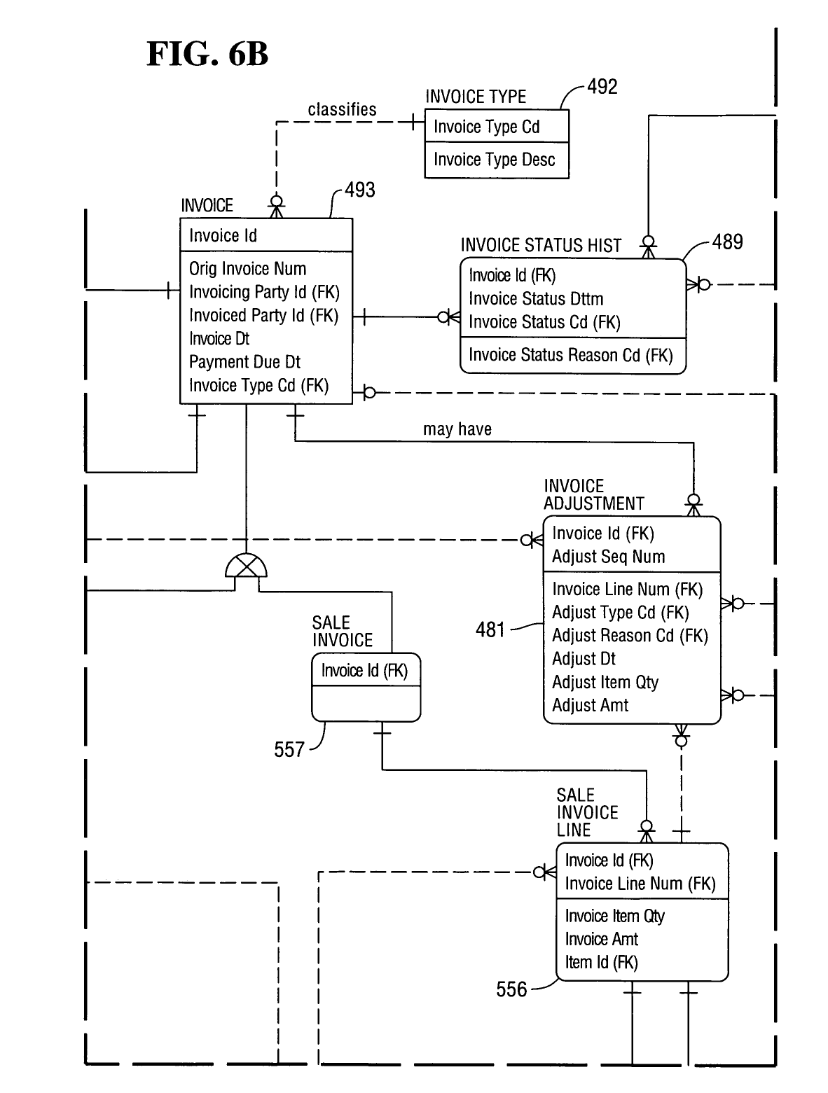

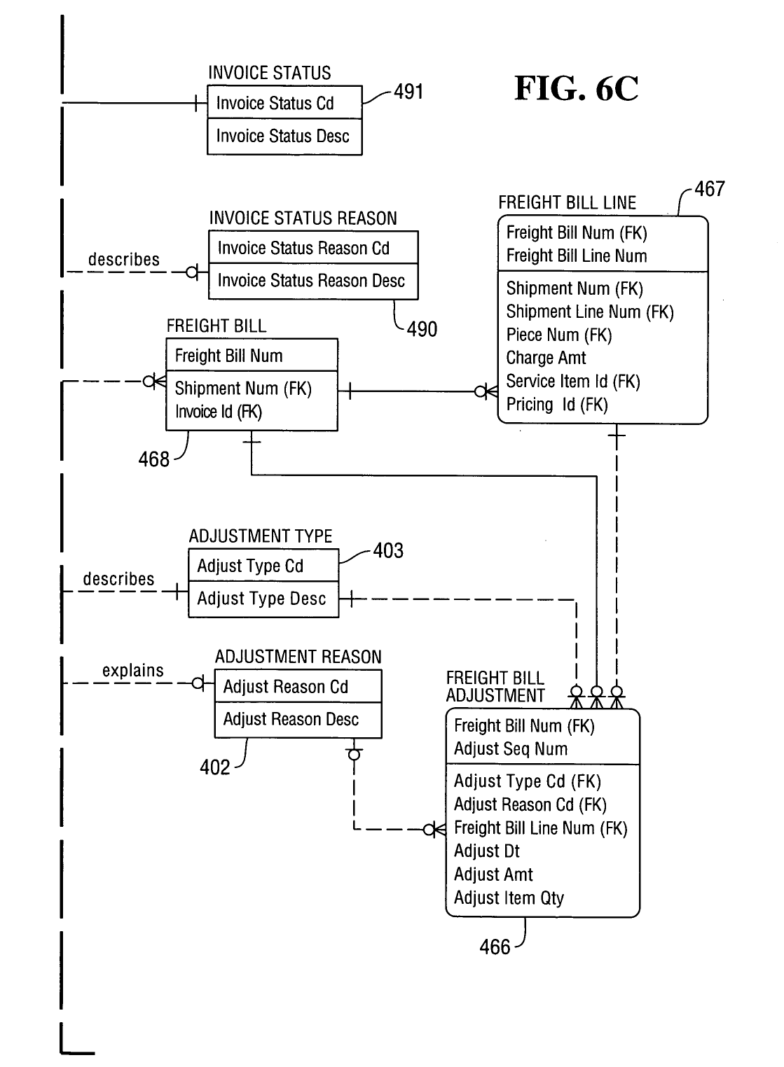

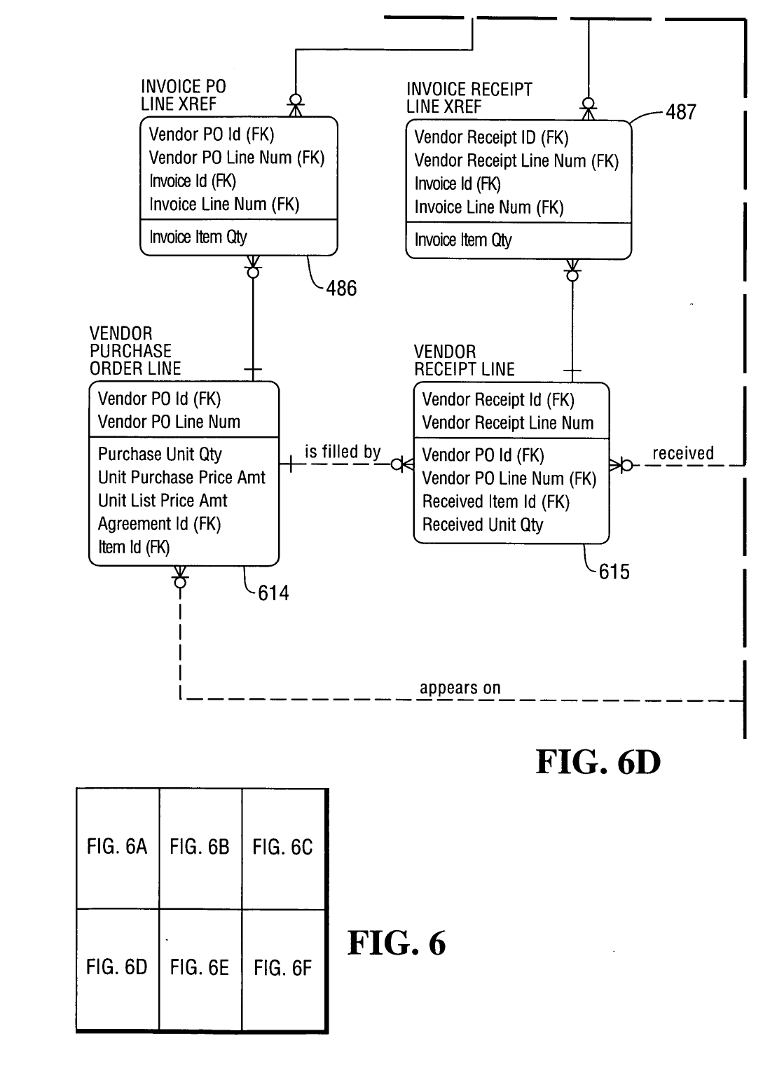

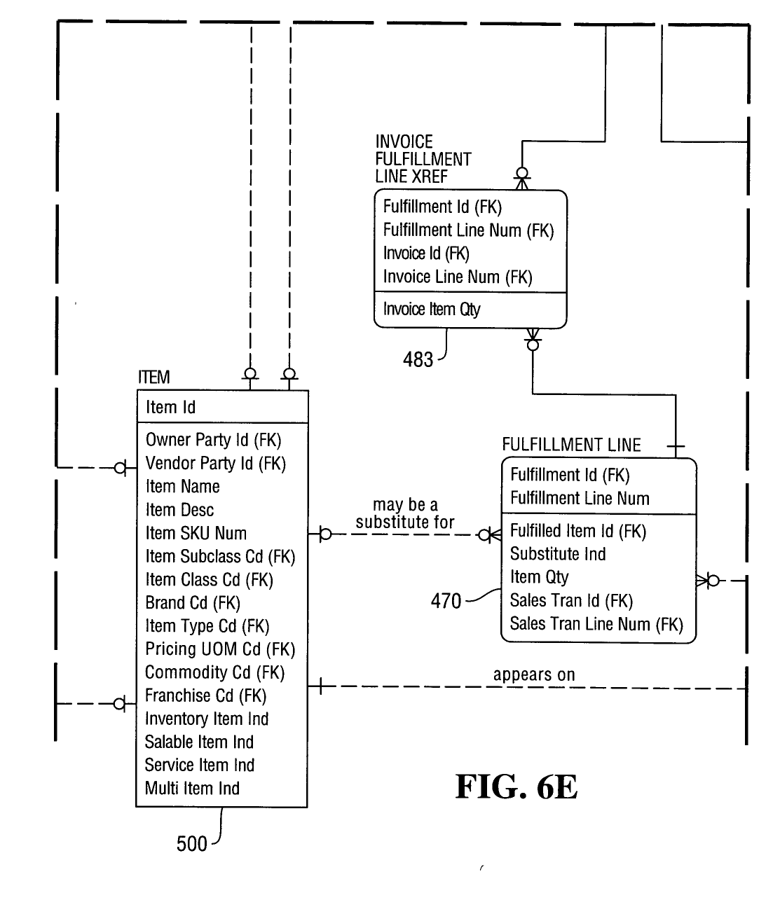

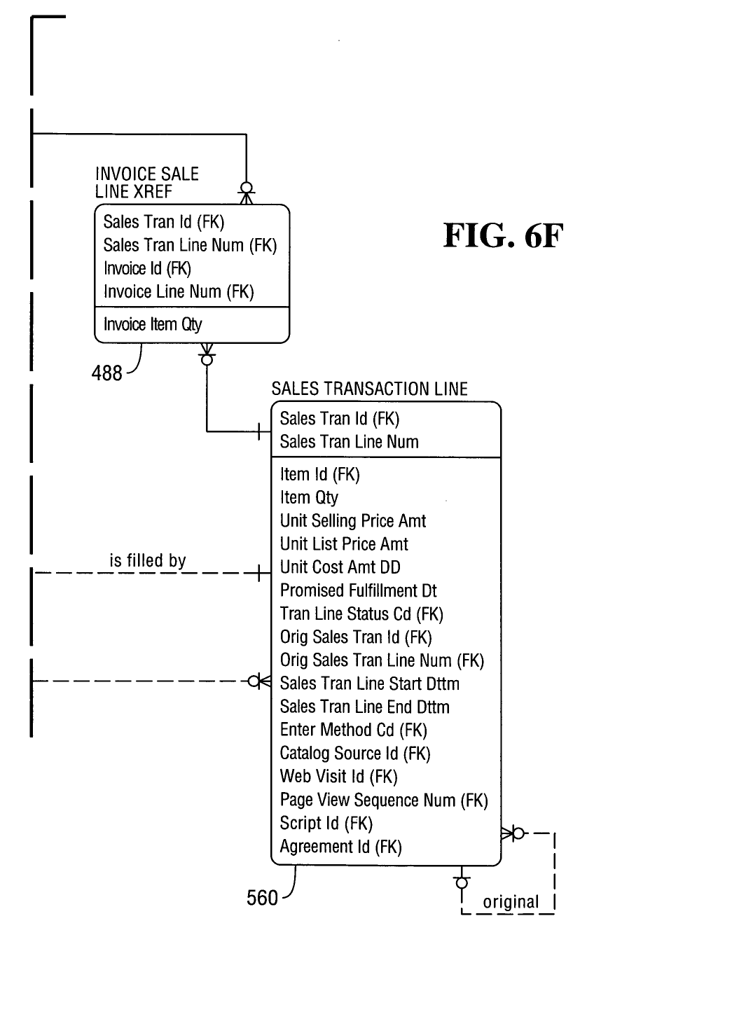

FIGS. 6A through 6F illustrate an entity-relationship diagram of the INVOICE subject area of the Retail Logical Data Model in accordance with the preferred embodiment of the present invention. An INVOICE represents a request for payment by a third party vendor or supplier to the enterprise (PURCHASE INVOICEs) or by the enterprise to a customer for goods provided or services rendered (SALES INVOICEs).

INVOICE detail is linked back to the originating business transactions such as Vendor Purchase Orders, Vendor Receipts, Sales Transactions and Fulfillment Transaction for cross verification and analytical business purposes The entities of the INVOICE subject area, illustrated in FIGS. 6A through 6D, are defined as follows:

ADJUSTMENT REASON (402) Specific reason for an adjustment within ADJUSTMENT TYPE. For ADJUSTMENT TYPE of “Goodwill” examples include: packaging lightly damaged, driver late, item damaged, or wrong item. For ADJUSTMENT TYPE of “Bad Debt” examples of ADJUSTMENT REASONs include: Company out of business, and Customer refuses to pay. For ADJUSTMENT TYPE of “Rating change” examples include: Weight differs from stated, and PIECE not Classed properly on the Bill of Lading

ADJUSTMENT TYPE (403) A High level classification of why an adjustment was made. Examples include: Goodwill, Debit, Rating change, Bad debt, and Increase adjustment.

CHARGE TYPE (423) A type of charge that is in addition to the Item or Service that was bought or sold. Examples: Shipping, Handling, Insurance, Expedited Shipping, (Customs) Duty, Customs Broker Fee, etc.

FREIGHT BILL ADJUSTMENT (466) Adjustments to the Freight Bill that take place after the original Bill of Lading is accepted. This can be for an entire Freight Bill, or a specific Freight Bill Line. Examples: Bad Debt write-off, Incorrect NMFC code, and Incorrect weight.

FREIGHT BILL LINE (467) FREIGHT BILL line item that corresponds to a SHIPMENT LINE ITEM or SERVICE. Details the amount and type of charge to a customer.

FREIGHT BILL (468) The internal record of a SHIPMENT that corresponds to the customer's Bill of Lading (SHIPMENT). The default FREIGHT BILL covers exactly 1 SHIPMENT.

FULFILLMENT LINE (470) The actual ITEMs contained in a FULFILLMENT, e.g., Wooden Desk style H14, etc.

INVOICE ADJUSTMENT (481) Adjustments to an Invoice or an Invoice Line. Examples: credit for damaged item, or credit for missing items

INVOICE CHARGE (482) Details the specific charges that are added to a Purchase or Sales Transaction that are not related to any particular item. Examples include: Shipping, Handling, Insurance, Expedited Shipping, etc.

INVOICE FULFILLMENT LINE XREF (483) Provides a cross reference between Items on a Sales Invoice and the related Items on a Fulfillment Line.

INVOICE PAYMENT APPLY (484) A way to apply one PAYMENT to one or more INVOICEs.

This minor entity identifies the role type of a party to INVOICE, such as the Customer, Buyer, Vendor, Requestor, Salesperson, Collector, Payer, Payee, Ordering Party, Delivered To Party, Bill To Party, Responsible Department Party, Invoice Created by Party, Responsible Sales Department, etc.

INVOICE PAYMENT (485) Payments made or collected that relate to an INVOICE. Other PAYMENTs could include Shopping Transactions, Contract payments or any PAYMENT that does not relate to an INVOICE.

INVOICE PO LINE XREF (486) Provides a cross reference between Items on a Purchase Invoice and the related Items on the original Purchase Order Line.

INVOICE RECEIPT LINE XREF (487) Provides a cross reference between Items on a Purchase Invoice and the related Items on a Vendor Receipt Line.

INVOICE SALE LINE XREF (488) Provides a cross reference between Items on a Sales Invoice and the related Items on the original Sales Order Line.

INVOICE STATUS HIST (489) This entity tracks the status of an INVOICE, such as cancelled, approved, pending, send, hold, release, etc.

INVOICE STATUS REASON (490) A reason why a particular Invoice Status Type Cd is assigned to an INVOICE. For example, if the status code is ‘release’, the reason codes may be: PO was matched, or the quantity ordered has been reconciled. If the status code is ‘hold’, the reason codes may be: Funds Hold Reason, Insufficient Information, etc.

INVOICE STATUS (491) Describes the status of an Invoice. Examples include: Paid in Full, Written Off, Pending, etc.

INVOICE TYPE (492) Describes the type of Invoice. Examples: Submitted by the enterprise for Payment (Accounts Receivable), and Received by the enterprise to be Paid (Accounts Payable).

INVOICE (493) A request for payment presented by one Party to another, typically for services rendered or goods provided.

ITEM (500) An ITEM is the lowest level for which inventory and sales records are retained within the enterprise.

PAYMENT (527) A tender amount received and applied to one or more business transactions.

PURCHASE INVOICE LINE (542) Invoice Lines related to Purchases (Invoice issued to the enterprise by a Supplier/Vendor).

PURCHASE INVOICE (543) A request for payment presented by (typically) a Supplier or Vendor to the Enterprise, typically for services rendered or goods provided to the Enterprise.

SALE INVOICE LINE (556) Invoice Lines related to Sales (Invoice issued by the enterprise to a customer).

SALE INVOICE (557) A request for payment presented by the Enterprise to a Customer, typically for services rendered or goods provided.

SALES TRANSACTION LINE (560) The actual merchandise selected by a customer during a transaction.

VENDOR PURCHASE ORDER LINE (614) The detail line on the VENDOR PURCHASE ORDER that provides information about the product being ordered.

VENDOR RECEIPT LINE (615) Information about a specific ITEM contained in a VENDOR RECEIPT.

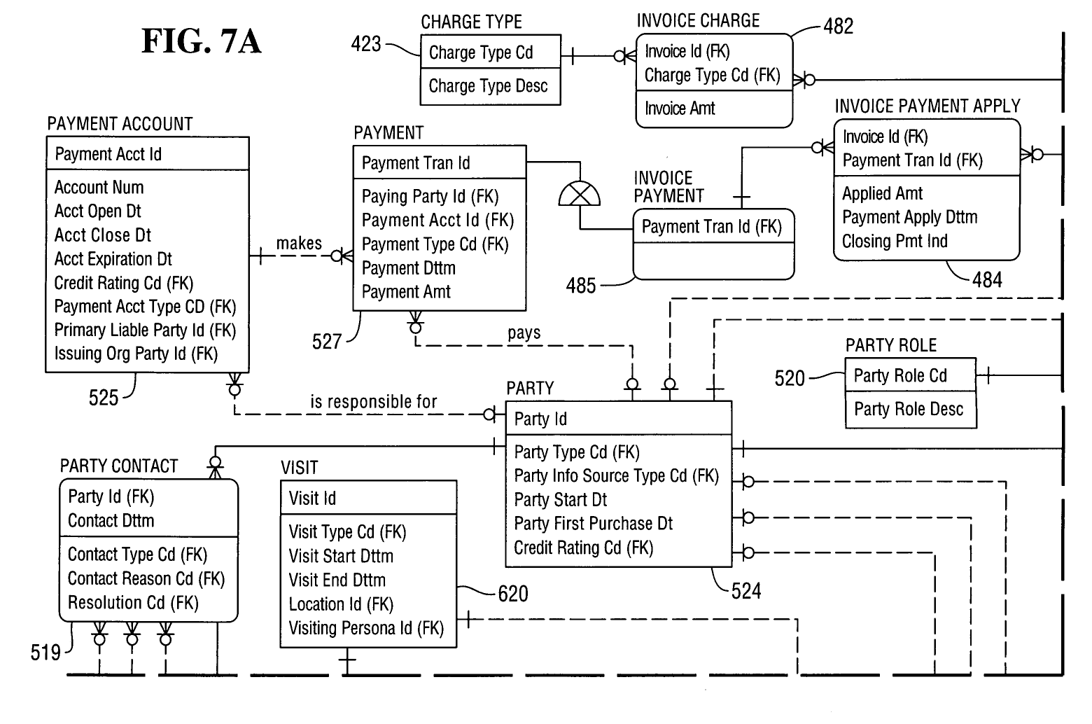

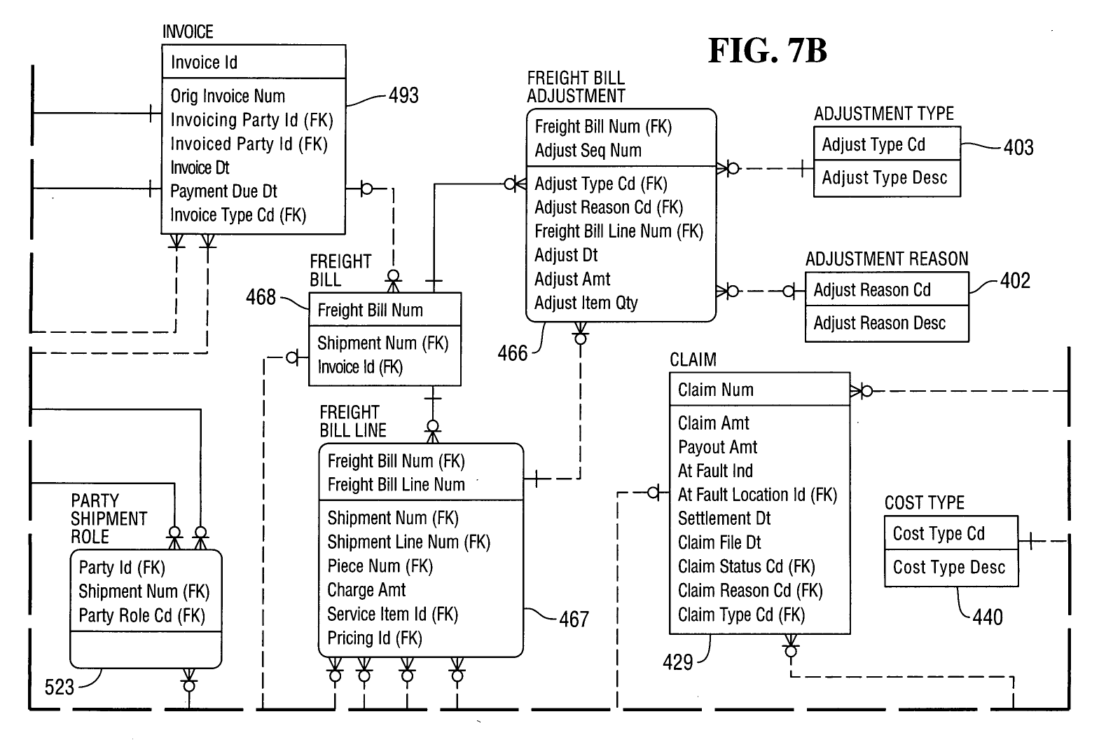

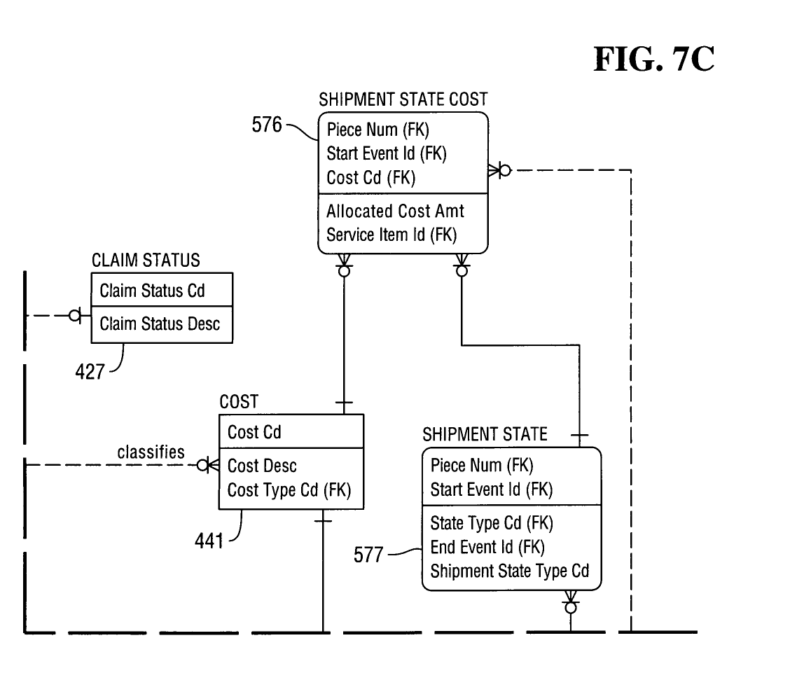

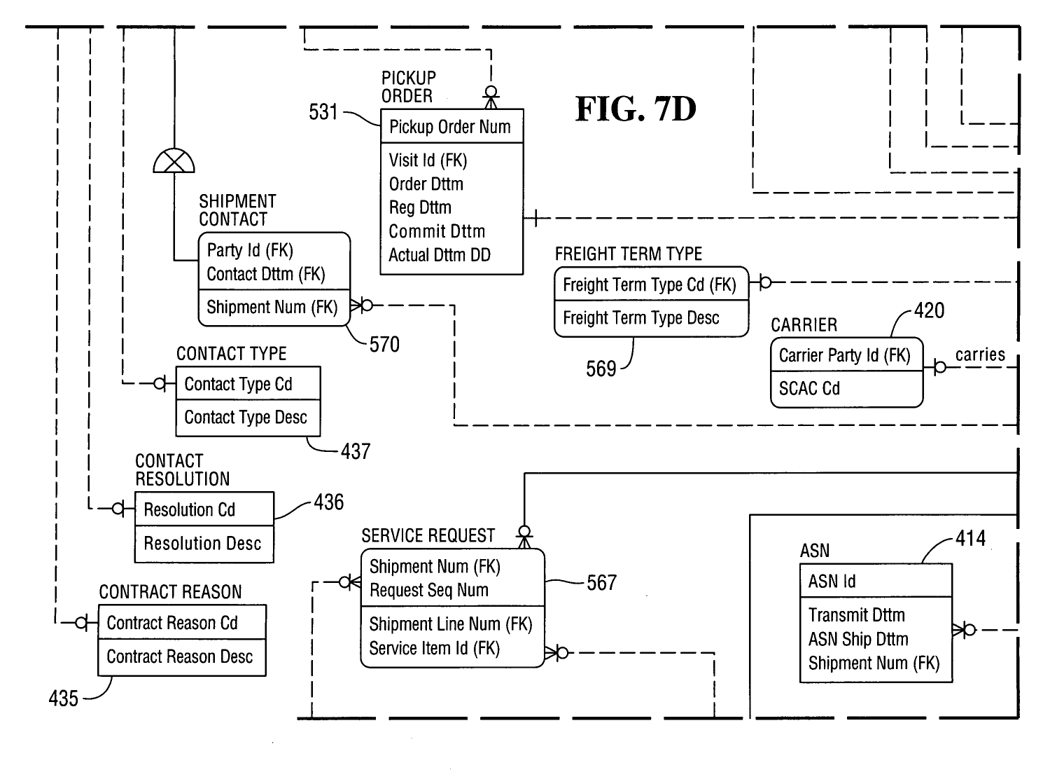

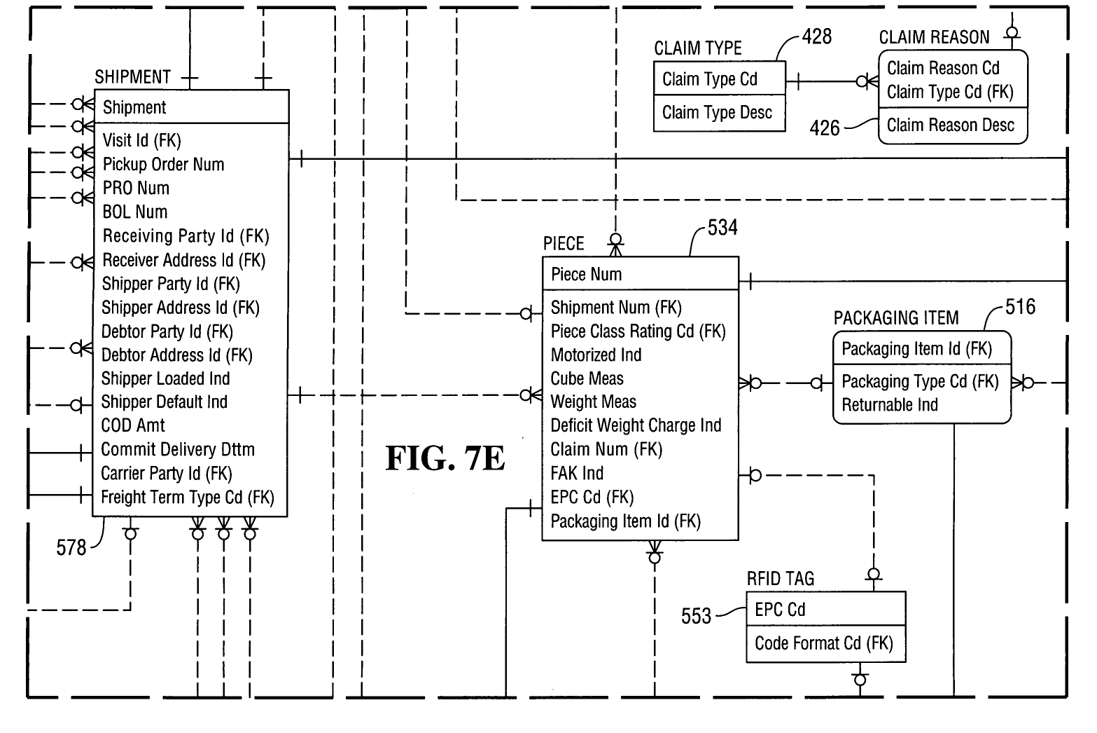

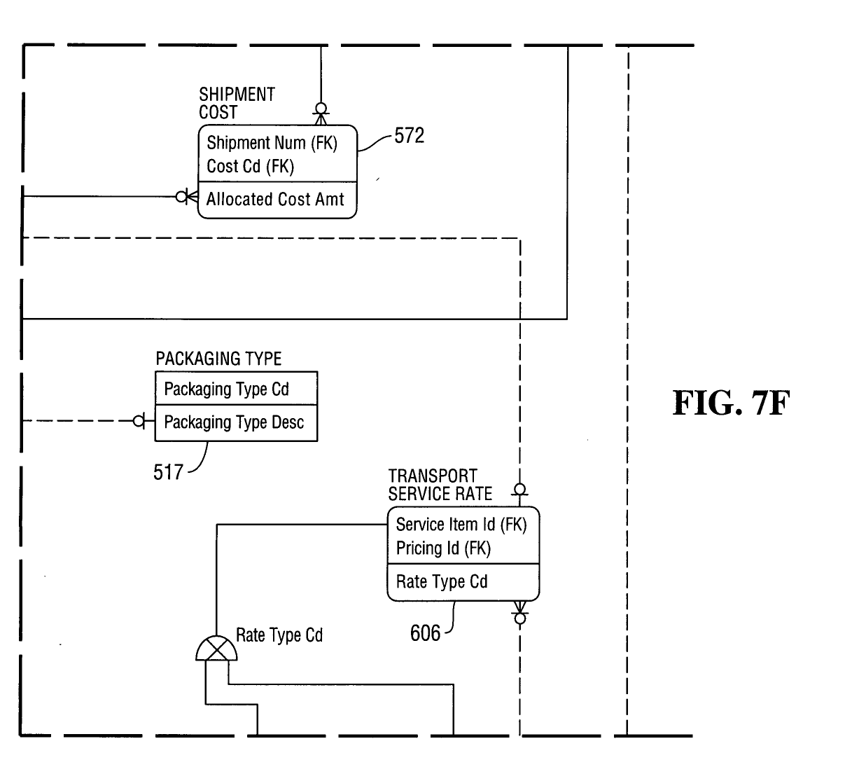

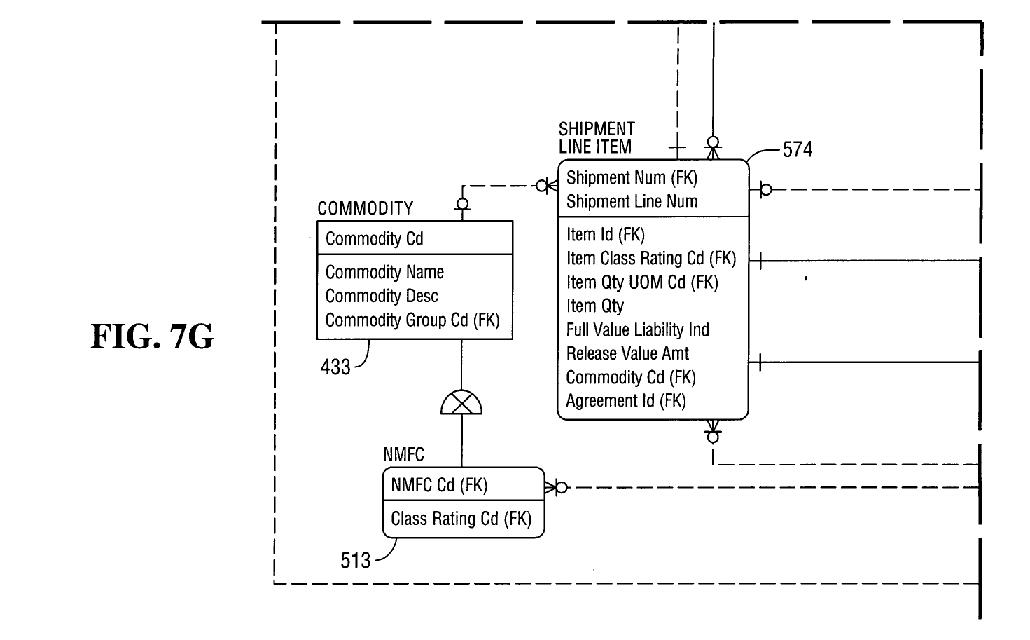

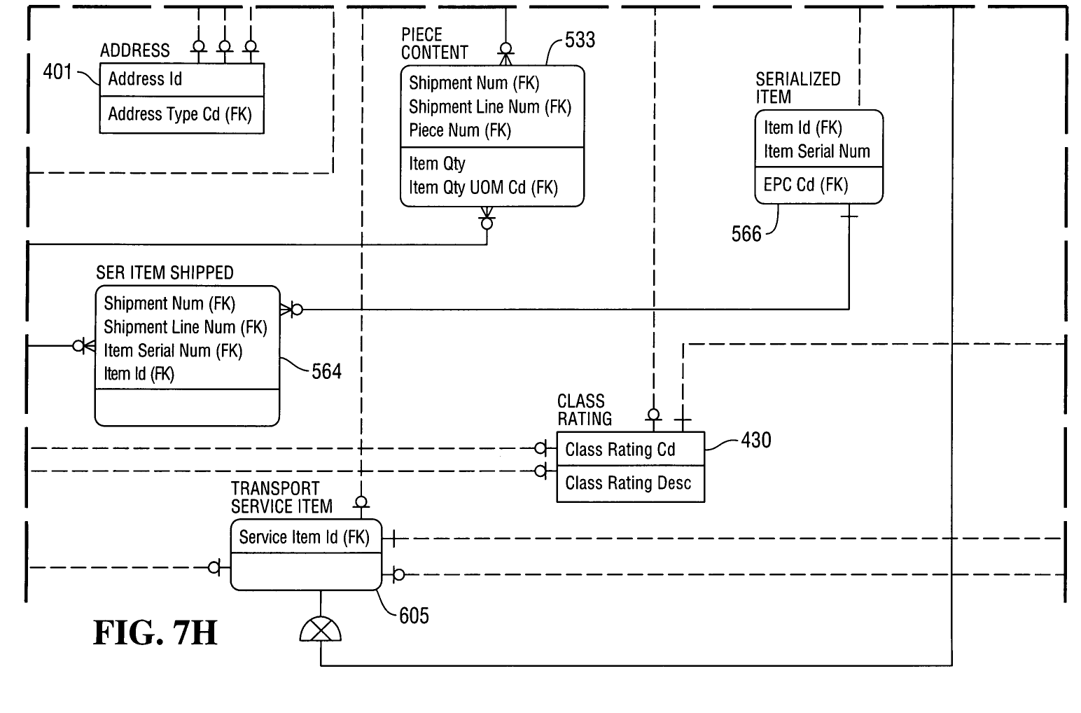

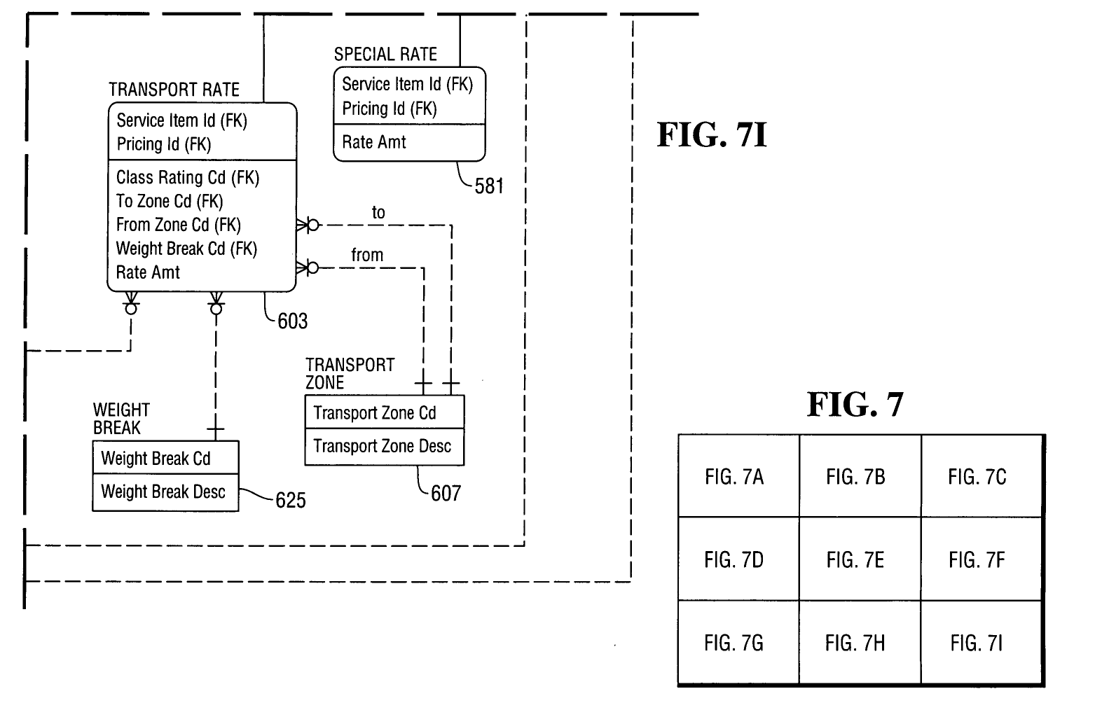

FIGS. 7A through 7I illustrate an entity-relationship diagram of the SHIPPING ORDER subject area of the Retail Logical Data Model. This subject area details the content of a SHIPMENT, the PIECEs (or Handling Units) that make up a Shipment, the actual Items contained therein, the different PARTIES involved, the TRANSPORTATION SERVICES requested, and any potential CLAIMs made against selected Shipment Pieces.

The SHIPPING ORDER subject area provides the enterprise the ability to:
1. Track the status and movement of shipped ITEMs from the point that they are picked up as part of a SHIPMENT and transported from an enterprise's location or while in transit from a supplier or vendor. Being able to better track the movement of ITEMs as part of a SHIPMENT, provides the enterprise a higher level of visibility and accuracy in analyzing and managing its supply chain, resulting in better replenishment cycles and optimal JIT inventory levels to properly meet customer demand, while minimizing or holding replenishment and inventory costs to an efficient level.
2. Track the actual cost of SHIPMENTs and the various cost components that make-up a given SHIPMENT COST to improve supplier, carrier as well as internal logistics efficiencies.
3. Track the various freight services charged and corresponding amounts as part of a FREIGHT BILL that is associated with a given SHIPMENT (bill of lading) to negotiate for better transportation service costs or improve transportation service efficiencies.
4. Track the CLAIMs made by the customer against a specific shipment PIECE or PIECEs to better analyze and improve customer logistics support services and by the enterprise to improve product flow and vendor services.

The entities of the SHIPPING ORDER subject area, illustrated in FIGS. 7A through 7I, are defined as follows:

ADDRESS (401) An ADDRESS provides a means of communications such as postal address, telephone number, or electronic address (e.g. e-mail). An ADDRESS may also represent a physical mailing location (e.g. street, post office box).

ADJUSTMENT REASON (402) Specific reason for an adjustment within ADJUSTMENT TYPE.

ADJUSTMENT TYPE (403) A High level classification of why an adjustment was made.

ASN (414) Advance Shipping Notice. A notice, typically an electronic transmission used in EDI, to notify the recipient of a Shipment that the Shipment has shipped or is about to be shipped.

CARRIER (420) A transportation company that is engaged in transporting products or items from one location to another for hire. This can include Parcel Delivery, LTL and TL trucking companies. Examples: Yellow Freight, FedEx, UPS, Roadway, Arkansas Best Freight, Reddaway, and Bestway. The term “Carrier” may also apply to Air Carriers, either Commercial Airlines or Air Cargo Carriers, in the case of Air Cargo.

CHARGE TYPE (423) A type of charge that is in addition to the Item or Service that was bought or sold.

CLAIM REASON (426) The entity that identifies the reason for a claim against a transportation company. For CLAIM TYPE “Loss” this could be: Theft, Misplaced, etc. For CLAIM TYPE “Damage” this could be: Water, Destroyed, Salvage, Contaminated, etc.

CLAIM STATUS (427) A unique code that reflects the status or resolution of a claim. Examples: Open, Paid, Partial Paid, and Denied.

CLAIM TYPE (428) The entity that identifies the high level type of claim. Examples: Loss, and Damage.

CLAIM (429) The entity that represents a request for reimbursement by a customer due to a failure to fulfill a transportation agreement or a shortage or damage to cargo. Each of these situations would result in a CLAIM being filed by the receiver of the item against the transportation company. Examples: Item was damaged in transit and must be replaced, and Item was delivered two days later than contracted time of delivery, so a penalty must be paid by the carrier.

CLASS RATING (430) The entity that identifies the different classifications used by transportation companies to classify ITEMS for SHIPMENT for rating/pricing purposes. The rating is based on the “transportability” of the goods, which in turn is determined by density, stowability, ease of handling, and liability. Some Rating Systems could be a simple formula involving dimensions and weight, without regard for the actual content type or commodity to be transported. One Rating system is as defined by the National Motor Freight Traffic Association. See www.nmfta.org for more information.

COMMODITY (433) A scheme for classifying products and services using a recognized third-party classification method, enabling a common reference for business-to-business usage, electronic catalogs, search engines and economic reporting/comparison purposes, etc. The Commodity classification of an Item can be used to help determine transportation rates, hazardous material information, customs implications, etc. Two such classification methods are the United Nations Standard Products and Services Classification (UNSPSC) and the National Motor Freight Classification (NMFC).

CONTACT REASON (435) A more detailed description of the nature of an interaction between the enterprise and a PARTY (typically a Customer) within a high level CONTACT TYPE. Within a Complaint, the CONTACT REASON could be: Late delivery, Rude Driver, etc. Within an Inquiry, it could be: Pricing, Shipment Tracking Status, etc.

CONTACT RESOLUTION (436) A brief description of the resolution type used to resolve a specific PARTY CONTACT. Examples: Provided requested information, Credited Customer Account, etc.

CONTACT TYPE (437) High level classification of the nature of an interaction between the enterprise and a PARTY, typically a Customer. Examples: Complaint, compliment, inquiry, etc.

COST TYPE (440) Classifies the different COSTs into logical groupings. Examples: Maintenance, Labor, Utilities, Purchase Price, Raw Materials, etc.

COST (441) Denotes the types of COSTs the enterprise expends. Expenditure items can include: Fuel, Equipment Maintenance, Rent, Service Charge, Heat and Electricity, Distribution, Repairs, Facility Maintenance and Grounds, Security, Cleaning, Refuse, Communication—Telephone, Mail, FedEx, Bank Charges, Stationery and Supplies, Labor, Purchase Price (at Cost) for Items actually resold, Raw Materials used, etc.

FREIGHT BILL ADJUSTMENT (466) Adjustments to the Freight Bill that take place after the original Bill of Lading is accepted.

FREIGHT BILL LINE (467) FREIGHT BILL line item that corresponds to a SHIPMENT LINE ITEM or SERVICE. Details the amount and type of charge to a customer.

FREIGHT BILL (468) The internal record of a SHIPMENT that corresponds to the customer's Bill of Lading (SHIPMENT).

FREIGHT TERM TYPE (469) Indicates the payment agreement for the freight.

INVOICE CHARGE (482) Details the specific charges that are added to a Purchase or Sales Transaction that are not related to any particular item. Examples: Shipping, Handling, Insurance, Expedited Shipping, etc.

INVOICE PAYMENT APPLY (484) A way to apply one PAYMENT to one or more INVOICEs.

INVOICE PAYMENT (485) Payments made or collected that relate to an INVOICE.

INVOICE (493) A request for payment presented by one Party to another, typically for services rendered or goods provided.

NMFC (513) A Specific way of classifying Commodities for Transportation purposes. The National Motor Freight Classification (NMFC) code used to identify specific freight by a pre-defined code and class defined by the National Motor Freight Traffic Association. Used to determine CLASS RATING, liability information, hazardous material designation, etc.

PACKAGING ITEM (516) Items that can be used for packaging, such as boxes, pallets or containers used for storing, moving and/or shipping ITEMs. Some containers are reusable and are returned to the Supplier after the enclosed ITEM has been consumed/removed.

PACKAGING TYPE (517) The kind of packaging that contains the PIECE. Examples include: box, barrel, carton, pallet, etc.

PARTY CONTACT (519) An instance of an interaction (or contact) between the enterprise and a PARTY (typically a Customer), usually related to a business transaction. This entity captures ‘non-formal’ interactions that are typically difficult to encode (as opposed to ‘formal’ interactions, such as orders, payments, etc.). These interactions are typically ‘free form’ (phone conversations, letters, etc.). Attributes are provided to enable summary representative standard codes to describe the essence of the contact to make analysis possible. Examples: Complaints, Product inquiries, etc.

PARTY ROLE (520) Code and description used to identify the role of the PARTY in a Transaction. Examples: Agent, Supplier, Inspector, Approver, Reservationist, Traveler, Travel Requestor, etc.

PARTY SHIPMENT ROLE (523) Intersection of a particular shipment and a party and the role that party plays in that shipment. The PARTY can be an ORGANIZATION or an INDIVIDUAL. For every SHIPMENT there must be at least three roles: shipper, receiver, and debtor—these roles are shown in the SHIPMENT entity since they are mandatory and constant. This entity allows for additional/optional PARTY involvement. Examples: Broker, Purchasing agent, Traffic Manager, Sales Agent, Expediter, etc.

PARTY (524) A party is any individual, organization or household that is of interest to the enterprise.

PAYMENT ACCOUNT (525) An account established by a PARTY with an ORGANIZATION typically to facilitate and enable the transfer of funds.

PAYMENT (527) A tender amount received and applied to one or more business transactions.

PICKUP ORDER (531) A request by a Shipper (or Consignor) to pick up goods to be transported at a specific LOCATION on a specific date and time.

PIECE CONTENT (533) A cross-reference showing which Shipment Line Items are contained in which pieces. For TL and LTL you will typically not have more than 1 SHIPMENT LINE per PIECE (because each PIECE is priced by a single CLASS RATING. However, other Transportation Industries may use this entity.

PIECE (534) Discrete identifiable object, many of which may make up the shipment. In Less than Truckload and Truckload the outer package is considered to be a Piece. This can be thought of as the “handling unit” or the discrete countable objects that make up a shipment. Typically the level at which trace and track scanning is done—in this case the PK may be the “Tracking Number”, provided it satisfies all the PK constraints uniqueness and non-re-use. For example: a box—may contain multiple items, or a shrink wrapped pallet—may contain multiple boxes.

RFID TAG (553) This entity captures Serialized Items or any other object tagged with a RFID Tag containing an Electronic Product Code. The Electronic Product Code (EPC) is a unique number that identifies a specific item or object in the supply chain. The EPC is stored on a radio frequency identification (RFID) tag, which combines a silicon chip and an antenna. Once the EPC is retrieved from the tag, it can be associated with dynamic data such as from where an item originated or the date of its production.

SER ITEM SHIPPED (564) Identifies the specific Serialized Items contained in a Shipment. This tracking may be enabled via RFID Technology—see the RFID Subject Area for more information.

SERIALIZED ITEM (566) Allows the identification of specific instances of an Item. Item instances can be uniquely identified in several ways: an imbedded manufacturer serial number on the Item (cameras, DVD players, firearms, etc.), or a tag fixed to the item for tracking purposes.

SERVICE REQUEST (567) Details the SERVICEs ordered by a customer pertaining to a SHIPMENT. Typically contains one TRANSPORT SERVICE and multiple SPECIAL SERVICE requests. Example include Transport Service: Expedited Overnight; and Special Service: inside delivery; sign for delivery.

SHIPMENT CONTACT (570) A Subtype of PARTY CONTACT. Information about a contact that is in reference to a specific SHIPMENT. This is a many to one relationship to SHIPMENT so multiple feedback can be associated with one SHIPMENT. Examples: a complaint about a late shipment, or a request for status of a shipment.

SHIPMENT COST (572) The individual items of COST associated with this particular SHIPMENT. Used to determine the ultimate profitability of the SHIPMENT.

SHIPMENT LINE ITEM (574) Commodity description that makes up the shipment.

SHIPMENT STATE COST (576) Associates all the generated allocated costs incurred by a specific PIECE while in a specific STATE if the COST could (optionally) be associated with a provided SERVICE. Used to assign costing to calculate SHIPMENT and customer profitability. Examples: associate fuel and labor cost consumed during a given LEG to each of the PIECEs transported; labor and equipment cost associated with break down by weight at the dock; facility cost associated with storage of goods when receiver not ready to receive; costs associated with clearing goods through customs, etc.

SHIPMENT STATE (577) Defines the actual state or ‘status’ of a SHIPMENT PIECE. It has a duration, and is usually initiated and terminated by an EVENT. Examples include: At customer, waiting to be picked up; Loading at Customer site; In transit from Customer to Terminal; Being Crossdocked; In Storage; etc.

SHIPMENT (578) Goods picked up at the same time and transported from one shipper at one origin to one receiver at one destination.

SPECIAL RATE (581) Entity that identifies the rate charged for special services by the transportation company. This can be Flat Rate OR per Unit of Measure (UOM) ($ per pound, $ per piece handled). Example Unit of Measure rates: time—time in storage, weight—humping charge—sacks of flour—sort and segregate, hourly rate—waiting time because receiver is not ready to receive delivery, % rate.

TRANSPORT RATE (603) A table that details the charges for performing specific transportation services (that is, the transporting of a specific type and weight of ITEM between two specific zones) at a specific service level. Transport Rates can also be a simple formula involving dimensions and weight, without regard for the actual content type or commodity to be transported.

TRANSPORT SERVICE ITEM (605) An Item used or sold to a customer as part of providing a Transport Service. Examples: Transporting goods from one location to another on behalf of a customer; Unpacking the item at delivery and taking away the packing material; Providing a truck with a lift gate since no dock is available at the delivery location; and Packaging material used.

TRANSPORT SERVICE RATE (606) The amount that is charged to perform a Transportation SERVICE. Can involve the actual movement of goods (movement from an origin to a destination), or related Services (White Glove Handling, Inside Delivery, etc.)

TRANSPORT ZONE (607) Grouping of geographic areas, typically POSTAL CODEs, into larger areas for use in pricing transport between different geographic regions.

VISIT (620) Indicates the type of the VISIT. Examples: web visit, store visit, catalog call, etc.

WEIGHT BREAK (625) Entity that represents the break points for one rate charge versus another based upon weight. Examples: AMC (absolute minimum charge), MC (minimum charge), LSC, SC, 1M, 2M, 5M, 10M, and 20M. 1M, 2M, 5M, 10M, and 20M are rates per 100 pounds.

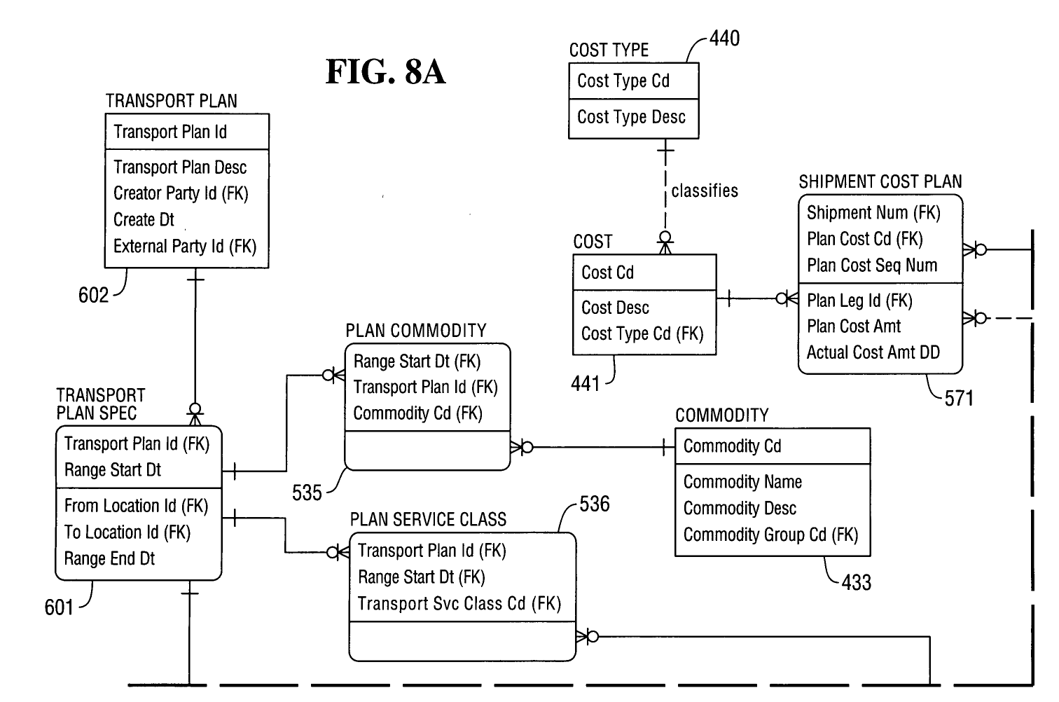

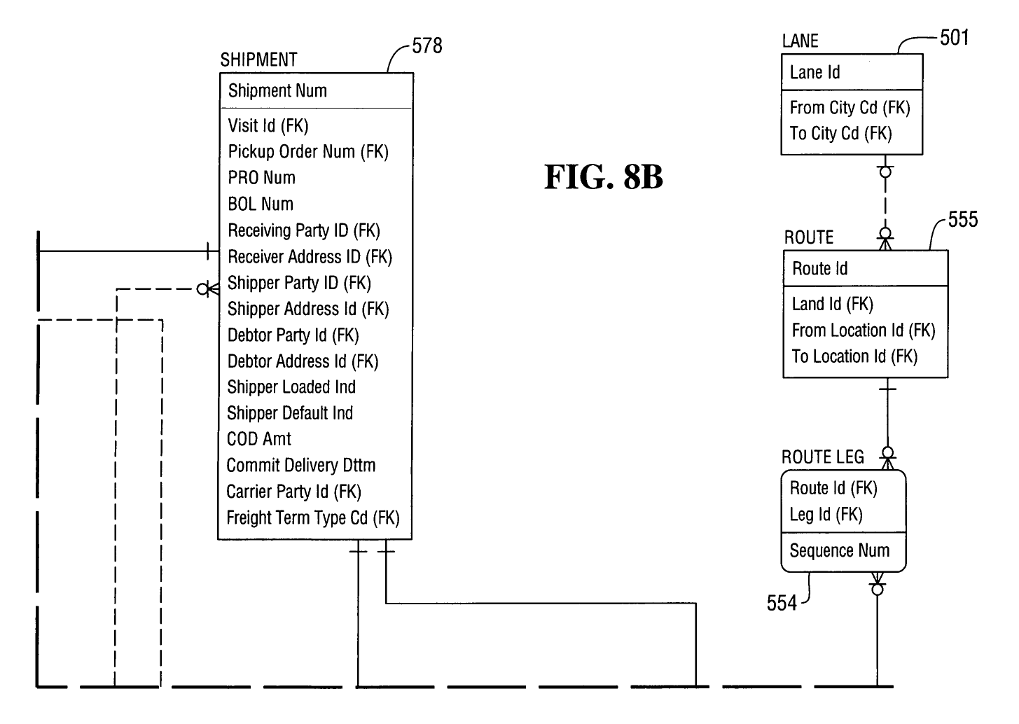

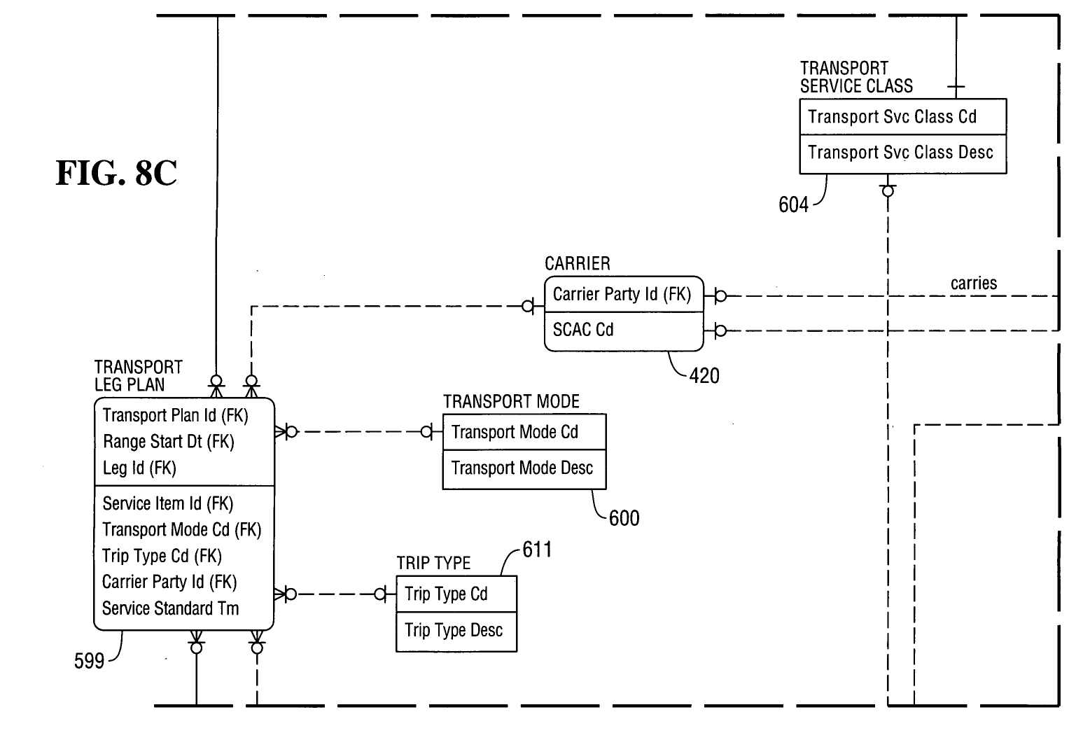

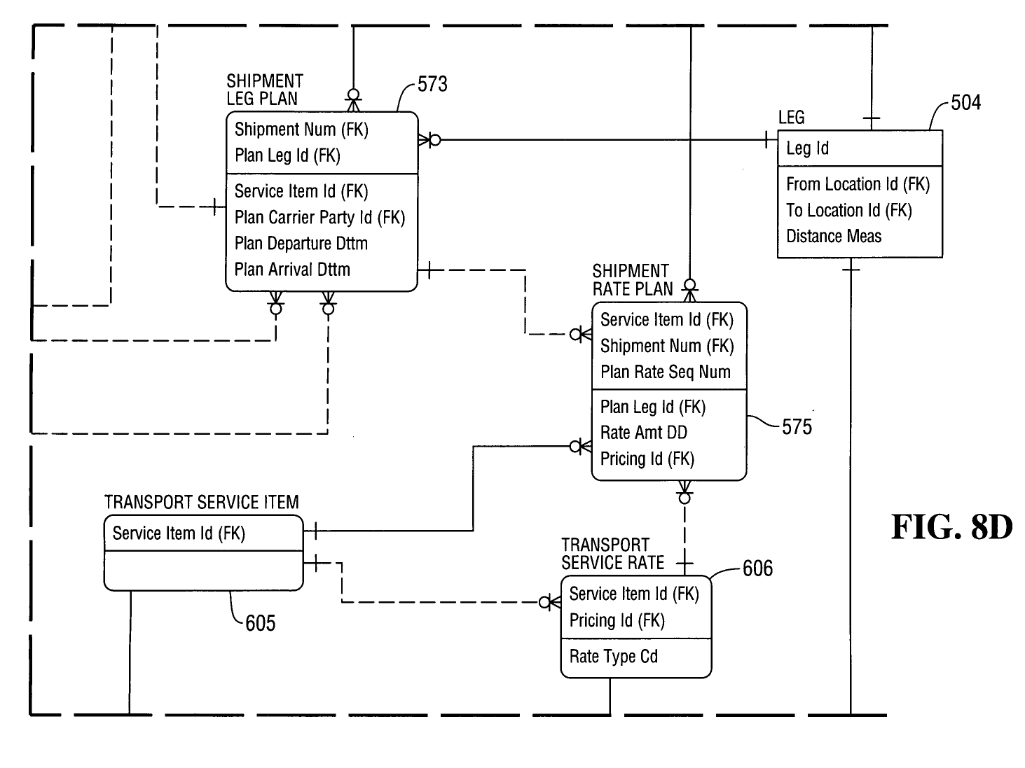

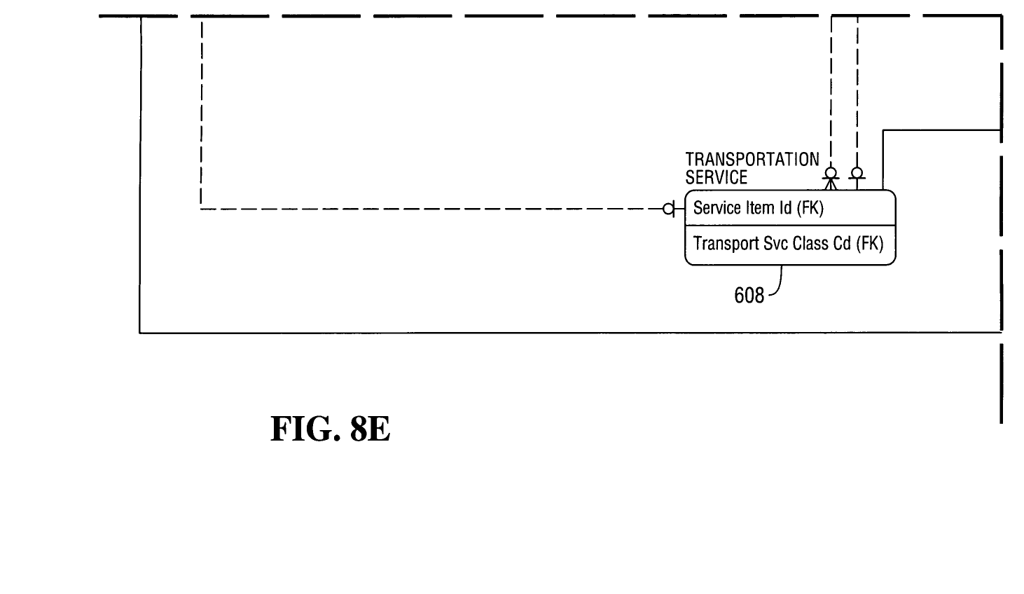

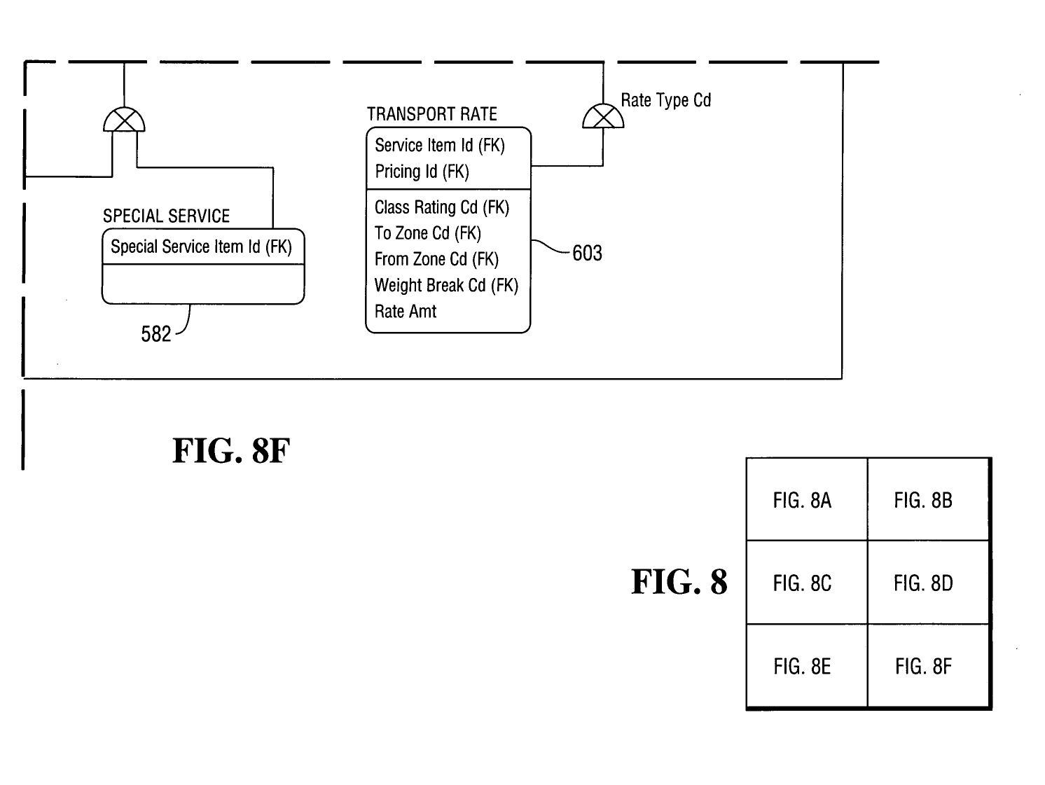

FIGS. 8A through 8F illustrate an entity-relationship diagram of the SHIPPING PLAN subject area of the Retail Logical Data Model. This Subject Area supports two distinctly different Transportation and Shipping Planning options. The first Planning area, SHIPMENT LEG PLAN and SHIPMENT COST PLAN, allows for the advance route, rate, carrier, service, and cost planning of every single (or select) Shipment. This information is used to compare to the after-the-fact actuals. This type of planning is primarily used by transportation service companies whereby products required to be shipped vary in nature in terms of content, size, and shipping requirement and therefore must be planned at the shipment level or lower (Piece), at or near the time of shipping. It may be used by specific retailers or wholesalers who own their own trucking fleet, whereby special orders or unique ITEMs not commonly carried, are required to be shipped.

The second Planning area, TRANSPORT PLAN SPEC, covers a global ‘goal setting’ capability. Based on the type of Item to be transported, urgency (Service Class), and time of year, a desired route, carrier, and service can be specified in advance. For those retailers who manage their own trucking fleets, this type of planning is more commonly used since the nature of the products potentially being shipped are known in advance and therefore can be planned for in advance. This information is used to perform comparative analysis against actual shipment logistics for performance variances.

The entities of the SHIPPING PLAN subject area, illustrated in FIGS. 8A through 8F, are defined as follows:

CARRIER (420) A transportation company that is engaged in transporting products or items from one location to another for hire. This can include Parcel Delivery, LTL and TL trucking companies.

COMMODITY (433) A scheme for classifying products and services using a recognized third-party classification method, enabling a common reference for business-to-business usage, electronic catalogs, search engines and economic reporting/comparison purposes, etc. The Commodity classification of an Item can be used to help determine transportation rates, hazardous material information, customs implications, etc. Two such classification methods are the United Nations Standard Products and Services Classification (UNSPSC) and the National Motor Freight Classification (NMFC).

COST TYPE (440) Classifies the different COSTs into logical groupings.

COST (441) Denotes the types of COSTs the enterprise expends

LANE (501) A collection of ROUTEs between two large geographical areas, typically cities. Used to define and group the major ‘routes’ served by the enterprise (unidirectional). Examples: Miami-L.A., New York-Chicago, etc.

LEG (504) The movement between two points where a shipment is actually handled at both points. Examples: Leg begins with loading freight, or Leg ends upon reaching a terminal for a cross-dock.

PLAN COMMODITY (535) Specifies the Commodity covered by the Plan.

PLAN SERVICE CLASS (536) Specifies the Service Classes covered by the Plan.

ROUTE LEG (554) Cross reference between a ROUTE and the LEGs that define the ROUTE. A LEG can be part of multiple ROUTEs. Examples: Route 28 as well as Route 34 are both from Los Angeles to Miami, but consist of different LEGs. Route 28 consists of 3 LEGs: L.A. Santa Monica facility to Denver Facility, Denver Facility to Chicago Facility, and Chicago Facility to Miami Facility. Route 34 consists of 3 LEGs: L.A. Santa Monica facility to Sacramento Facility, Sacramento Facility to Chicago Facility, and Chicago Facility to Miami Facility.

ROUTE (555) A specific path between two LOCATIONs, specifying all the intermediate LOCATIONs passed. Defined as a collection of LEGs. Examples for the L.A.—Miami Lane: L.A. Santa Monica facility to Denver Facility to Chicago Facility to Miami Facility, L.A. Santa Monica Facility to Sacramento facility to Chicago Facility to Miami Facility, etc.

SHIPMENT COST PLAN (571) Allows planning or estimation of the Costs associated with the Shipment if some or all of the transportation is done by the Enterprise.

SHIPMENT LEG PLAN (573) Supports the specification of a Plan or Expectation of route, carrier, etc. prior to an actual Shipment. This information is most useful to later compare against the actual information.

SHIPMENT RATE PLAN (575) Specifies all the Services and Rates that are planned. Can be per Leg or per Shipment.

SHIPMENT (578) Goods picked up at the same time and transported from one shipper at one origin to one receiver at one destination.

SPECIAL SERVICE (582) Services sold in addition to the physical transportation of goods. Also known as Assessorial/Accessorial Services. Examples: Notification prior to delivery, Inside Delivery, Hold for Pickup, etc.

TRANSPORT LEG PLAN (599) Specifies the desired Legs, Carriers, Transport Services, Cycle Times, etc. for a given From/To Transportation effort of Goods of a certain Class Rating and Urgency (Service Class).

TRANSPORT MODE (600) Indicates mode of transport. Examples are: Air, Rail, Ground, Water, etc.

TRANSPORT PLAN SPEC (601) Details a global “goal setting” planning capability. Based on the type of Item to be transported, urgency (Service Class), and time of year, a desired route, carrier, and service can be specified.

TRANSPORT PLAN (602) A Specification set for desired or expected future events.

TRANSPORT RATE (603) A table that details the charges for performing specific transportation services, i.e., the transporting of a specific type and weight of ITEM between two specific zones, at a specific service level.

TRANSPORT SERVICE CLASS (604) Generic indicator of speed of Transportation Service. Examples include: 2 day, overnight, and same day.

TRANSPORT SERVICE ITEM (605) An Item used or sold to a customer as part of providing a Transport Service.

TRANSPORT SERVICE RATE (606) The amount that is charged to perform a Transportation SERVICE. Can involve the actual movement of goods (movement from an origin to a destination), or related Services (White Glove Handling, Inside Delivery, etc.)

TRANSPORTATION SERVICE (608) The different service products that a company offers from a Transportation perspective that involves the physical transportation of goods. Examples: Acme Standard, Acme Overnight, and Acme Same Day.

TRIP TYPE (611) Classifies the nature of the TRIP. For Trucking this could be “Pick Up and Delivery’, ‘Line Haul’, etc.

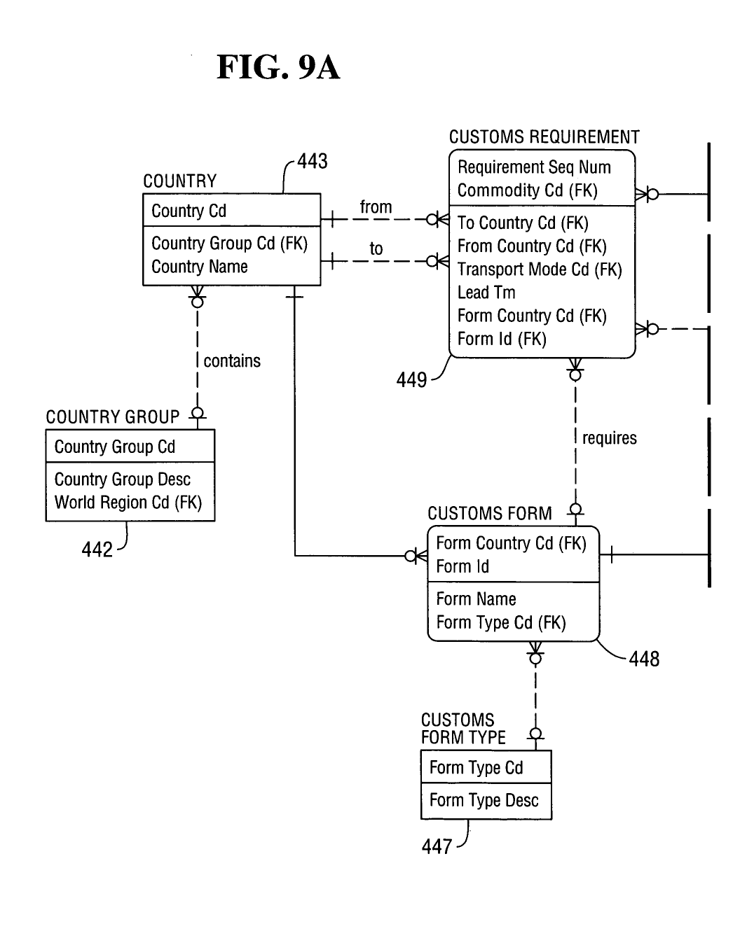

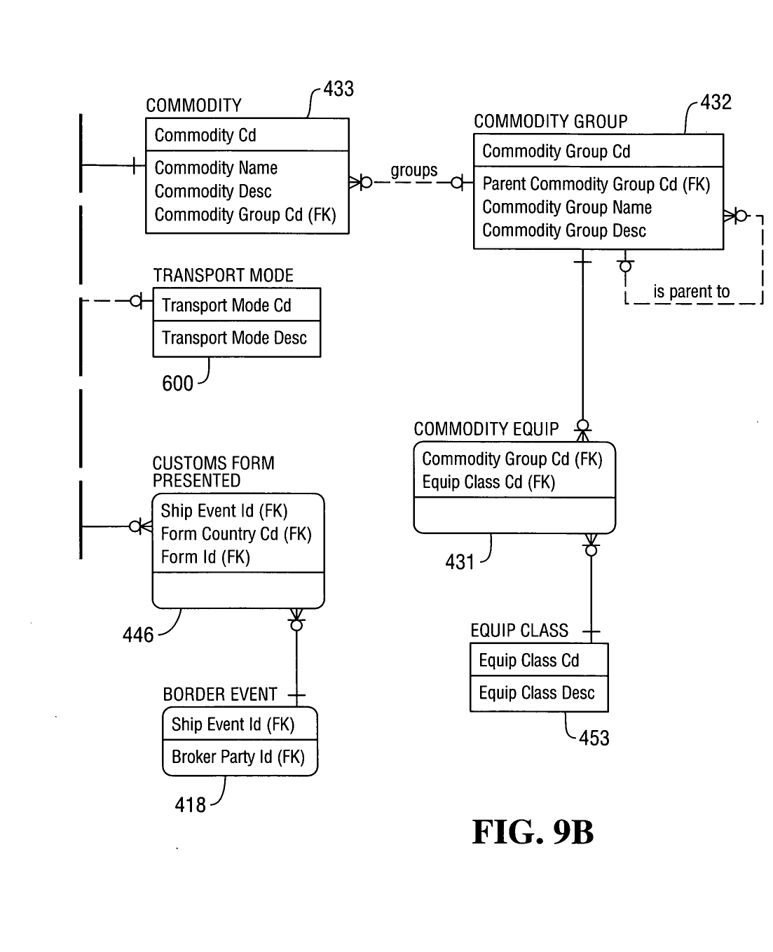

FIGS. 9A and 9B illustrate an entity-relationship diagram of the SHIPPING REGULATION subject area of the Retail Logical Data Model. A Shipping Regulation specifies the rules and regulations of transporting goods over borders. As part of the critical information that this subject area supports, it specifically defines the official information required to be presented to the Controlling Authority. Regulations may provide support for the importing and exporting of goods, as well as covering goods only transiting. This subject area also details the specialized Equipment required for Commodities with Special Handling Requirements (HazMat, etc.).

Information support and continuous analysis of Shipping Regulations is critical in insuring that custom requirements are properly recognized and supported as part of the customs process, allowing for the smooth flow of goods across country boundaries with minimum delay, to be achieved.

The entities of the SHIPPING REGULATION subject area, illustrated in FIGS. 9A and 9B, are defined as follows:

BORDER EVENT (418) Captures the Customs (or Regulatory) compliance events at Border Crossings. Examples include: 24 hrs Import Notification, and Customs Hold.

COMMODITY EQUIP (431) Cross Reference defining the specialized Equipment required to transport certain Commodity Groups of Items. Examples include: Hazardous Materials, Items needing Refrigeration, etc.

COMMODITY GROUP (432) A hierarchical grouping of Commodity classifications that may have as many levels as needed to fully code the classification scheme.

COMMODITY (433) A scheme for classifying products and services using a recognized third-party classification method, enabling a common reference for business-to-business usage, electronic catalogs, search engines and economic reporting/comparison purposes, etc. The Commodity classification of an Item can be used to help determine transportation rates, hazardous material information, customs implications, etc. Two such classification methods are the United Nations Standard Products and Services Classification (UNSPSC) and the National Motor Freight Classification (NMFC).

COUNTRY GROUP (442) A grouping of countries. Examples: Eastern Europe, Micronesia, etc.

COUNTRY (443) A geo-political region with sovereign governing. Examples: U.S.A., Canada, Denmark, etc.

CUSTOMS FORM PRESENTED (446) Defines a set of information to be provided to a Controlling Authority for the importing or exporting of specific goods between countries.

CUSTOMS FORM TYPE (447) Indicates if the Form governs Imports, Exports, or goods In Transit.

CUSTOMS FORM (448) Captures the Sets of Regulatory information (Forms) presented to the Controlling Authority to enable this Border Crossing.

CUSTOMS REQUIREMENT (449) Specifies the rules and regulations of transporting goods over borders. Specifically mentions the official information to be provided to the Controlling Authority.

EQUIP CLASS (453) Describes the Class of EQUIPMENT for skills certification; commodity handling; associate/crew training; licensing purposes. Examples for the Trucking Industry include: Class A Truck, Class B Haz-Mat, Double (2 trailers), and Triple (3 trailers).

TRANSPORT MODE (600) Indicates mode of transport.

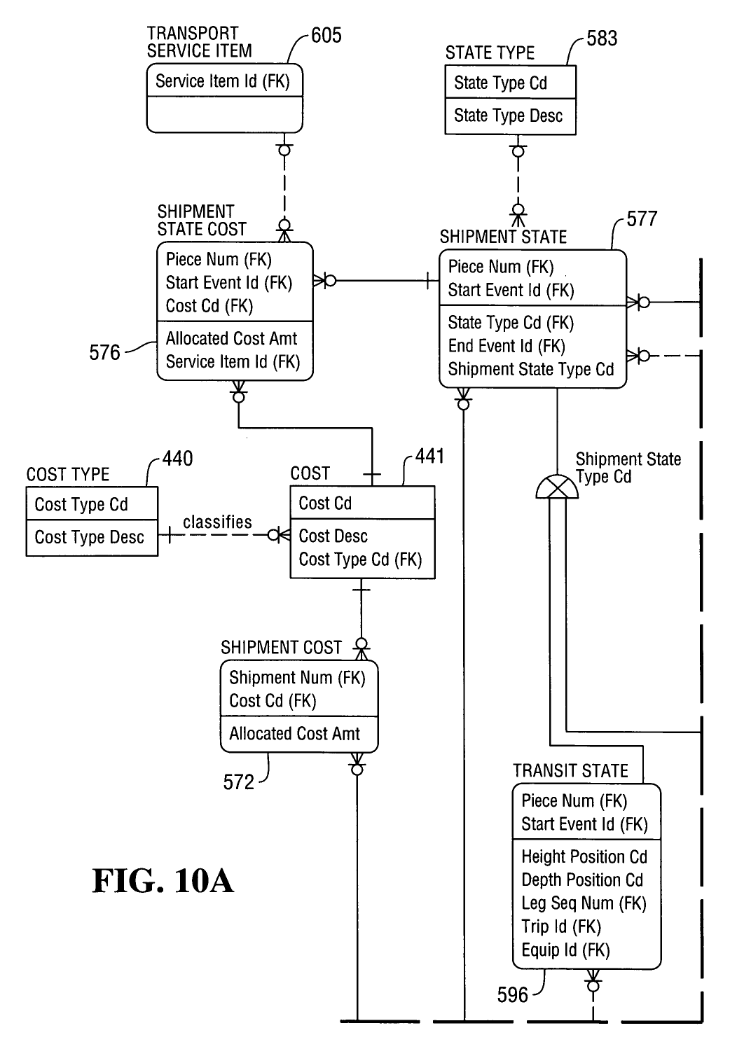

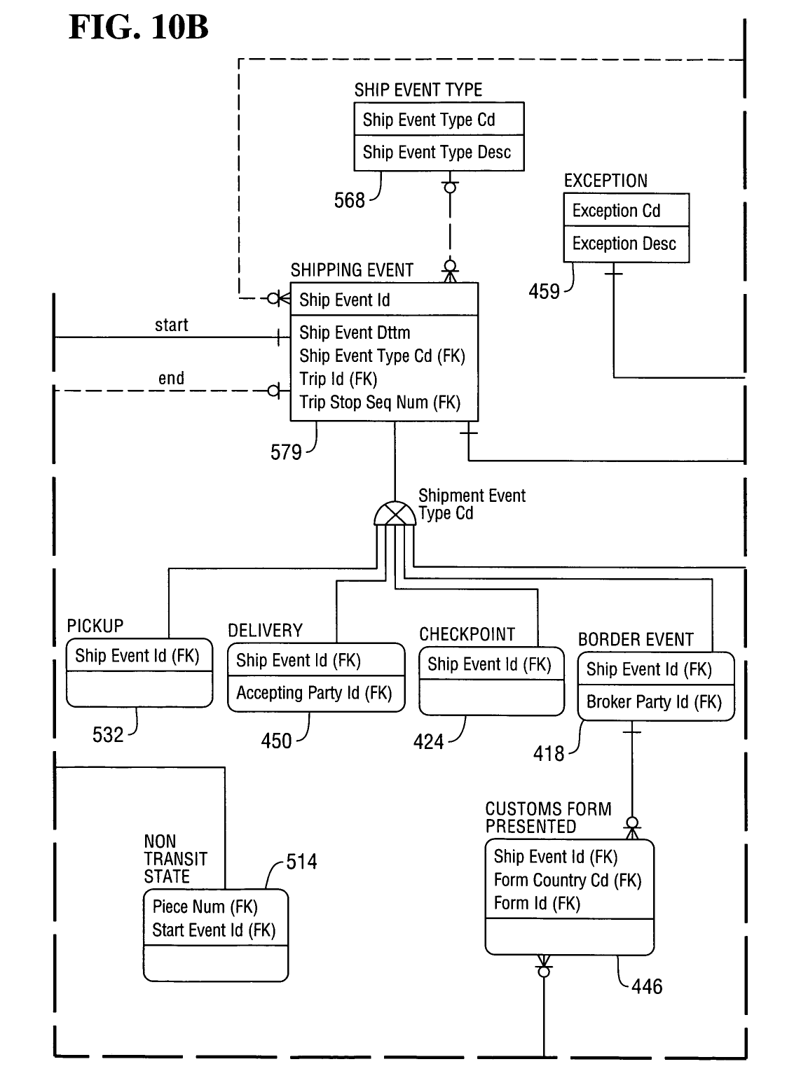

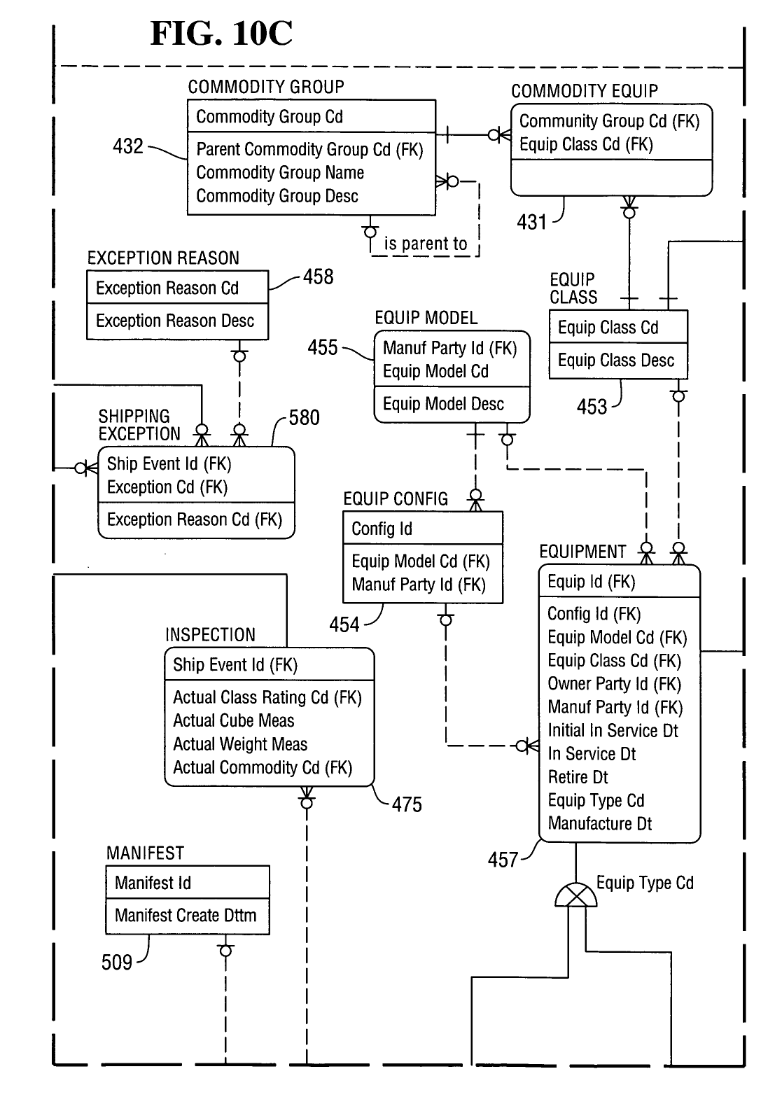

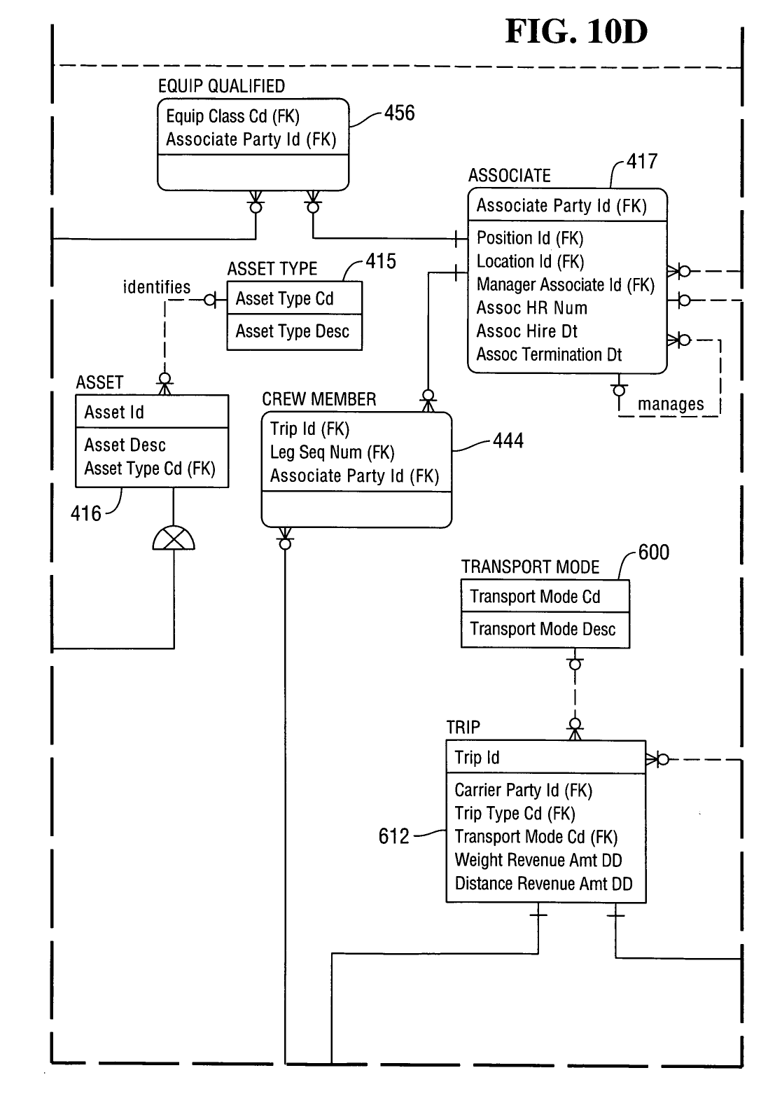

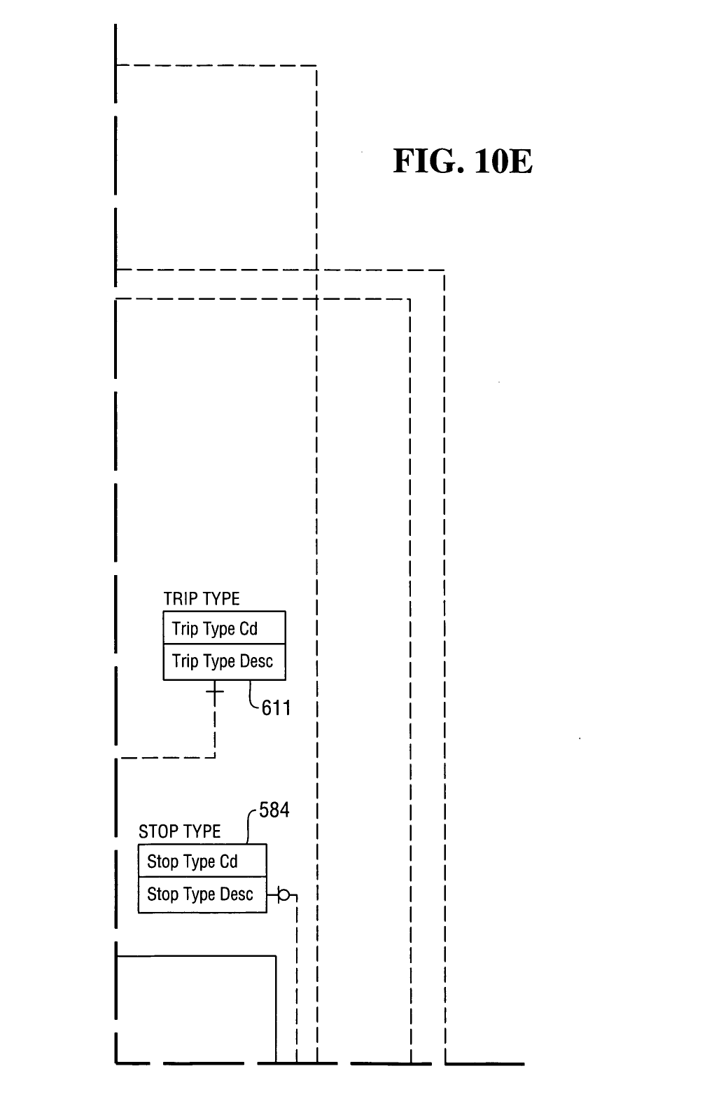

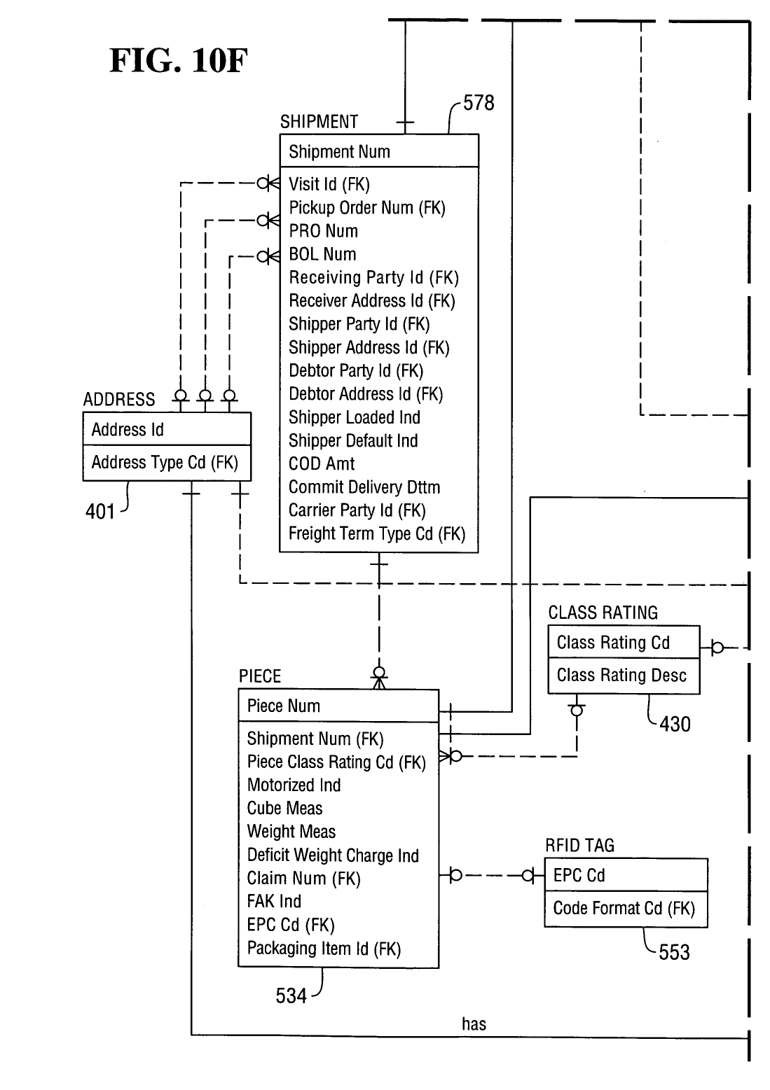

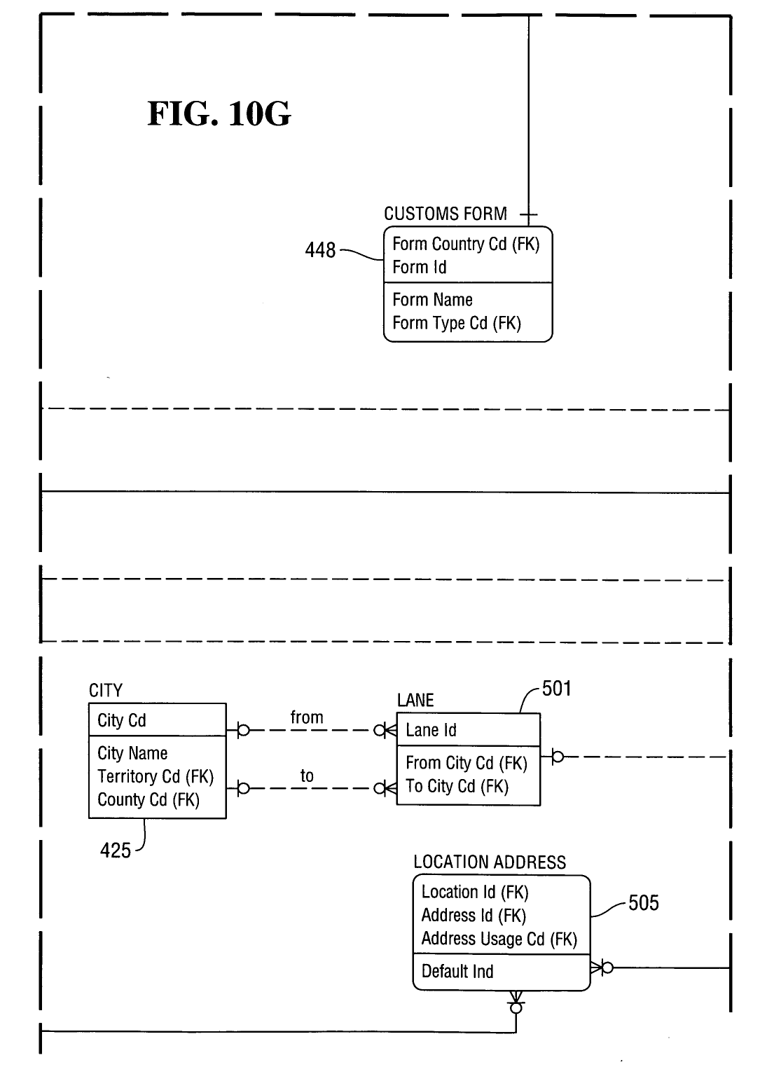

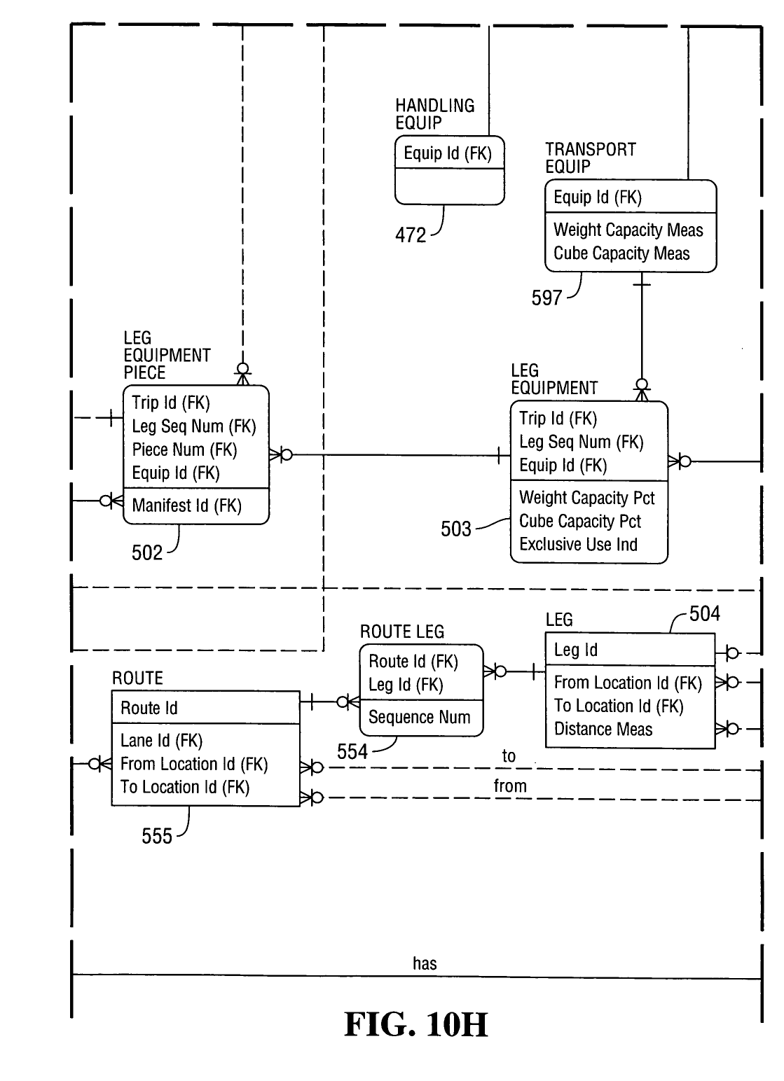

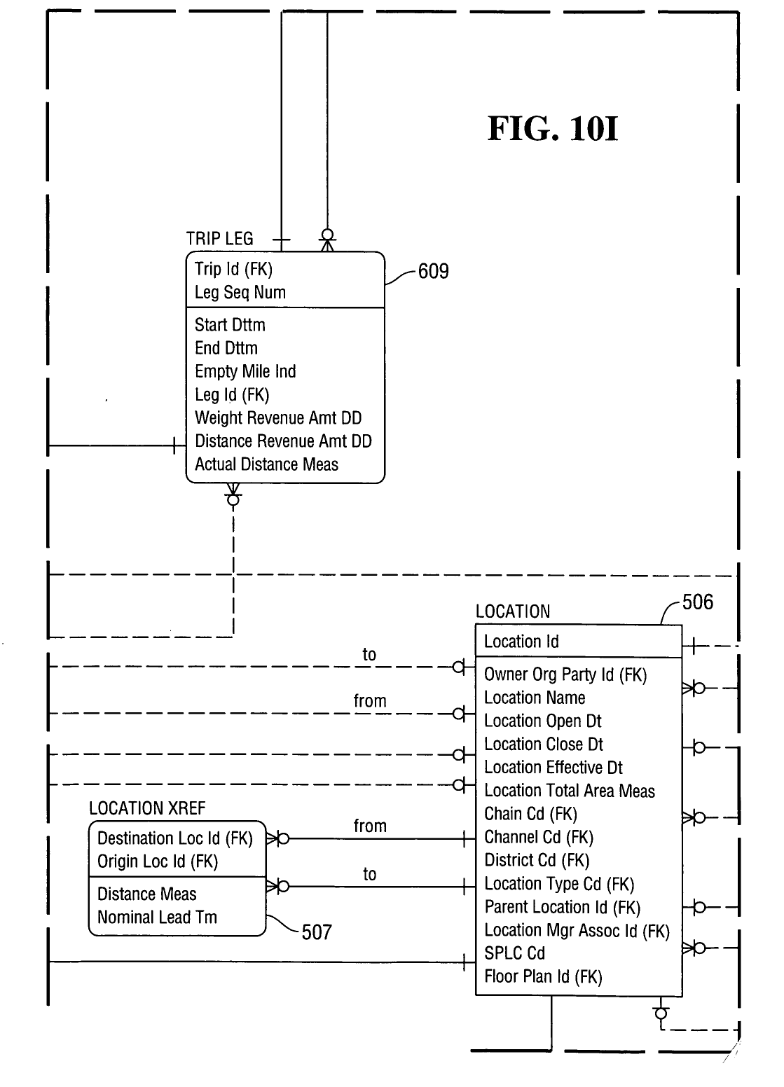

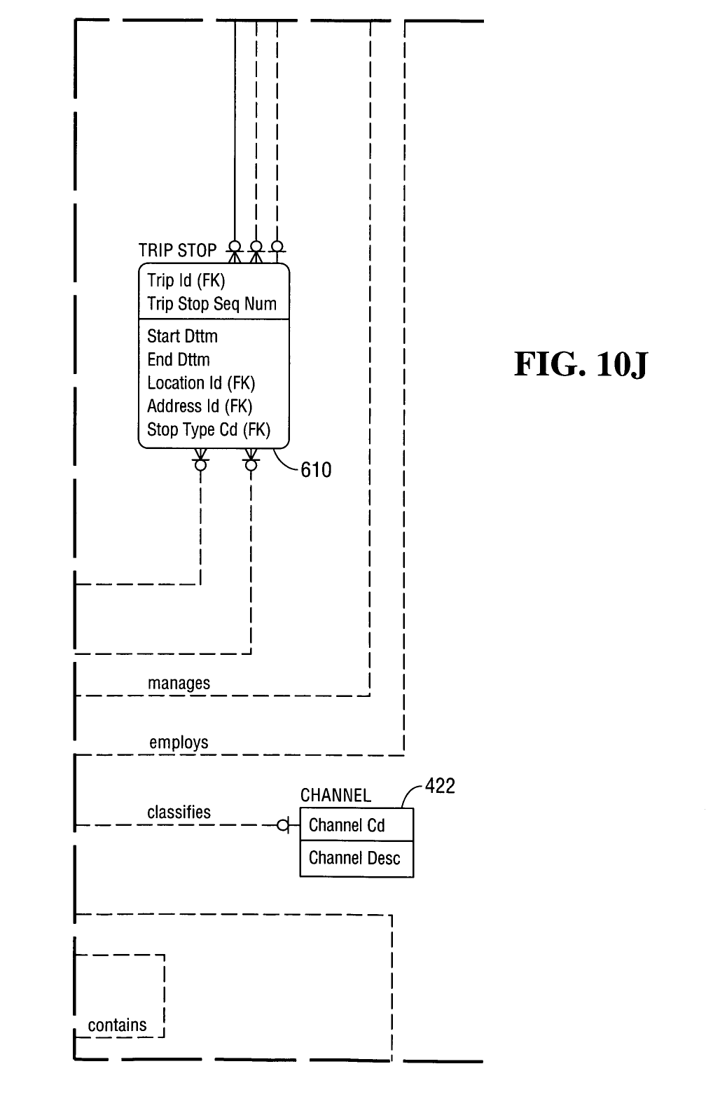

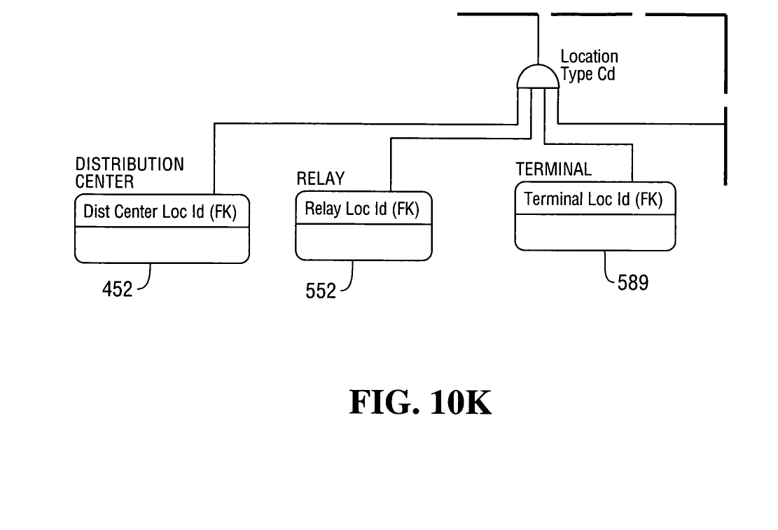

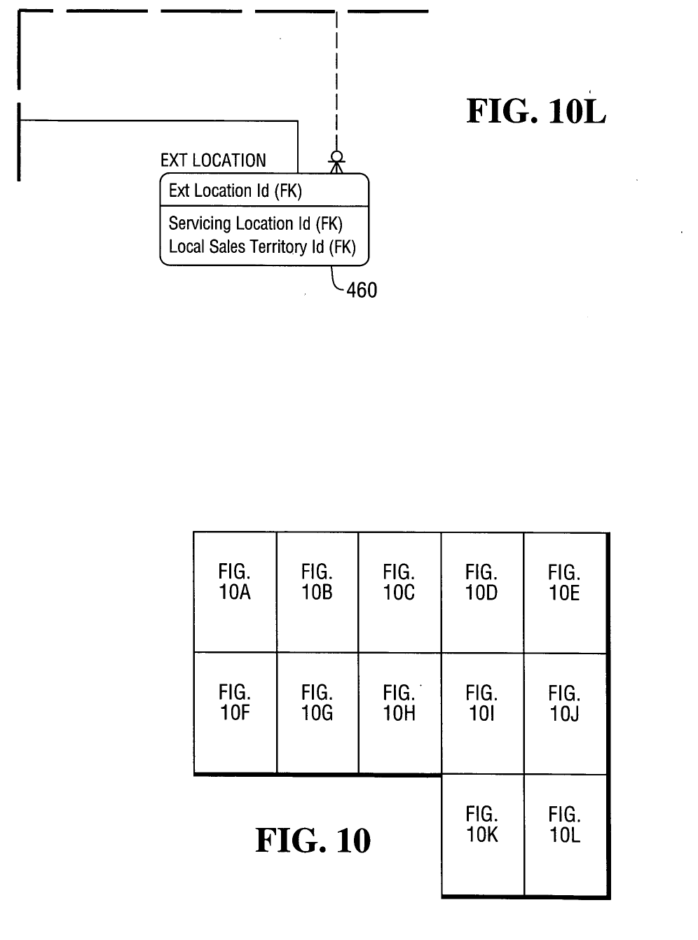

FIGS. 10A through 10L illustrate an entity-relationship diagram of the SHIPPING TRANSPORT subject area of the Retail Logical Data Model. The SHIPPING TRANSPORT subject area details the actual transporting of a Shipment, including all tracking information, transport modes used, legs and routes traveled and the Equipment utilized. This subject area provides the enterprise a much more detailed and accurate degree of visibility into their supply chain by allowing them to track where a given SHIPMENT is at a given point in time during a given TRIP, and determine the status and nature of a given SHIPMENT'S STATE as it is being handled and/or transported. By supporting this level of transport logistics detail, the enterprise will be able to not only monitor and better react to potential disruptions or variances in their product inbound and outbound flow but also better understand the performance and service levels and exceptions among their suppliers and carriers to:
Optimize inventory and total logistics (store, warehousing and transportation) through improved supplier collaboration through visibility of supplier data and performance
Establish a base of transportation resources to achieve least cost service based upon supplier replenishment and customer shipment requirements.

The entities of the SHIPPING TRANSPORT subject area, illustrated in FIGS. 10A through 10L, are defined as follows:

ADDRESS (401) An ADDRESS provides a means of communications such as postal address, telephone number, or electronic address (e.g. e-mail). An ADDRESS may also represent a physical mailing location (e.g. street, post office box).

ASSET TYPE (415) Describes the particular kind of ASSET. Examples: Handling Equipment, Transport Equipment, Aircraft, etc.

ASSET (416) Specific asset owned by the enterprise. Examples: Boeing 737 model 300 Tail Number N3232, Unit Load Device Serial Num 3234 for a Boeing 757, Framostat Test Equipment Ser #34344

ASSOCIATE (417) An individual who works under the direct control of the enterprise such as Employees, Contractors, Temporary Workers, etc.

BORDER EVENT (418) Captures the Customs (or Regulatory) compliance events at Border Crossings.

CHANNEL (422) The various venues in which Items or Services are sold. Locations (facilities) belong to 1 specific Channel. A specific Item or Service price may vary across Channels. Examples: Internet, Call Center, Over the Counter (In-Person Point of Sale.)

CHECKPOINT (424) The recording of a progress event for a given shipment. Examples: Departure Scan, Arrival Scan, etc.

CITY (425) A geographical region within a TERRITORY. Can also be a hamlet, village, township, etc. Examples: Los Angeles, Dijon, etc.

CLASS RATING (430) The entity that identifies the different classifications used by transportation companies to classify ITEMS for SHIPMENT for rating/pricing purposes.

COMMODITY EQUIP (431) Cross Reference defining the specialized Equipment required to transport certain Commodity Groups of Items. Examples: Hazardous Materials, Items needing Refrigeration, etc.

COMMODITY GROUP (432) A hierarchical grouping of Commodity classifications that may have as many levels as needed to fully code the classification scheme. For example, the United Nations Standard Products and Services Classification (UNSPSC), an open global coding system that classifies products and services, includes the following coding:

50.00.00.00—Food Beverage and Tobacco Products (Parent group)
50.11.00.00—Meat and Poultry Products (immediate child group)
   50.11.15.00—Meat and poultry (lower-level child group)
      50.11.15.10 Fresh meat or poultry (commodity)
      50.11.15.11 Frozen meat or poultry (commodity)

The model shows two entities to illustrate both the lowest-level commodity and the higher-level groups that are possible. It is entirely feasible to utilize a single entity similar to this Commodity Group entity and include all levels of the commodity classification standard within and having a single relationship to the Item entity.

COST TYPE (440) Classifies the different COSTs into logical groupings.

COST (441) Denotes the types of COSTs the enterprise expends

CREW MEMBER (444) The individual(s) that are operating (driving, flying, etc.) the transportation equipment during a specific TRIP LEG.

CUSTOMS FORM PRESENTED (446) Defines a set of information to be provided to a Controlling Authority for the importing or exporting of specific goods between countries.

CUSTOMS FORM (448) Captures the Sets of Regulatory information (Forms) presented to the Controlling Authority to enable this Border Crossing.

DELIVERY (450) The actual delivery/acceptance of a shipment by the Receiver Party (Consignee).

DISTRIBUTION CENTER (452) A type of LOCATION where items are stored and may sometimes be bought directly by customers. A DISTRIBUTION CENTER is a physical LOCATION where merchandise is received from VENDORs or suppliers and temporarily held for the purpose of being packaged to fulfill STORE orders or STORE allocation plans and then distributed to the STOREs. A DISTRIBUTION CENTER may also act as temporary-holding point to receive return goods from STOREs, which will then be returned to the supplying VENDOR, or serve as a distribution point for a Distributor.

EQUIP CLASS (453) Describes the Class of EQUIPMENT for skills certification; commodity handling; associate/crew training; licensing purposes.

EQUIP CONFIG (454) A pre-defined configuration of EQUIPMENT with a fixed set of configurable options. Examples of configurable trailer options include: Reefer, rack system, decking type, etc.

EQUIP MODEL (455) The type of vehicle as manufactured. Examples: Kenworth Diesel Tractor—Model 2100, Mac Tipper Trailer, and Volvo WX64 Cab.

EQUIP QUALIFIED (456) Cross reference of Individuals & Equipment they're qualified to operate. Examples: the class of driver license an Associate has (Class A Truck), qualified to operate a Forklift, etc.

EQUIPMENT (457) A Type of fixed asset (Equipment) used and tracked by the enterprise. Examples: Tractor, Trailer, Fork Lift, etc.

EXCEPTION REASON (458) Describes (if known) the reason or cause for an Exception to occur that was different from what was expected or promised. For a Late (delayed) delivery, examples include “truck breakdown,” for Missing Piece it could be “Theft,” and for Damage, it could be “Dropped.”

EXCEPTION (459) Describes an anomaly. A deviation from what was promised, planned or expected. Examples: Late Delivery, Confiscated by Customs, Missing Items, Damaged Items, etc.

EXT LOCATION (460) A LOCATION that belongs to (or is used by) a third PARTY (external to the enterprise).

HANDLING EQUIP (472) Equipment used to handle (as opposed to transport) goods. Examples: Forklift, Scales, etc.

INSPECTION (475) The event that records the results of an inspection of cargo/freight. Captures the difference between actual measurements versus that specified on the SHIPMENT LINE ITEM for this PIECE. Examples: Weight is more or less than that stated, Wrong NMFC code used to classify the shipment, Wrong Container type used to rate the shipment.

LANE (501) A collection of ROUTEs between two large geographical areas, typically cities. Used to define and group the major ‘routes’ served by the enterprise (unidirectional).

LEG EQUIPMENT PIECE (502) Specifies all the content (Pieces) of a Shipment that is being transported by a specific piece of Equipment over a specific Leg.

LEG EQUIPMENT (503) Specifies all the transportation equipment components that traveled a specific LEG. Collectively, all of the Equipment that travel together in a connected fashion is called a TRIP LEG. Examples include: a specific tractor; two trailers, and one dolly to connect the second trailer.

LEG (504) The movement between two points where a shipment is actually handled at both points. Examples: Leg begins with loading freight, Leg ends upon reaching a terminal for a cross-dock.

LOCATION ADDRESS (505) Describes how a specific combination of ADDRESS, LOCATION and ADDRESS USAGE is used in a unique combination. Examples: “123 Main Street” is used by “Distribution Center 23” as “Ship To” or “‘310-555-2342”’ is used by “Call Center 46” as “Customer Service Fax number.”

LOCATION (506) A physical or virtual site or facility which is owned or leased by a PARTY in support of their business activities such as to support the Sales, Distribution, Storage, etc. A Location can be contained in another Location (Pharmacy inside a Retail Store, etc.).

Location subtypes are shown as Inclusive (meaning a single Location can be a member of multiple Location Subtypes). This allows a single Location to inherit characteristics from multiple Location Subtypes. For example, a Pharmacy Location can also be a Store Location, thereby inheriting the Store Location attributes. If the enterprise does not have this requirement, the subtypes can be made Exclusive instead.

“Virtual” Locations can refer to: non-physical locations (Web Store, etc.), or logical Locations inside physical Locations.

LOCATION XREF (507) Details information regarding a location pair. Typically used when moving goods between two locations.

MANIFEST (509) Specifies the Content (Shipment Pieces) of a specific piece of Equipment for a specific Trip (or Leg), e.g., a tractor hauling two trailers on a given Trip will have two Manifests specifying the Pieces being transported, one for each trailer.

NON TRANSIT STATE (514) The duration of time that a shipment is at a LOCATION (as opposed to being transported between two locations). Examples: Being Crossdocked, In Storage, Customs Clearing, Breakbulk, etc.

PICKUP (532) The Pickup event is the moment in time goods to be transported are accepted by the CARRIER.

PIECE (534) Discrete identifiable object, many of which may make up the shipment. In Less than Truckload and Truckload the outer package is considered to be a Piece.

RELAY (552) A LOCATION used during Transportation where EQUIPMENT takes on a new driver or crew.

RFID TAG (553) This entity captures Serialized Items or any other object tagged with a RFID Tag containing an Electronic Product Code. The Electronic Product Code (EPC) is a unique number that identifies a specific item or object in the supply chain.

ROUTE LEG (554) Cross reference between a ROUTE and the LEGs that define the ROUTE.

ROUTE (555) A specific path between two LOCATIONs, specifying all the intermediate LOCATIONs passed. Defined as a collection of LEGs.

SHIP EVENT TYPE (568) A classification of event types related to the shipment of goods. Examples: Pickup Arrival, Delivery Acceptance, Terminal Departure Scan, etc.

SHIPMENT COST (572) The individual items of COST associated with this particular SHIPMENT. Used to determine the ultimate profitability of the SHIPMENT.

SHIPMENT STATE COST (576) Associates all the generated allocated costs incurred by a specific PIECE while in a specific STATE if the COST could (optionally) be associated with a provided SERVICE. Used to assign costing to calculate SHIPMENT and customer profitability.

SHIPMENT STATE (577) Defines the actual state or ‘status’ of a SHIPMENT PIECE. It has a duration and is usually initiated and terminated by an EVENT.

SHIPMENT (578) Goods picked up at the same time and transported from one shipper at one origin to one receiver at one destination.

SHIPPING EVENT (579) An event related to the shipment of goods. It does not have a duration, and occurs in an “instant.” Typically changes the STATE or status of the shipments involved. Examples: Pickup Arrival, Delivery Acceptance, Terminal Departure Scan, Customs(Border) Event, etc.

SHIPPING EXCEPTION (580) Captures the Exception(s) (if any) that occurred during a Shipping Event.

STATE TYPE (583) Classification of the state or “status” of a Piece being transported. Examples: At customer, waiting to be picked up; Loading at Customer site; In transit from Customer to Terminal; Being Crossdocked; In Storage; etc.

STOP TYPE (584) Indicates the type of, or reason for a stop. Examples include: Pickup, Delivery, Lunch, Crew change, Weighing Station stop, etc.

TERMINAL (589) A LOCATION owned or used during Transportation as a point of departure and for delivery and handling of freight. LTL operators use TERMINALs for cross-docking operations for consolidating shipments.

TRANSIT STATE (596) The duration of time that the shipment is being transported between two locations. A cross-reference of PIECEs being transported in each TRIP LEG, and the EQUIPMENT it was contained in.

TRANSPORT EQUIP (597) Equipment used in the physical transportation of goods. Typically vehicles or vehicle components. Examples: Truck, Tractor, Trailer, Container, etc.

TRANSPORT MODE (600) Indicates mode of transport.

TRANSPORT SERVICE ITEM (605) An Item used or sold to a customer as part of providing a Transport Service.

TRIP LEG (609) The specific driver and specific vehicle traveling between two points at which items are taken off or placed onboard. The shortest distance between packing and unpacking—a change in the goods being moved or the equipment doing the moving.

TRIP STOP (610) This entity identifies specific events that happen when the driver is stopped during the TRIP at a LOCATION or ADDRESS. A TRIP STOP can occur in between two TRIP LEGs, or in the middle of a TRIP LEG. This information is Equipment specific, as opposed to Shipment specific. Shipment events are described in the Shipping Event area)

An important metric for the stops made during a Pickup and Delivery trip is the actual duration of each stop (more so than the distance between the stops). Also, a stop could be at a LOCATION (a known or scheduled facility that is enterprise or customer owned) OR an ADDRESS (typically a residential or non-repeating delivery address, and could even be an arbitrary point defined by GPS like the delivery of equipment to the side of a road for a construction project). Stops for meals, etc. are also typically at ADDRESSes, not LOCATIONs.

TRIP TYPE (611) Classifies the nature of the TRIP. For Trucking this could be “Pick Up and Delivery’, ‘Line Haul’, etc.

TRIP (612) Planned or scheduled movement of a “powered” TRANSPORT EQUIPMENT unit, e.g. a tractor—the engine that pulls the freight. Also a collection of TRIP LEGs associated with a Carrier/Mode. A TRIP can also be the round-trip movement starting at one facility and ending up back at that facility. An example of this is the typical Pickup and Delivery (P&D) trip.

### Conclusion

The Figures and description of the invention provided above reveal a flexible relational data model for a retail enterprise data warehouse solution. The data model design enables the capturing of supply chain and transportation logistics information. Maintaining this information in a data warehouse provides the retail enterprise with the ability to analyze and improve supply chain operations and better manage store inventory through better informed decision making.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A relational database system for storing and managing information for a retail enterprise, said information being organized within said relational database system in accordance with a logical data model, said logical data model comprising:
a plurality of entities and relationships defining the manner in which supply chain management and transportation logistics information associated with said retail enterprise is stored and organized within a relational database.

2. The relational database system in accordance with claim 1, wherein said logical data model comprises:
a subject area including a plurality of entities and relationships defining the manner in which information pertaining to content of a shipment, including items contained therein, parties involved in the shipment, and transportation services associated with the shipment, is stored and organized within said relational database.

3. The relational database system in accordance with claim 1, wherein said logical data model comprises:
a subject area including a plurality of entities and relationships defining the manner in which information pertaining to transportation of a shipment, including tracking information, transport mode used during shipment, legs and routes traveled during shipment, and the equipment utilized during shipment, is stored and organized within said relational database.

4. The relational database system in accordance with claim 1, wherein said logical data model comprises:
a subject area including a plurality of entities and relationships defining the manner in which information pertaining to cost planning of a shipment is stored and organized within said relational database.

5. The relational database system in accordance with claim 1, wherein said logical data model comprises:
a subject area including a plurality of entities and relationships defining the manner in which information pertaining to rules and regulations of transporting goods over country borders is stored and organized within said relational database.

6. A method for storing and managing information for a retail enterprise, said method comprising the steps of:
establishing a relational database for storing and organizing supply chain management and transportation logistics information associated with said retail enterprise;
establishing a logical data model including a plurality of entities and relationships defining the manner in which said supply chain management and transportation logistics information is stored and organized within said relational database; and
populating said relational database with said supply chain management and transportation logistics information in accordance with said logical data model.

7. The method in accordance with claim 6, further comprising the step of:
establishing a subject area within said logical data model including a plurality of entities and relationships defining the manner in which information pertaining to content of a shipment, including items contained therein, parties involved in the shipment, and transportation services associated with the shipment, is stored and organized within said relational database.

8. The method in accordance with claim 6, further comprising the step of:
establishing a subject area within said logical data model including a plurality of entities and relationships defining the manner in which information pertaining to transportation of a shipment, including tracking information, transport mode used during shipment, legs and routes traveled during shipment, and the equipment utilized during shipment, is stored and organized within said relational database.

9. The method in accordance with claim 6, further comprising the step of:
establishing a subject area within said logical data model including a plurality of entities and relationships defining the manner in which information pertaining to cost planning of a shipment is stored and organized within said relational database.

10. The method in accordance with claim 6, further comprising the step of:
establishing a subject area within said logical data model including a plurality of entities and relationships defining the manner in which information pertaining to rules and regulations of transporting goods over country borders is stored and organized within said relational database.
